(19) United States
(12) Patent Application Publication
(10) Pub. No.: US 2023/0050287 A1
(43) Pub. Date: Feb. 16, 2023

(54) OBJECT IDENTIFICATION AND DUPLICATION SYSTEMS

(71) Applicant: The Hillman Group, Inc., Cincinnati, OH (US)

(72) Inventors: Byron Keith Grice, Phoenix, AZ (US); Michael J. Schmidt, Gilbert, AZ (US); Michael Kenneth Hart, Tempe, AZ (US); Ari Bennett, San Francisco, CA (US); Patrick Kowalsky, Denver, CO (US); Brian Rosner, Phoenix, AZ (US); Wendell Luckow, Longmont, CO (US); Bryan Solace, Chandler, AZ (US); David Wilkinson, Scottsdale, AZ (US); Roger Palmer, Cave Creek, AZ (US)

(21) Appl. No.: 17/887,259

(22) Filed: Aug. 12, 2022

Related U.S. Application Data
(60) Provisional application No. 63/260,208, filed on Aug. 12, 2021.

(51) Int. Cl. B23C 3/35; G06K 7/10; G01B 11/24

(52) U.S. Cl. CPC B23C 3/35; G06K 7/10366; G01B 11/24; E05B 19/0017

(57) ABSTRACT

Systems and methods disclosed for use in identifying and duplicating objects, particularly access devices such as house keys, office keys, automobile keys, and RFID key fobs. Within a singular housing, the customizable systems may include any or all of a key identification system, a key duplication system, an automobile key identification system, and/or an RFID key fob duplication system. Unique capabilities of the systems include the ability to verify that an existing automobile key matches data input by the user pertaining to the associated automobile. Further, the systems reduce frustration, error, and waste by programming a duplicate blank RFID key fob in a fully automated manner within the housing of the machine. To facilitate this process, blank RFID key fobs may be stored inside of the housing within RFID key fob containers that are readily stacked and dispensed.

### RELATED APPLICATION

This application claims the benefit of priority to U.S. Provisional Patent Application No. 63/260,208, filed Aug. 12, 2021, the contents of which are expressly incorporated herein by reference.

### TECHNICAL FIELD

The present disclosure is directed to object identification and duplication systems and, more particularly, to systems and methods for identifying and duplicating access control devices such as house keys, automobile keys, motorcycle keys, recreational vehicle keys, RFID fobs, etc.

### BACKGROUND

Access control is a major industry, one that touches nearly every household and business. Whether a person owns a home, runs an office, drives a car, or rents a vacation home, access control devices like keys and fobs will be ubiquitous.

Managing and duplicating these access control devices presents a significant challenge, particularly in a “lockout” situation where the original device is locked inside, lost, or damage. Absent an easily accessed on-demand retail solution, one is left with few options besides an expensive locksmith service, or waiting days or weeks for a spare key to arrive.

Machines and methods for duplicating access control devices, such as key duplication machines, were once the sole purview of trained experts and locksmiths. In recent years, the industry has evolved and expanded to self-service machines and further still to fully automated robotic systems aided by artificial intelligence. But retail space and inventory remain at a premium, and every inch of floor space represents (lost) revenue for a retailer. Although the various types of machines discussed above may be individually acceptable for some environments, they can also be problematic. In particular, having only one type of machine is a sales environment can limit the number and type of customers attracted to the environment. However, having multiple types of machines in the sales environment can consume valuable floor space and increase equipment and operating costs.

Identifying and duplicating automobile keys presents both a challenge and an opportunity for the industry. Previously, a customer who lost a car key would have no choice but to return to the dealership to secure a new key, usually at a price of hundreds of dollars. In time, duplication devices for automobile keys reached the broader marketplace, offering a faster, cheaper solution. But these machines almost always required the time and attention of a well-trained store employee, and often carried a limited range of keys. As modern car keys have exploded in complexity, duplication of an existing key at a reasonable price has gotten even more difficult.

Although machines exist in the prior art for duplicating RFID key fobs, these machines also are either not self-service, not instantaneous, or are cumbersome to use. In particular, any machine that requires an untrained user to insert a blank RFID key fob back into the machine for writing runs a significant risk that the user will either walk away with the blank fob (thinking it has already been written) or will fail to place the fob properly into the machine. Both scenarios result in significant frustration and potential danger when the user tries to use the duplicate fob later only to find it worthless.

The disclosed object identification and duplication systems, which consolidate multiple functions of identifying and duplicating objects such as access control devices within one housing, are directed to overcoming one or more of the problems set forth above and/or other problems of the prior art.

### SUMMARY

In one aspect, the present disclosure is directed to a system for duplicating access devices. The system may include a self-service kiosk which includes a housing and a user interface. The self-service kiosk may further include a key identification system within the housing. The key identification system may be configured to receive an existing key at a key insertion slot, clamp the existing key, and identify geometric features of the existing key. The self-service kiosk may further include a key duplication system within the hosing. The key duplication system may be configured to retrieve a key blank associated with the existing key, clamp the key blank, cut the geometric features of the existing key identified by the key identification system into the key blank, and dispense the cut key blank. The self-service kiosk may further include an automobile key identification system within the housing. The automobile key identification system may be configured to receive input via the user interface indicative of the make, model, and year of an automobile associated with an existing automobile key, determine whether the existing automobile key includes a transponder chip, determine information associated with the type of transponder chip, interrogate the transponder chip, and determine a code associated with the transponder chip. The self-service kiosk may further include an RFID key fob duplication system within the housing. The RFID key fob duplication system may be configured to read data associated with an existing RFID key fob, and determine whether the existing RFID key fob can be duplicated. When the data indicates that the existing RFID key fob can be duplicated, the RFID key fob duplication system may be further configured to retrieve an RFID key fob container containing an RFID key fob blank, write the existing RFID key fob data onto the RFID key fob blank within the RFID key fob container, and dispense the RFID key fob container containing the written RFID key fob blank. Finally, the system may include a remote server.

In another aspect, the present disclosure is directed to a method for duplicating an automobile key. The method may include receiving input via a user interface of a self-service kiosk indicative of the make, model, and year of an automobile associated with an existing automobile key. The method may also include determining, based on the received input, that the existing automobile key is a remote control device. Additionally, the method may include capturing at least one image of a remote control device provided by a user of the self-service kiosk. The method may also include verifying, based on the captured at least one image, that the remote control device provided by the user matches a remote control device associated with the make, model, and year of an automobile input received by the user interface. Finally, the method may include transmitting the input of a make, model, and year of an automobile received by the user interface and the captured at least one image to a remote server.

In yet another aspect, the present disclosure is directed to a method for duplicating a key. The method may include receiving an existing key at a key insertion slot of a housing of a self-service kiosk. The method may further include clamping the existing key, and determining that the existing key is a sidewinder key. Also, the method may include capturing at least one sidelight image of the blade of the sidewinder key, and capturing at least one laser stripe image of the blade of the sidewinder key. The method may additionally include transmitting one or more of the at least one sidelight image and the at least one laser stripe image to a remote server. Further, the method may include determining milling geometry information for the blade of the existing sidewinder key based on one or more of the at least one sidelight image and the at least one laser stripe image. Finally, the method may include retrieving a sidewinder key blank associated with the existing sidewinder key, and milling a blade of the sidewinder key blank with geometric features of the existing sidewinder key based on the determined milling geometry information for the blade of the existing sidewinder key.

In still another aspect, the present disclosure is directed to a method for duplicating an RFID key fob. The method may include reading data associated with an existing RFID key fob at a self-service kiosk, and determining whether the existing RFID key fob can be duplicated. When the data indicates that the existing RFID key fob can be duplicated, the method includes retrieving an RFID key fob container containing an RFID key fob blank, writing the existing RFID key fob data onto the RFID key fob blank within the RFID key fob container, and dispensing the RFID key fob container containing the written RFID key fob blank.

In another aspect, the present disclosure is directed to a system for duplicating access devices. The system may include a self-service kiosk including a housing and a user interface. The self-service kiosk may include a key identification system within the housing configured to receive an existing key at a key insertion slot, clamp the existing key, and identify geometric features of the existing key. The self-service kiosk may also include a key duplication system within the housing configured to retrieve a key blank associated with the existing key, clamp the key blank, cut the geometric features of the existing key identified by the key identification system into the key blank, and dispense the cut key blank. The self-service kiosk may additionally include an RFID key fob duplication system within the housing configured to read data associated with an existing RFID key fob, and determine whether the existing RFID key fob can be duplicated. When the data indicates that the existing RFID key fob can be duplicated, the RFID key fob duplication system may be further configured to retrieve an RFID key fob container containing an RFID key fob blank, write the existing RFID key fob data onto the RFID key fob blank within the RFID key fob container, and dispense the RFID key fob container containing the written RFID key fob blank.

### BRIEF DESCRIPTION OF THE DRAWINGS

FIGS. 1A-1C illustrate exemplary vehicle keys consistent with this disclosure.

FIG. 2 illustrates an exemplary kiosk arrangement consistent with this disclosure.

FIG. 3 illustrates an exemplary kiosk consistent with this disclosure.

FIG. 4 is a schematic of an exemplary object identification and duplication system consistent with this disclosure.

FIG. 5 is a schematic of an exemplary hardware configuration for a kiosk or a server consistent with this disclosure.

FIGS. 6-45 illustrate exemplary graphical user interface displays associated with an exemplary kiosk such as that of FIG. 3, consistent with this disclosure.

FIG. 46A is a front perspective view of a self-service kiosk consistent with this disclosure.

FIGS. 46B-46C are enlarged front perspective views of a self-service kiosk consistent with this disclosure.

FIG. 46D is a front perspective view of a housing of a self-service kiosk consistent with this disclosure.

FIGS. 46E-46F are rear and front perspective views, respectively, of a module for a self-service kiosk configured to identify and duplicate RFID key fobs, consistent with this disclosure.

FIG. 47A is a front perspective view of a module for a self-service kiosk configured to identify keys, consistent with this disclosure.

FIG. 47B is a rear perspective view of a module for a self-service kiosk configured to identify keys, consistent with this disclosure. FIG. 47C is the same view as FIG. 47B, with the outer frame removed to reveal the internal structure and components, consistent with this disclosure.

FIG. 48 is a hardware block diagram of a module configured to identify keys in a self-service kiosk such as that depicted in FIG. 46A, consistent with this disclosure.

FIG. 49A is a front view of a module for a self-service kiosk configured to identify keys such as that depicted in FIGS. 47A-C, with the front panel removed to reveal the internal structure and components, consistent with this disclosure. FIG. 49B is the same view as FIG. 49A, with additional hardware removed to further reveal the internal structure and components, consistent with this disclosure.

FIG. 50 is a side view of a laser assembly within a module for a self-service kiosk configured to identify keys, consistent with this disclosure.

FIG. 51A is a side view of a module for a self-service kiosk configured to identify keys such as that depicted in FIGS. 47A-C, with the left-side panel removed to reveal the internal structure and components, consistent with this disclosure. FIG. 51B is the same view as FIG. 51A, with a key inserted into a key insertion slot within the front panel, consistent with this disclosure.

FIGS. 52A-52D are exemplary images of a key taken by a module for a self-service kiosk configured to identify keys such as that depicted in FIGS. 47A-C, consistent with this disclosure.

FIG. 53 is an exemplary diagram illustrating positional data derived from images such as those depicted in FIGS. 52A-52D, consistent with this disclosure.

FIG. 54 is an exemplary combined image of laser stripes directed towards a key taken by a module for a self-service kiosk configured to identify keys such as that depicted in FIGS. 47A-C, consistent with this disclosure.

FIG. 55 is an exemplary diagram illustrating positional data derived from an image such as that depicted in FIG. 54, consistent with this disclosure.

FIGS. 56A-56F are exemplary images of keys taken by a module for a self-service kiosk configured to identify keys such as that depicted in FIGS. 47A-C, consistent with this disclosure.

FIG. 57A is a front perspective view of a module for a self-service kiosk configured to dispense RFID key fobs, consistent with this disclosure.

FIGS. 57B and 57C are rear perspective views of a module for a self-service kiosk configured to dispense RFID key fobs, consistent with this disclosure.

FIG. 58 is an illustration of various RFID key fobs and containers for storage of RFID key fobs within a module for a self-service kiosk configured to dispense RFID key fobs, consistent with this disclosure.

FIG. 59 is a flowchart depicting an exemplary process of identifying and duplicating an existing object using a self-service kiosk, consistent with this disclosure.

FIG. 60 is a flowchart depicting an exemplary process of identifying an existing key using a module for a self-service kiosk configured to identify keys such as that depicted in FIGS. 47A-C, consistent with this disclosure.

FIG. 61 is a flowchart depicting an exemplary process of identifying an existing automobile key, consistent with this disclosure.

FIG. 62 is a flowchart depicting an exemplary process of identifying an existing automobile key, consistent with this disclosure.

FIG. 63 is a flowchart depicting an exemplary process of identifying an existing automobile key, consistent with this disclosure.

FIG. 64 is a flowchart depicting an exemplary process of receiving information and payment from a user of a self-service kiosk such as that depicted in FIG. 46A, consistent with this disclosure.

FIG. 65 is a flowchart depicting an exemplary process of duplicating an existing key, consistent with this disclosure.

FIG. 66 is a flowchart depicting an exemplary process of duplicating an existing automobile key, consistent with this disclosure.

FIG. 67 is a flowchart depicting an exemplary process of identifying an existing RFID key fob, consistent with this disclosure.

FIG. 68 is a flowchart depicting an exemplary process of duplicating an existing RFID key fob, consistent with this disclosure.

FIG. 69 is a schematic of an exemplary object identification and duplication system consistent with this disclosure.

FIG. 70 is a schematic of an exemplary object identification and duplication system consistent with this disclosure.

FIG. 71 is a schematic of an exemplary hardware configuration for a kiosk such as the one depicted in FIG. 46A, consistent with this disclosure.

FIG. 72 is a flowchart depicting an exemplary process of duplicating an existing object when the existing object is not present, consistent with this disclosure.

FIGS. 73-102 illustrate exemplary graphical user interface displays for an exemplary self-service kiosk such as the one depicted in FIG. 46A, consistent with this disclosure.

### DETAILED DESCRIPTION

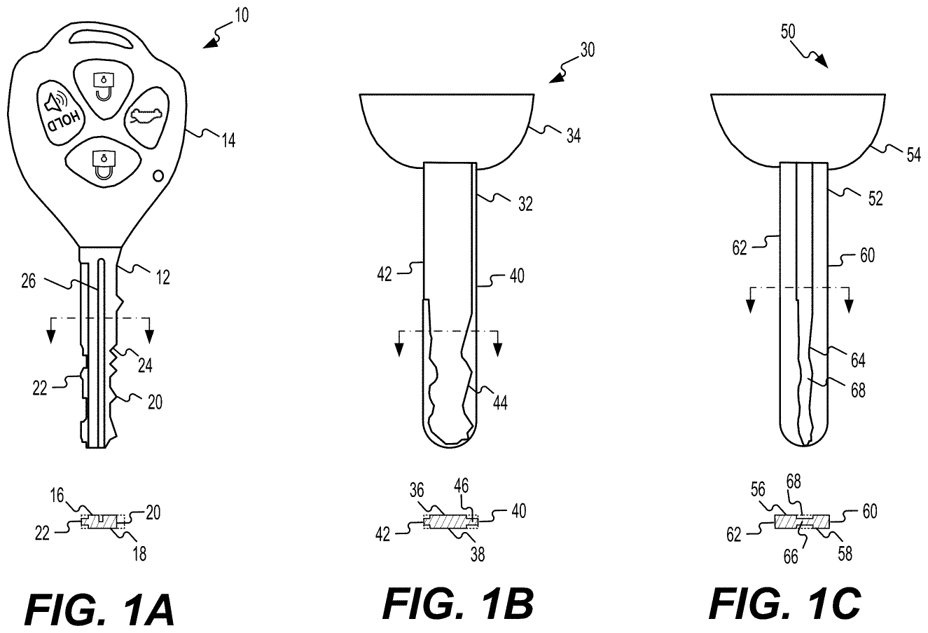

Numerous types of vehicle keys are currently in use. Such keys usually include an elongated shank and a head portion that may be covered with a key fob. The key fobs may include one or more buttons configured to lock/unlock a vehicle, open the trunk of the vehicle, and/or cause the vehicle to sound an alert in an emergency. FIGS. 1A-1C illustrate exemplary vehicle keys consistent with this disclosure.

As illustrated in the exemplary embodiment of FIG. 1A, key 10 may include shank 12 and key fob 14. In one exemplary embodiment as illustrated in FIG. 1A, shank 12 may include a generally elongated member having top side 16, bottom side 18, edge 20, and edge 22. Edges 20 and/or 22 may include one or more indentations or notches 24. In one exemplary embodiment as illustrated in FIG. 1A, both edges 20 and 22 may include notches 24. It is contemplated, however, that in some exemplary embodiments only one of edges 20 or 22 may include notches 24. As also illustrated in FIG. 1A, top side 16 of shank 12 may include one or more channels 26 extending along a part of or all of a length of shank 12. It is contemplated that notches 24 may be created by milling or otherwise machining edges 20 and/or 22 corresponding to a predetermined bitting pattern for key 10. As also illustrated in FIG. 1A, notches 24 may extend across a thickness of edges 20 and/or 22.

As illustrated in the exemplary embodiment of FIG. 1B, key 30, like key 10, may include shank 32 and key fob 34. Key fob 34 may be similar to key fob 14. Shank 32 of key 30 may include top side 36, bottom side 38, and edges 40, 42. In one exemplary embodiment as illustrated in FIG. 1B, shank 32 may included indentations or notches 44 milled into top side 36 and/or bottom side 38. Unlike key 10, however, notches 44 of key 30 may extend only partway into a thickness of edges 40, 42 leaving an uncut shank portion 46. It is contemplated that notches 44 may be created by side milling top side 36 and/or bottom side 38 corresponding to a predetermined bitting pattern for key 30.

As illustrated in the exemplary embodiment of FIG. 1C, key 50, like key 10, may include shank 52 and key fob 54. Key fob 54 may be similar to key fob 14. Shank 52 of key 50 may include top side 56, bottom side 58, and edges 60, 62. In one exemplary embodiment as illustrated in FIG. 1C, shank 52 may include indentations or notches 64 milled into top side 56 and/or bottom side 58. Unlike key 30, however, notches 64 of key 50 may extend only partway into a thickness of edges 60, 62. As also illustrated in FIG. 1C, notches 64 may be located in channel 68 formed between edges 60 and 62 on top side 56 and/or bottom side 58, leaving an uncut shank portion 66 forming a bottom surface of channel 68. It is contemplated that notches 64 may be created by side milling top side 56 and/or bottom side 58 corresponding to a predetermined bitting pattern for key 50.

A user or customer may desire to obtain a duplicate of a key (e.g., key 10, 30, or 50) that may be a vehicle key. Many retail locations offer key duplication services for manufacture of a duplicate key. Such retail locations typically include machining centers equipped with milling cutters or other cutting devices to generate the required notches on a key blank based on a desired bitting pattern. Typically, the machining centers in retail locations can generate keys similar to key 10 shown in FIG. 1A. This is because such machining centers include cutting devices capable of cutting notches 24 that extend across a thickness of edges 20 or 22. Although some retail locations may include machining centers equipped with side milling cutters, the large number of potential variations in side milled keys makes it prohibitive for the retail locations to store hundreds or even thousands of types of key blanks corresponding to the wide variety of side-milled keys in user. Thus, there is a need to provide an easy to use key identification and duplication system that would allow a retail location to provide key duplication services to a user or customer for side-milled keys without having to store a large inventory of key blanks.

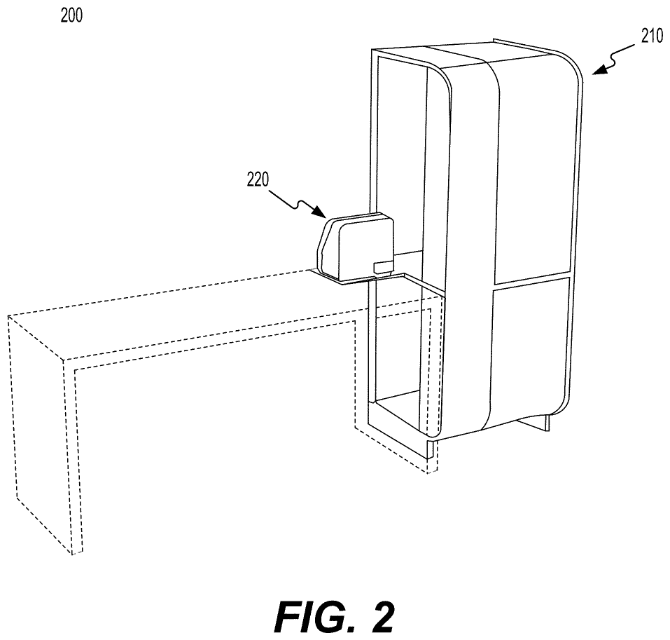

FIG. 2 illustrates an exemplary kiosk arrangement 200. Kiosk arrangement 200 may be located in a retail location, for example, grocery or hardware store, shopping mall, or airport, etc. Kiosk arrangement 200 may include key duplication kiosk 210 that may be configured to duplicate keys having edge milled notches similar to notches 24 of key 10. Adjacent to kiosk 210, kiosk arrangement 200 may include kiosk 220 that may be positioned on a platform (shown in phantom) located adjacent to kiosk 210. Kiosk 220 may be configured to allow a user or customer to duplicate side milled keys similar to keys 30 and 50. Although kiosk 220 has been illustrated as being located adjacent to kiosk 210, it is contemplated that in some embodiments, kiosk 220 may be located on top of or remote from kiosk 210.

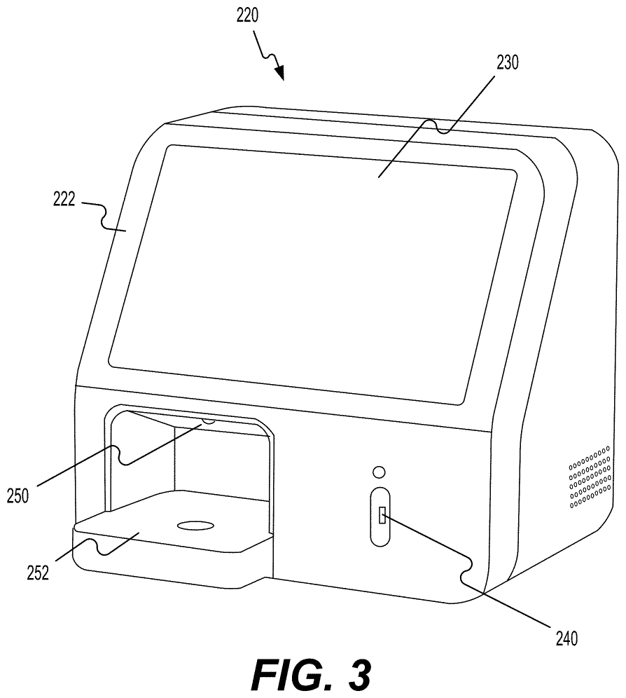

FIG. 3 illustrates an exemplary front view of kiosk 220 consistent with this disclosure. As illustrated in FIG. 3, kiosk 220 may include display 230, slot 240, camera 250, one or more payment capture devices, etc. Display 230 may be positioned anywhere on kiosk 220. Display 230 may include a conventional display device, for example, an LCD screen, an LED screen, a cathode ray tube screen, etc. In some exemplary embodiments, display 230 may be configured to display a graphical user interface, including instructions, advertising, and/or other information. In some exemplary embodiments, display 230 may additionally or alternatively include a touch screen device configured to receive one or more inputs from a user. Thus, for example, a graphical user interface displayed on display 230 may allow a user to provide additional information regarding the key to be duplicated and/or additional information about the user, accept or reject a displayed price, and/or request help on using kiosk 220. In some exemplary embodiments, display 230 may be configured to display a virtual keyboard or numeric keypad, which may allow a user to enter payment information, address information, and/or other information associated with duplicating a key similar to keys 30, 50.

Kiosk 210 may be equipped with one or more payment mechanisms to allow a user or a customer to pay for the key duplication services. In one exemplary embodiment, display 230 of kiosk 220 may be configured to display an image of, for example, a bar code or a QR code in a graphical user interface. An associate at the retail location may be able to scan the bar code or QR code allowing information from the bar code or QR code (e.g., payment information) to be directly imported into the retail location's native payment processing system. In another exemplary embodiment, one or more payment capture devices associated with kiosk 210 or 220 may include, for example, a cash acceptor, a credit or debit card reader, etc. For example, the cash acceptor may be located an outer surface of housing 222 of kiosk 220. Cash acceptor may be configured to receive currency in the form of bills or coins as payment from a customer. In some exemplary embodiments, the payment capture device may be configured to accept other types of payment such as checks or other forms of electronic payment. In some exemplary embodiments, the payment capture device may be configured to receive payment via wireless communication with another electronic device, for example, a mobile phone, a tablet computer, a laptop computer, a remote server, etc.

Slot 240 may be configured to allow a user to insert shank (e.g. 12, 32, or 52) of a key that the user wishes to duplicate. For example, display 230 may display instructions to the user to insert shank 12, 32, or 52 of a key into slot 240. Kiosk 220 may include one or more sensors configured to detect insertion of shank 12, 32, or 52 into slot 240. Kiosk 220 may also include one or more mechanical clamps, grasping devices, etc., configured to align shank 12, 32, or 52 so that shank 12, 32, or 52 may be fully insertable into slot 240 until key fob 14, 34, or 54 abuts on a surface of housing 222 of kiosk 220. Kiosk 220 may also include one or more imaging devices and/or one or more lighting devices within housing 222 of kiosk 220. The one or more imaging devices may include one or more 2D or 3D cameras, video cameras, holographic cameras, or other types of imaging devices. The one or more imaging devices may be configured to capture images of, for example, top side 16, 36, or 56, bottom side 18, 38, or 58, edge 20, 40, or 60, and/or edge 22, 42, or 62 of, for example, shank 12, 32, or 52 inserted into slot 240. It is contemplated, however, that the one or more imaging devices may be configured to capture any number of images of any number of sides of shank 12, 32, and/or 52. The one or more imaging devices within housing 222 may be positioned on one or more walls of housing 222. It is also contemplated that the one or more imaging devices within housing 222 may be attached to one or more gantries or carriage devices that may allow the one or more imaging devices to be moved in one or more directions relative to shank 12, 32, or 52 inserted into slot 240. It is also contemplated that the one or more gantries or carriage devices may include one or more tracks, chains, motors, springs, or other actuator systems configured to move the one or more imaging devices in the one or more directions. The one or more imaging devices may be configured to transmit the one or more captured images of shank 12, 32, and/or 52 to a server.

The one or more lighting devices within kiosk 220 may include, for example, one or more structured or unstructured light sources, single or multiple wavelength light sources, infrared, ultraviolet, or laser light sources, etc. Like the one or more imaging devices, the one or more lighting devices may also be attached to one or more gantries or carriage devices as discussed above to allow the one or more lighting devices to be moved in one or more directions relative to shank 12, 32, 52 inserted into slot 240 and or relative to the one or more imaging devices located within housing 222.

As discussed above, kiosk 220 may also include camera 250 that may be configured to obtain an image of one or more items positioned on platform 252. The relative positions of slot 240 and camera 250 as illustrated in FIG. 3 are exemplary and it is contemplated that slot 240 and/or camera 250 may be positioned anywhere on housing 222. Camera 250 may be a 2D or 3D camera, video camera, a document scanner, or other type of imaging device. Camera 250 may be configured to capture one or more images of, for example, one or more documents placed by a user on platform 252. It is contemplated that display 230 may display instructions to the user to provide one or more types of documents that may include information regarding a vehicle associated with a key inserted for duplication into slot 240. It is also contemplated that such documents may include, for example, driver's license of user, title associated with the vehicle, a document including a vehicle identification number (VIN) of the vehicle associated with the key inserted into slot 240, and/or any other type of document that may include information about the user (e.g., name, address, contact number, email, etc.) and/or information regarding the vehicle associated with the key inserted into slot 240 (e.g., VIN, driver's license, license plate information, vehicle brand, model, and/or type, etc.). Camera 250 may be configured to capture one or more images of the one or more documents placed on platform 252. Camera 250 may also be configured to transmit the one or more captured images to a server.

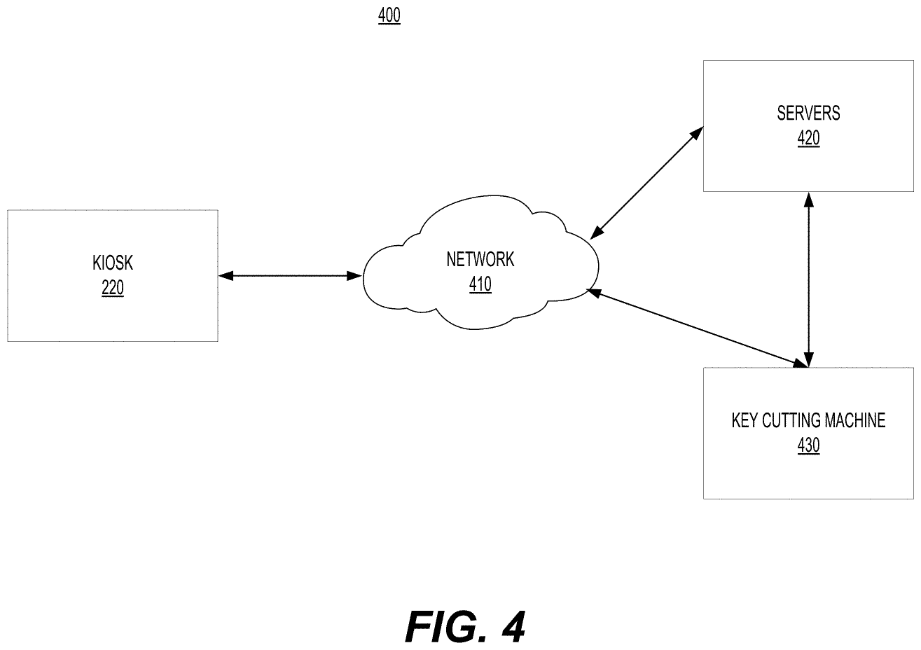

FIG. 4 illustrates an exemplary key identification and duplication system 400 consistent with this disclosure. Key identification and duplication system 400 may include kiosk 220, network 410, server 420, and/or key cutting machine 430. Kiosk 220 may communicate data and/or information with server 420 and/or key cutting machine 430 via network 410. It is also contemplated that server 420 may communicate data and/or information with key cutting machine 430 directly or via network 410.

Network 410 may include any combination of communications networks. For example, network 410 may include the Internet and/or any type of wide area network, an intranet, a metropolitan area network, a local area network (LAN), a wireless network, a cellular communications network, or Wi-Fi, WiMAX, Bluetooth or other communication protocol, etc.

Server 420 may include one or more servers configured to communicate and interact with one or more kiosks 220 and/or one or more key cutting machines 430. Server 420 may be a general purpose computer, a mainframe computer, or any combination of these components. In certain exemplary embodiments, server 420 may be a standalone computing system or apparatus, or it may be part of a subsystem, which may be part of a larger system. For example, server 420 may represent distributed servers that are remotely located and communicate over a communications medium (e.g., network 410) or over a dedicated network, for example, a LAN. Server 420 may be implemented as a server, a server system comprising a plurality of servers, or a server farm comprising a load balancing system and a plurality of servers. Server 420 may be configured to receive one or more images from kiosk 220. Server 420 may also be configured to determine a bitting pattern of the key associated with the images received from kiosk 220. In one exemplary embodiment, server 420 may be configured to determine the bitting pattern based on the images of shank 12, 32, and/or 52 transmitted from kiosk 220. In another exemplary embodiment, server 420 may be configured to determine the bitting pattern based on vehicle information extracted from, for example, images of one or more documents captured by camera 250 and transmitted to server 420 from kiosk 220. It is also contemplated that server 420 may be configured to determine the bitting pattern based on both the images of shank 12, 32, and/or 52 and/or the images of one or more documents captured by camera 250.

Server 420 may access one or more databases configured to store instructions and/or data associating vehicle information such as VIN number, make, model, driver's license number, vehicle title information, license plate information, etc., with a bitting pattern for a key associated with the vehicle information. It is also contemplated that in some exemplary embodiments, server 420 may determine the bitting pattern based on one or more dimensional measurements obtained from the one or more images of, for example, shank 12, 32, and/or 52 transmitted from kiosk 220. Although server 420 has been illustrated in FIG. 4 as being separate or remote from kiosk 220, it is contemplated that in some exemplary embodiments, server 420 may be integral with kiosk 220.

Server 420 may also be configured to transmit the bitting pattern, instructions, and/or commands to key cutting machine 430 to manufacture a duplicate key based on the bitting pattern. In one exemplary embodiment, server 420 may display instructions to allow an operator to select an appropriate key blank and insert the selected key blank into key cutting machine 430. Key cutting machine 430 may be equipped with one or more cutting devices (e.g., edge milling cutters, side milling cutters, drills, saws, laser cutters, etc.). Key cutting machine 430 may also be configured to cut notches, for example, 24, 44, or 64 in key shank 12, 32, or 52 based on instructions received from server 420. It is also contemplated that in some embodiments, key cutting machine 430 may be configured to retrieve instructions for cutting notches, for example, 24, 44, or 64 in key shank 12, 32, or 52 from a database based on instructions received, for example, from server 420.

It is contemplated that after the duplicate key has been manufactured by key cutting machine 430, an operator may remove the duplicate key from key cutting machine 430 and send it to a retail location, for example, where the user or customer initially requested duplication of the key. It is also contemplated that an associate at the retail location may use additional fob duplication equipment to copy programs, instructions, or codes from the user's key fob to a key fob associated with the duplicate key.

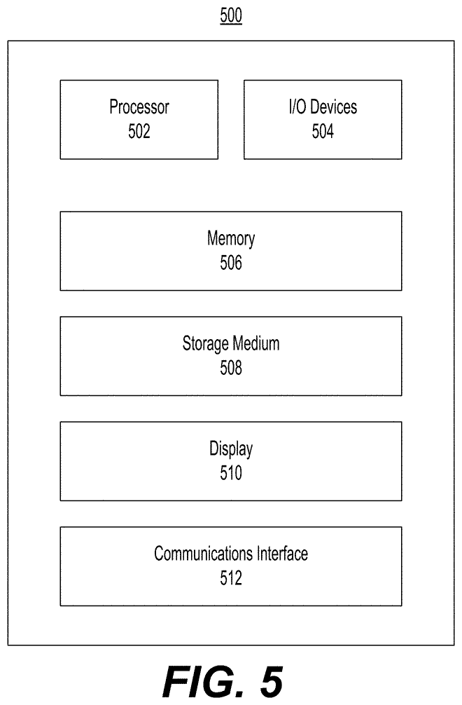

FIG. 5 illustrates an exemplary hardware configuration 500. Both kiosk 220 and/or server 420 may include one or more of the components of hardware configuration 500. In one exemplary embodiment, hardware configuration 500 may include one or more processors 502, input/output (I/O) devices 504, memories 506, storage media 508, displays 510, and/or communications interfaces 512.

Processor 502 may embody a single or multiple microprocessors, digital signal processors (DSPs), etc. I/O devices 504 may include physical keyboards, virtual touch screen keyboards, mice, joysticks, styluses, etc. In certain exemplary embodiments, I/O devices 504 may include a microphone (not shown) for providing input to system 400 using, for example, voice recognition, speech to text, and/or voice command applications. In other exemplary embodiments, I/O devices 504 may include a telephone keypad and/or a keypad on a touch screen for providing input to system 400.

Memory 506 may be configured to store data or one or more instructions and/or software programs that perform functions or operations when executed by the one or more processors 502. For example, memory 506 may include Random Access Memory (RAM) devices, NOR or NAND flash memory devices, Read Only Memory (ROM) devices, etc. System 400 may also include storage medium 508 configured to store data or one or more instructions and/or software programs that perform functions or operations when executed by the one or more processors 502. In some exemplary embodiments, storage medium 508 may include hard drives, solid state drives, tape drives, RAID arrays, compact discs (CDs), digital video discs (DVDs), Blu ray discs (BD), etc. Although FIG. 5 shows only one memory 506 and one storage medium 508, system 500 may include any number of memories 506 and storage media 508. Further, although FIG. 5 shows memory 506 and storage medium 508 as part of hardware configuration 500 of kiosk 220 and/or server 420, memory 506 and/or storage medium 508 may be located remotely and system 500 may be able to access memory 506 and/or storage medium 508 via network 410.

Displays 510 may be configured to display data and/or information and may be similar to display 230 discussed above. Communications interface 512 may allow software and/or data to be transferred between kiosk 220, network 410, server 420, and/or key cutting machine 430. Examples of communications interface 512 may include a modem, a network interface (e.g., an Ethernet card or a wireless network card), a communications port, a PCMCIA slot and card, a cellular network card, a Bluetooth interface, etc. Communications interface 512 may transfer software and/or data in the form of signals, which may be electronic, electromagnetic, optical, or other signals capable of being transmitted and received by communications interface 512. Communications interface 512 may transmit or receive these signals using wire, cable, fiber optics, radio frequency (“RF”) link, and/or other communications channels.

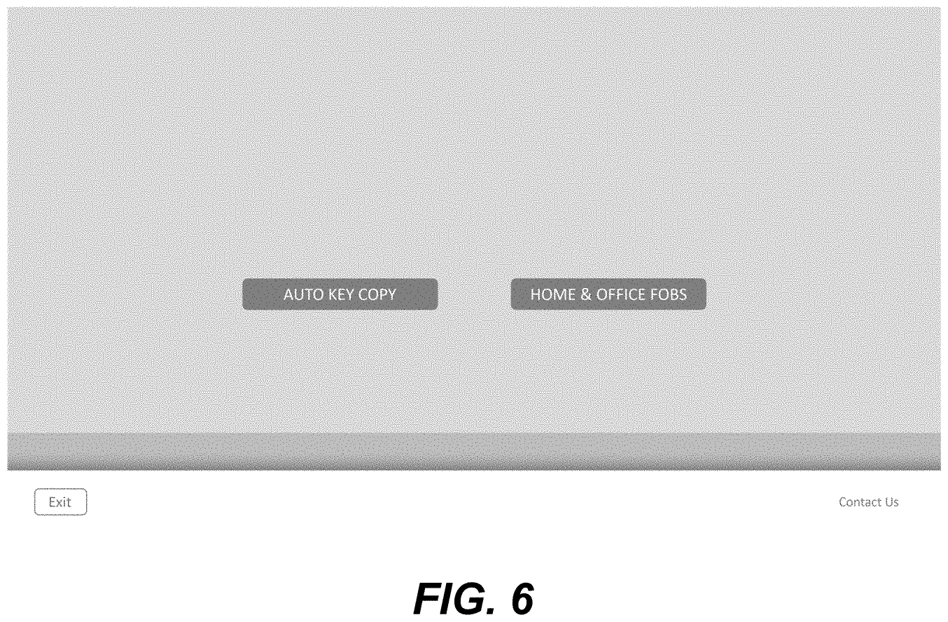

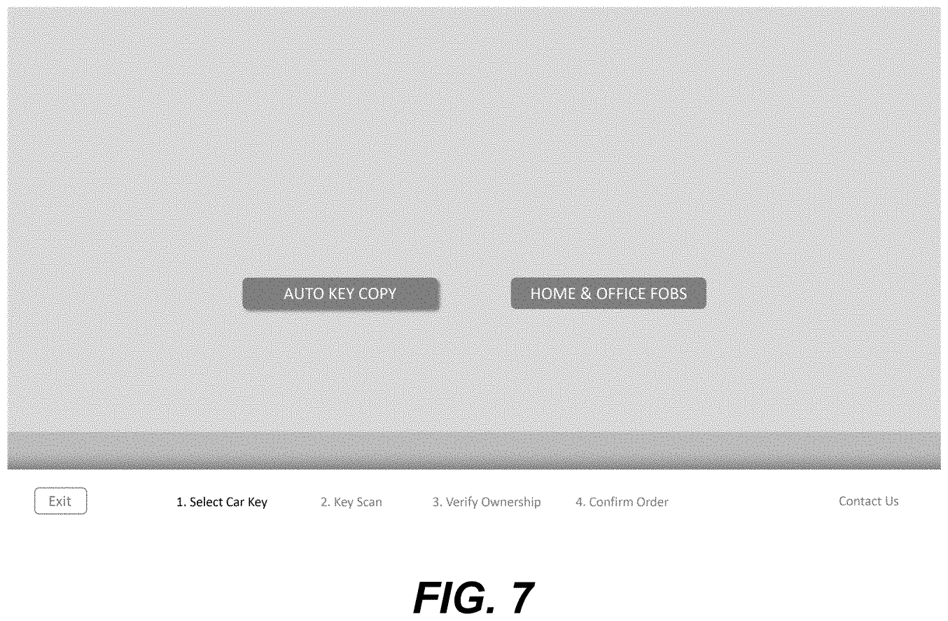

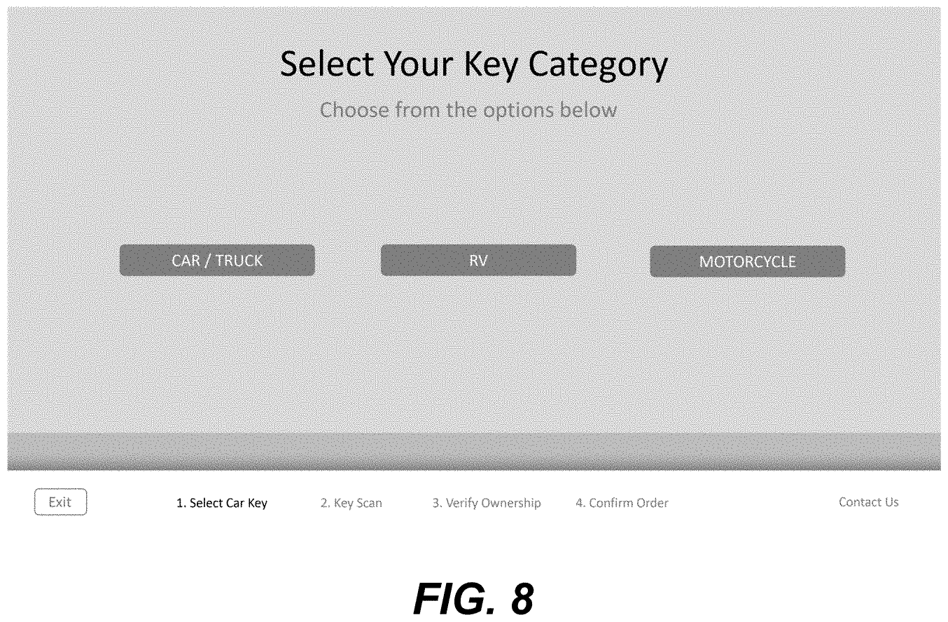

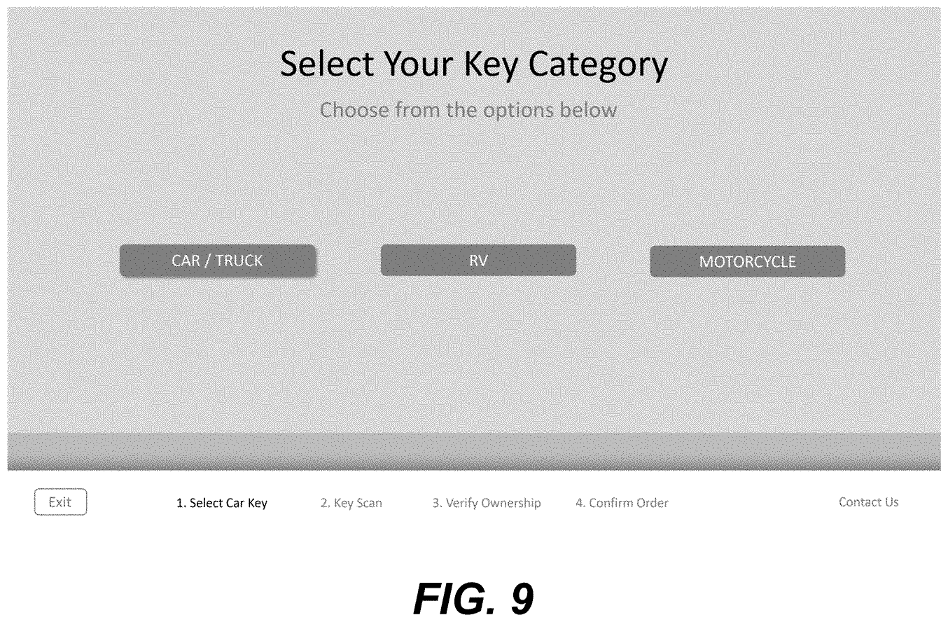

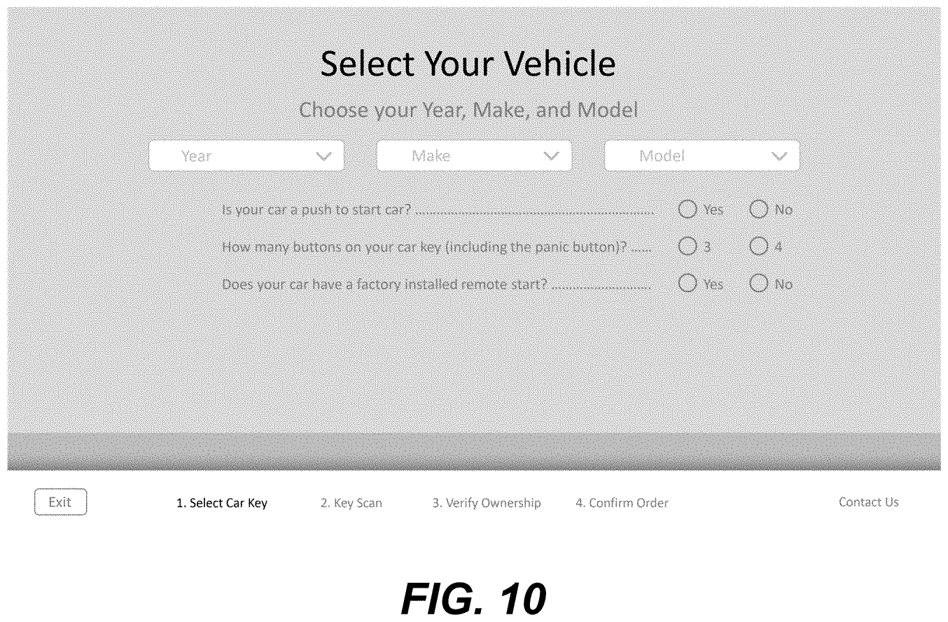

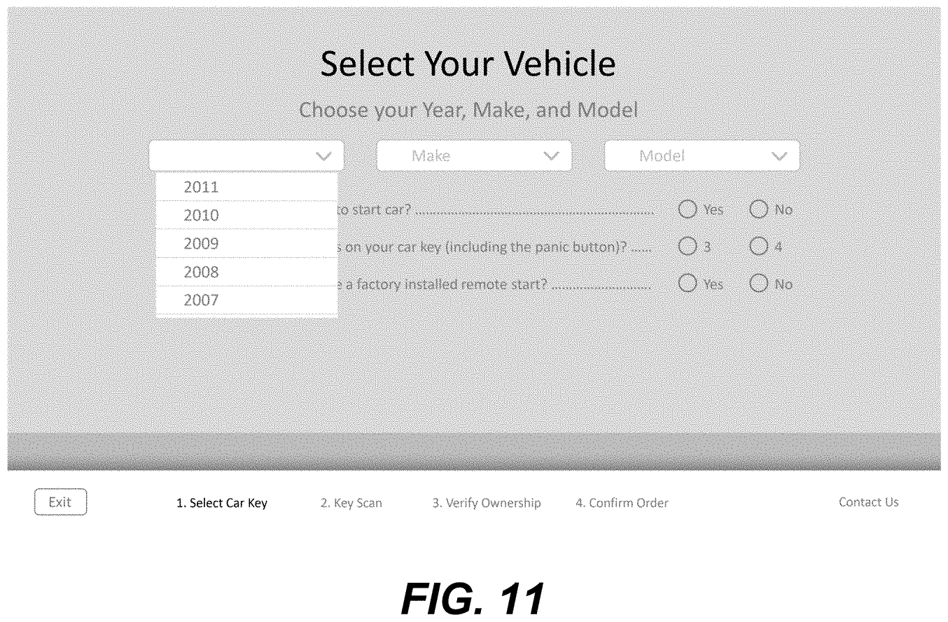

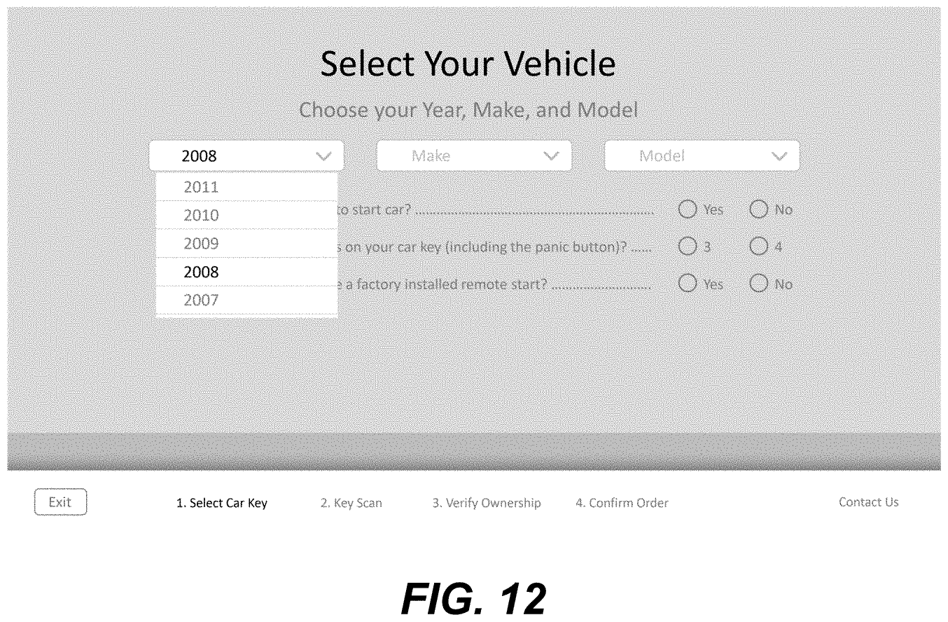

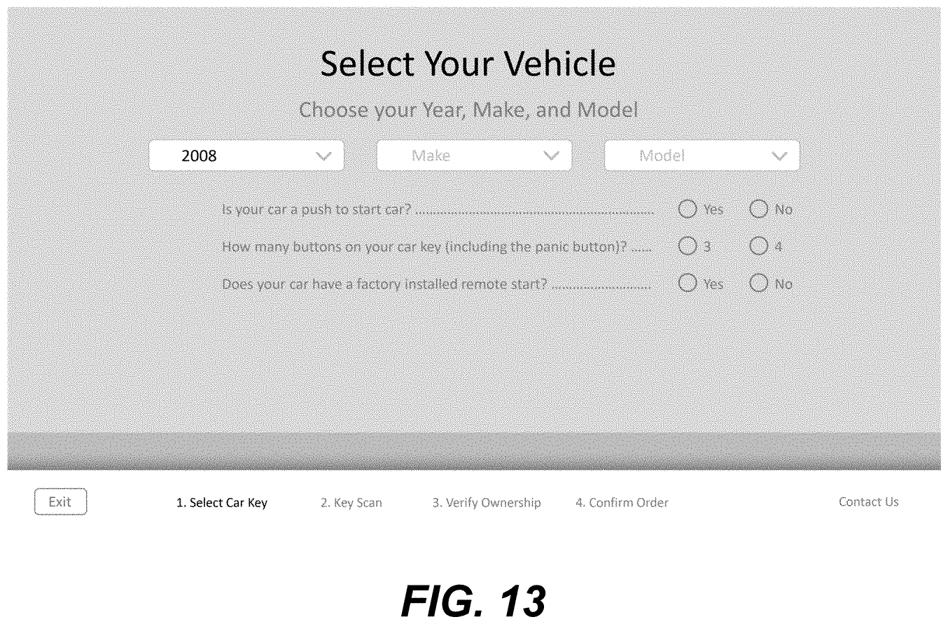

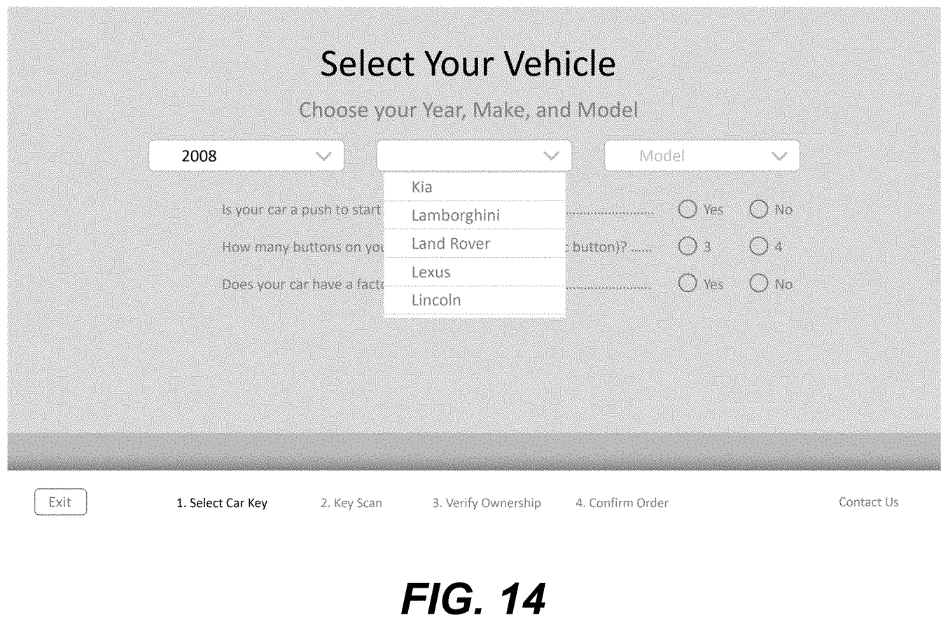

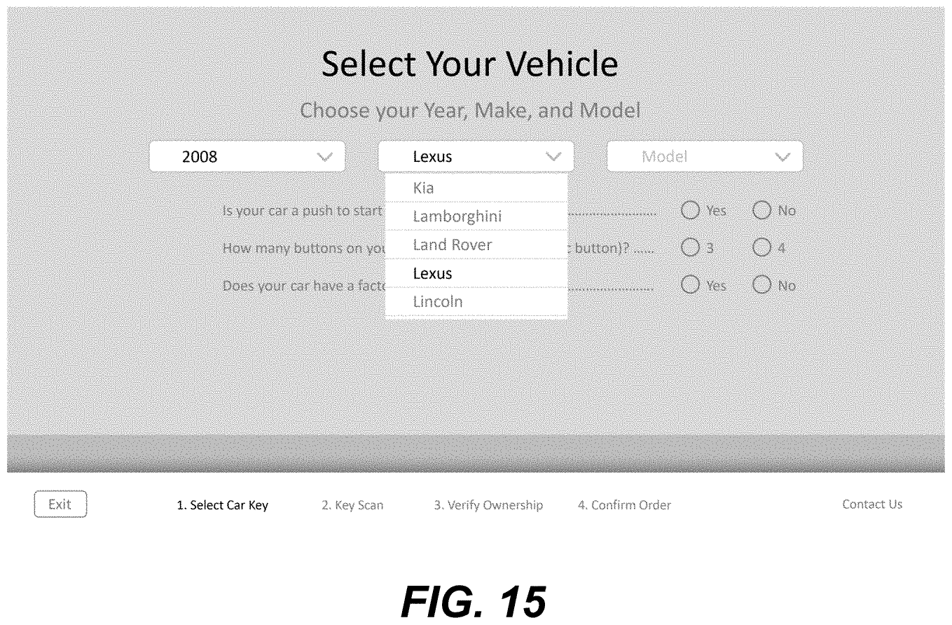

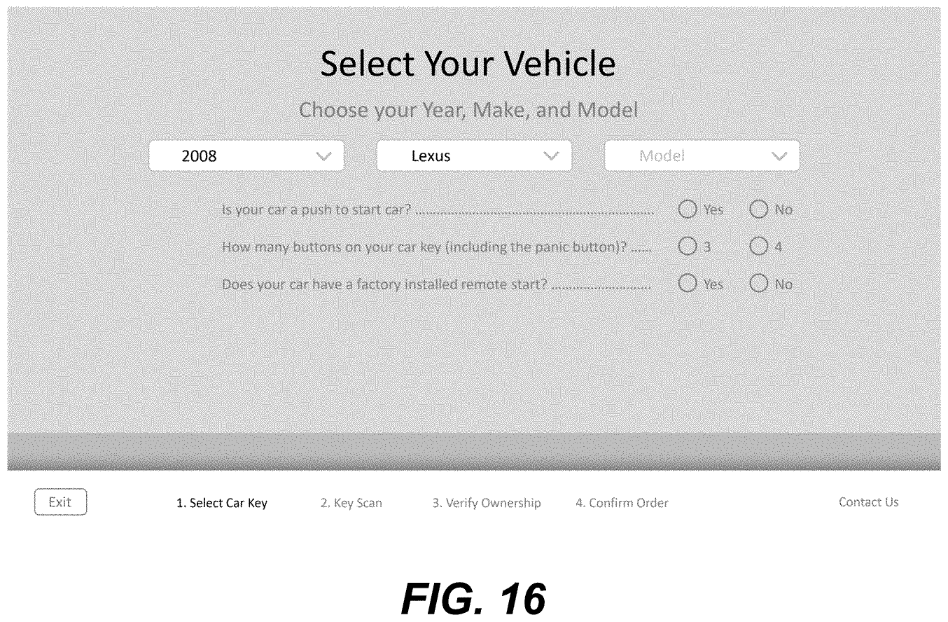

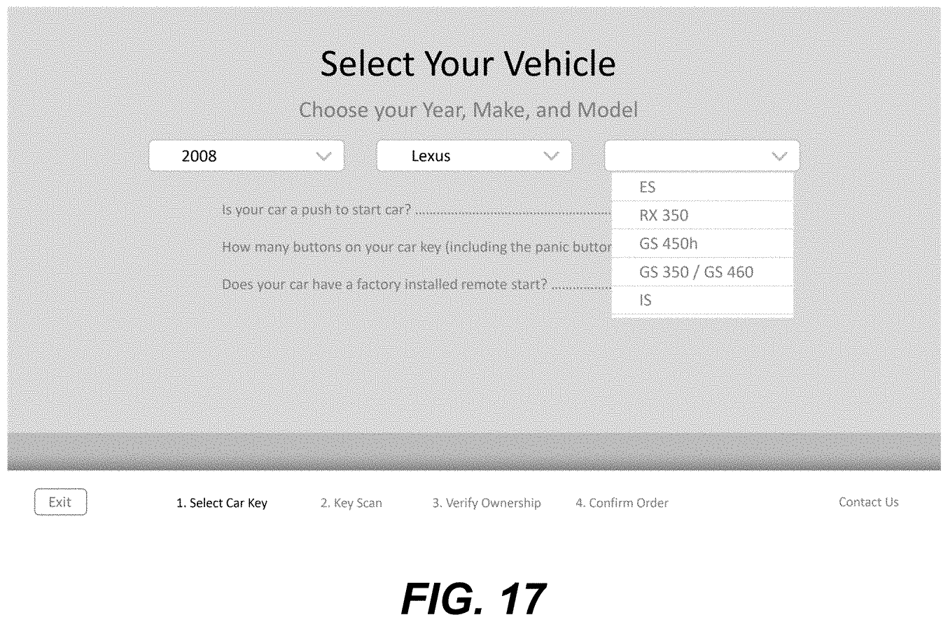

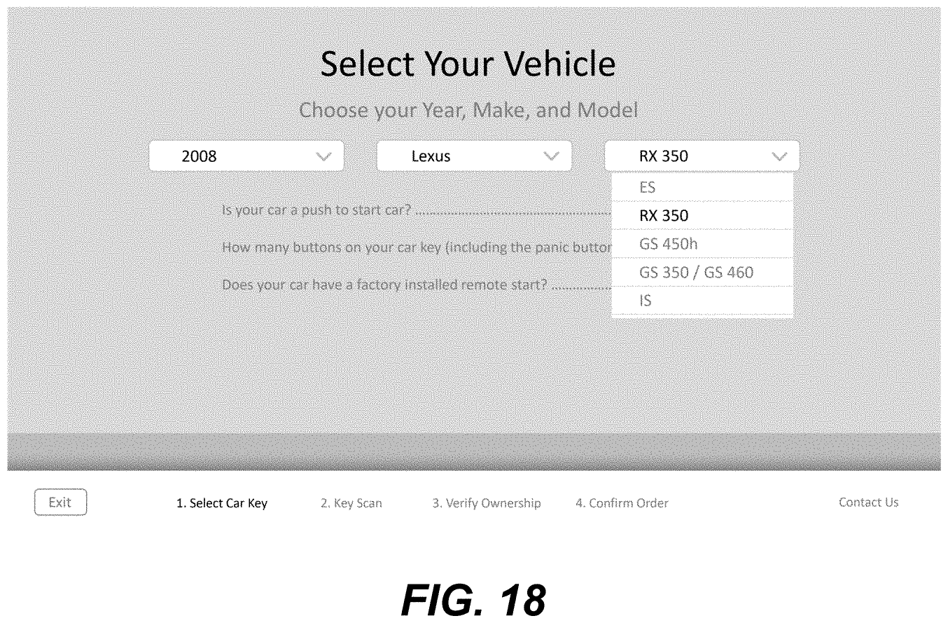

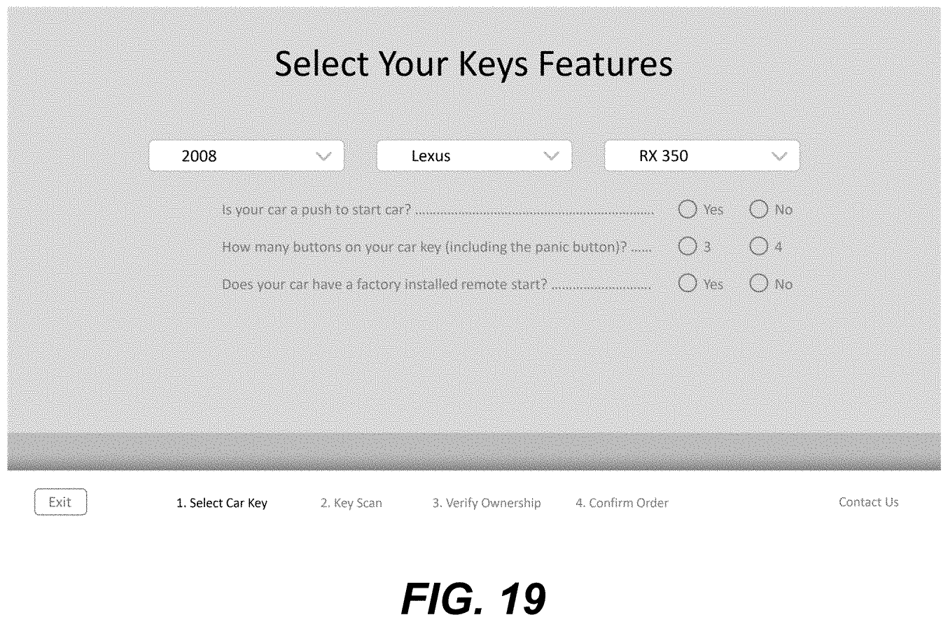

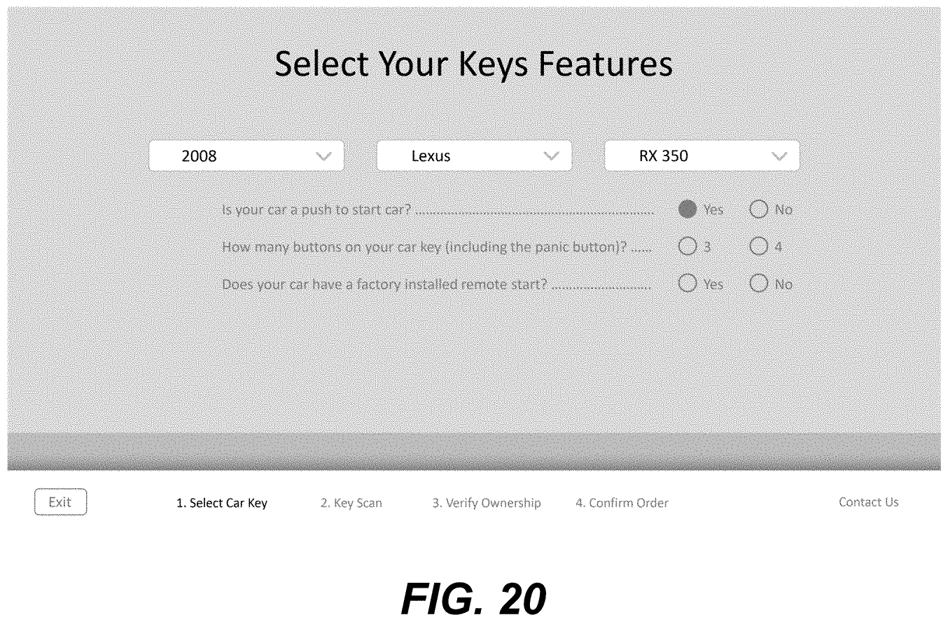

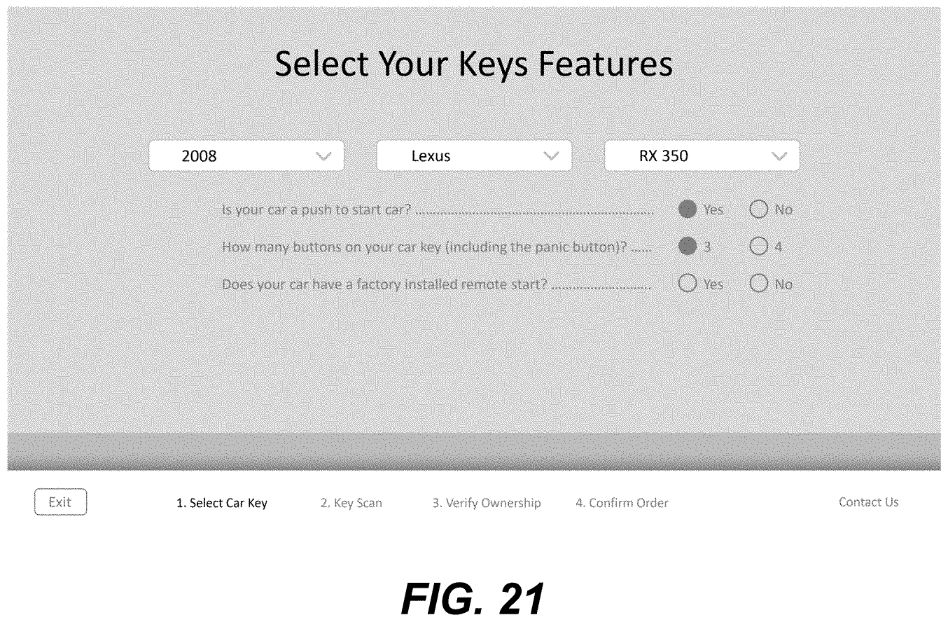

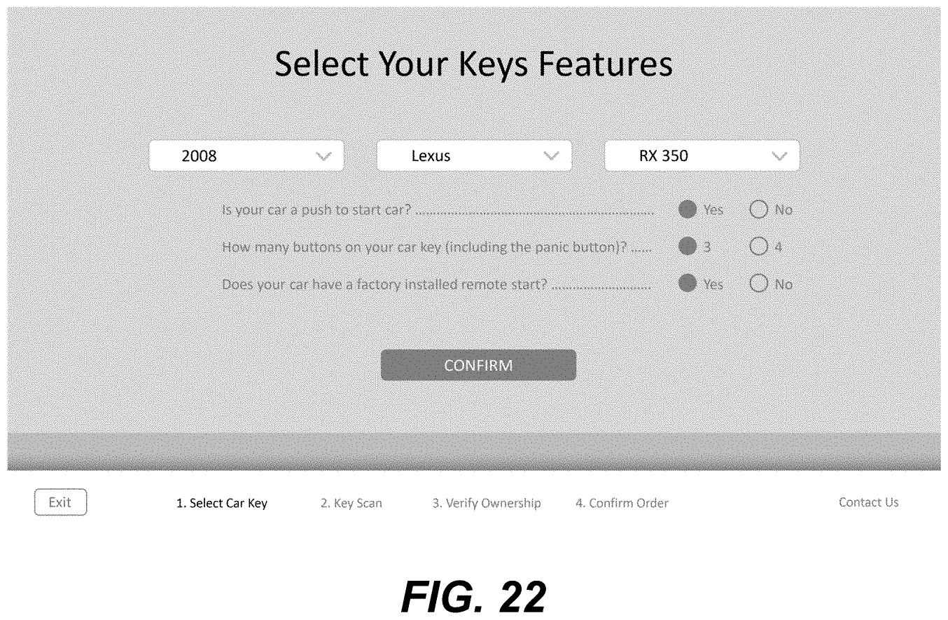

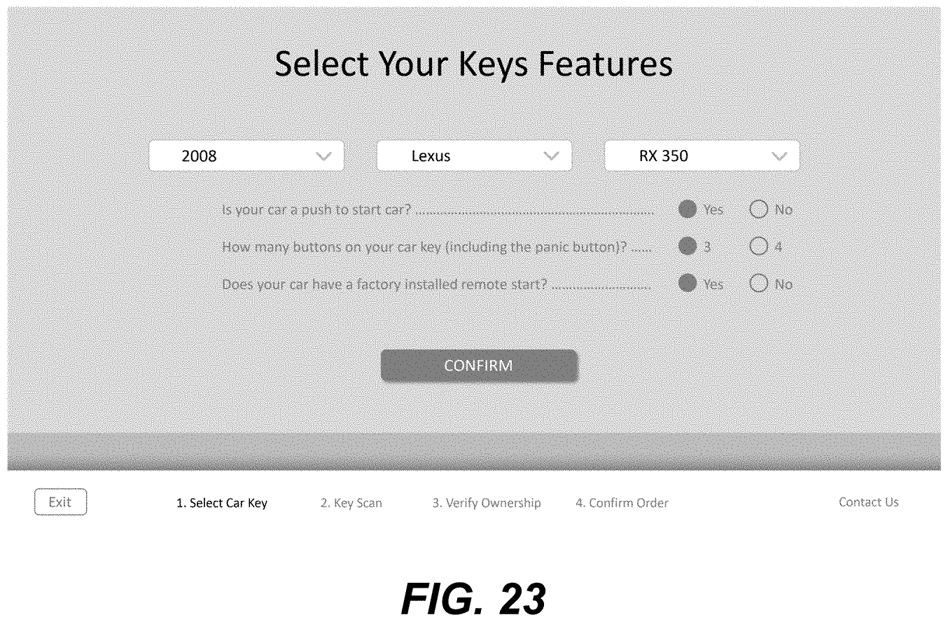

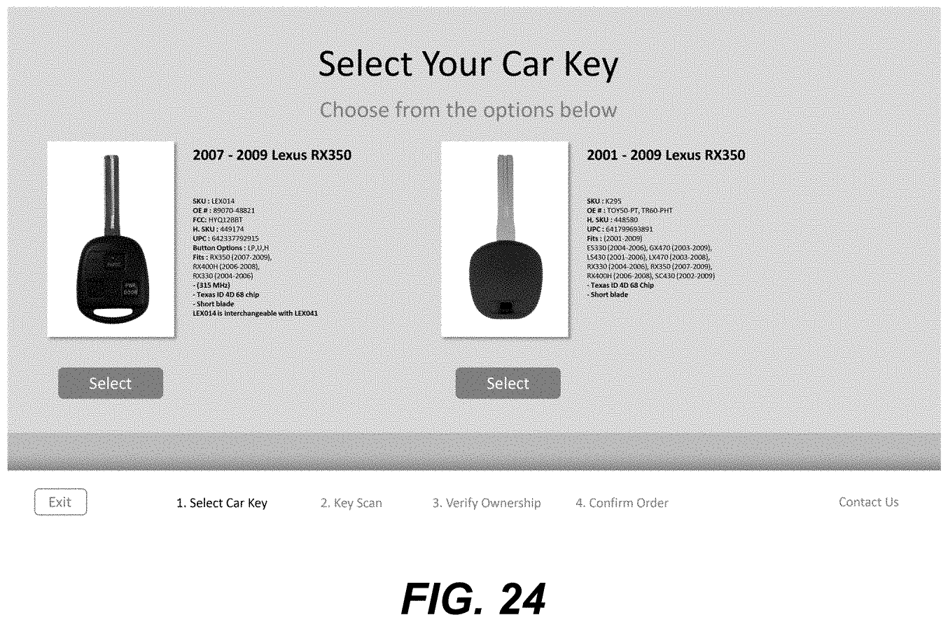

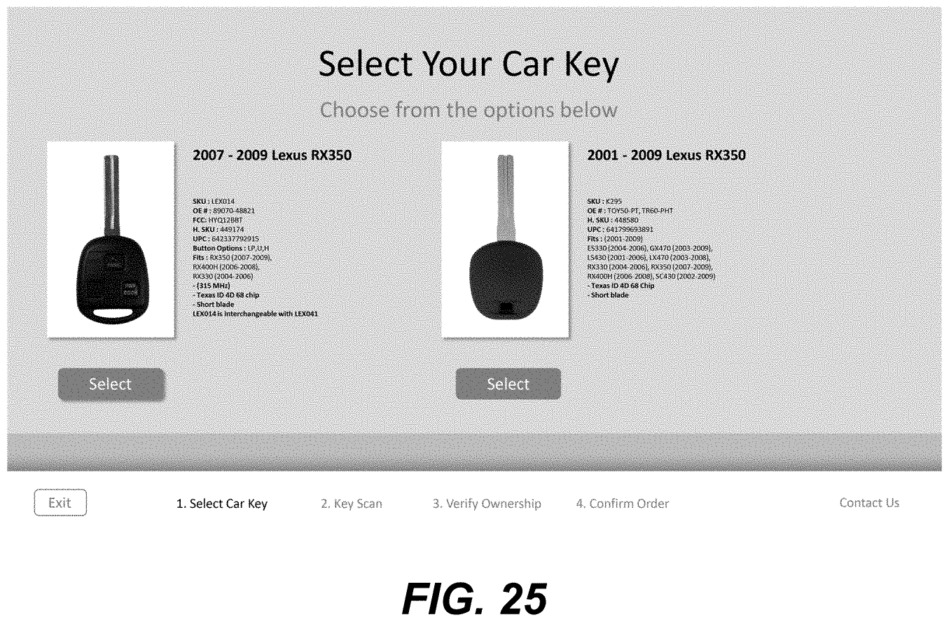

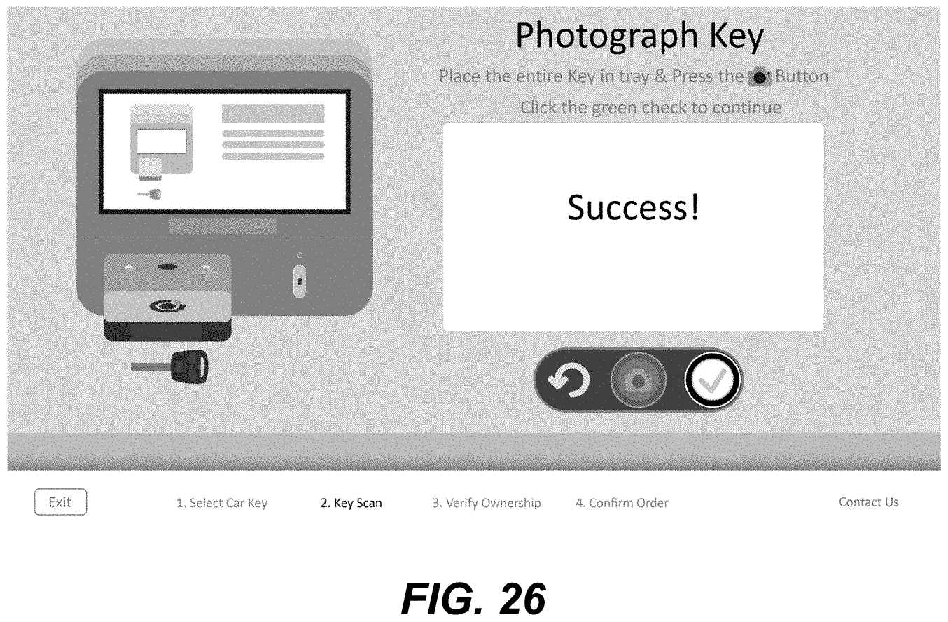

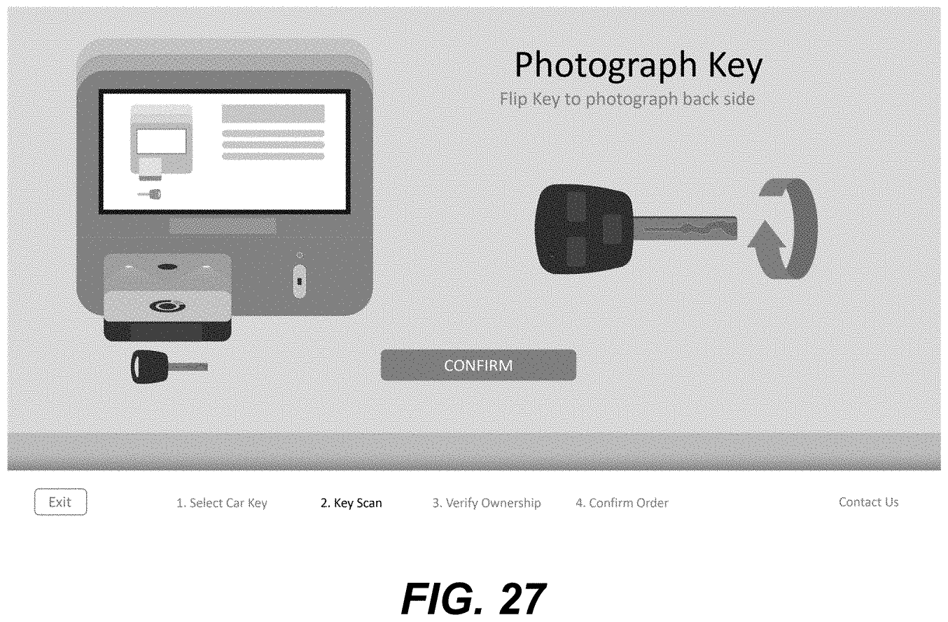

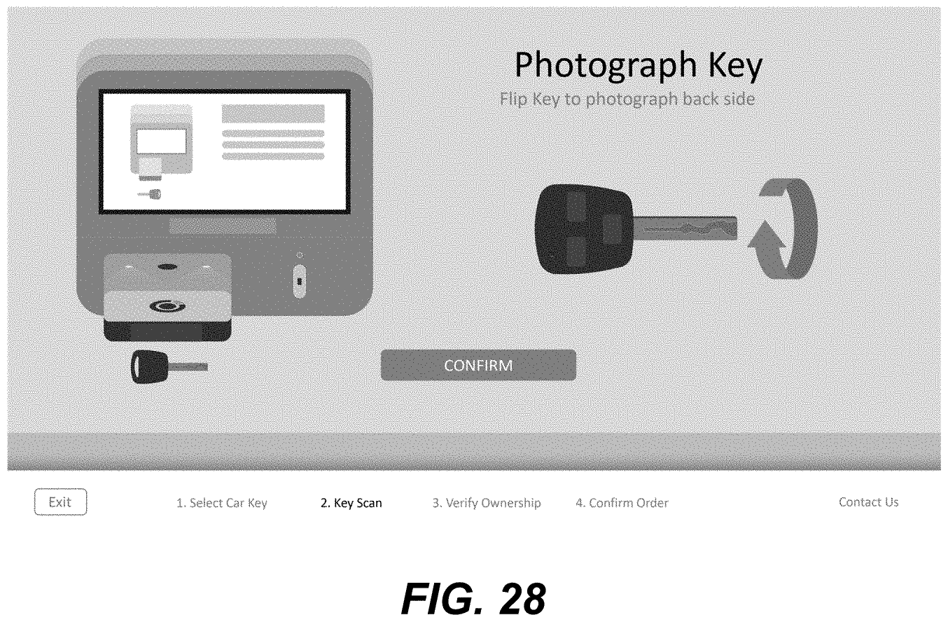

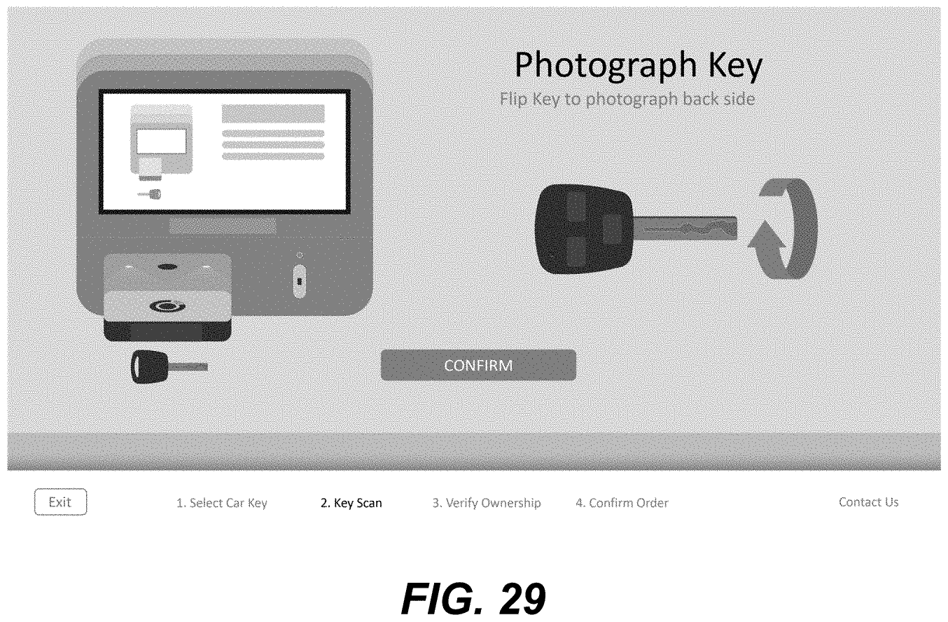

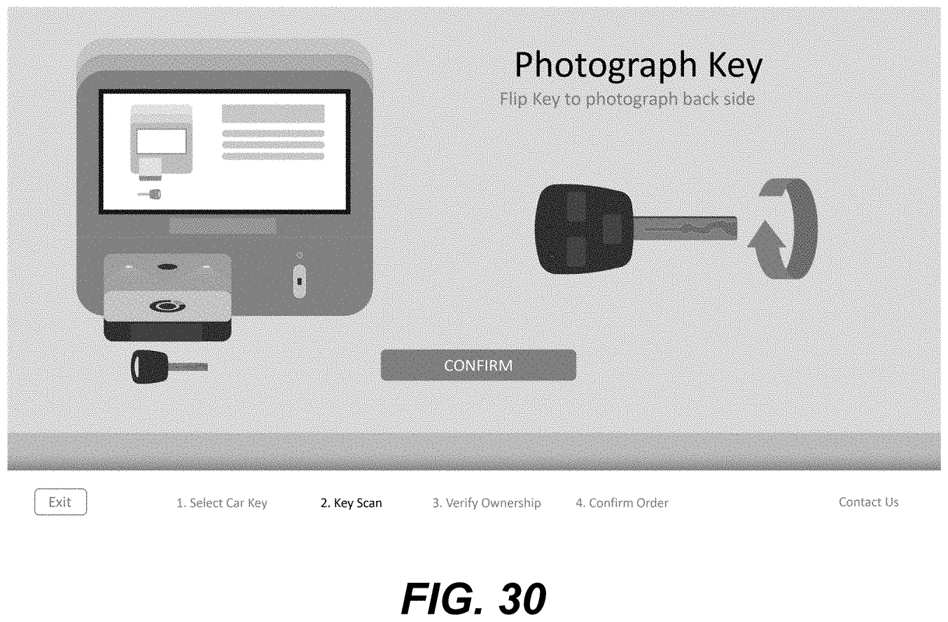

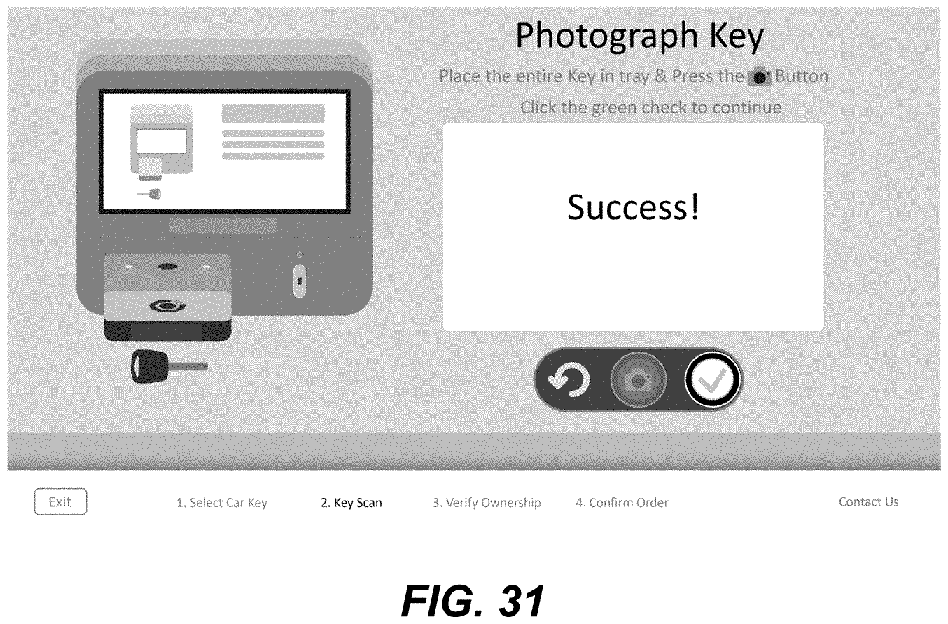

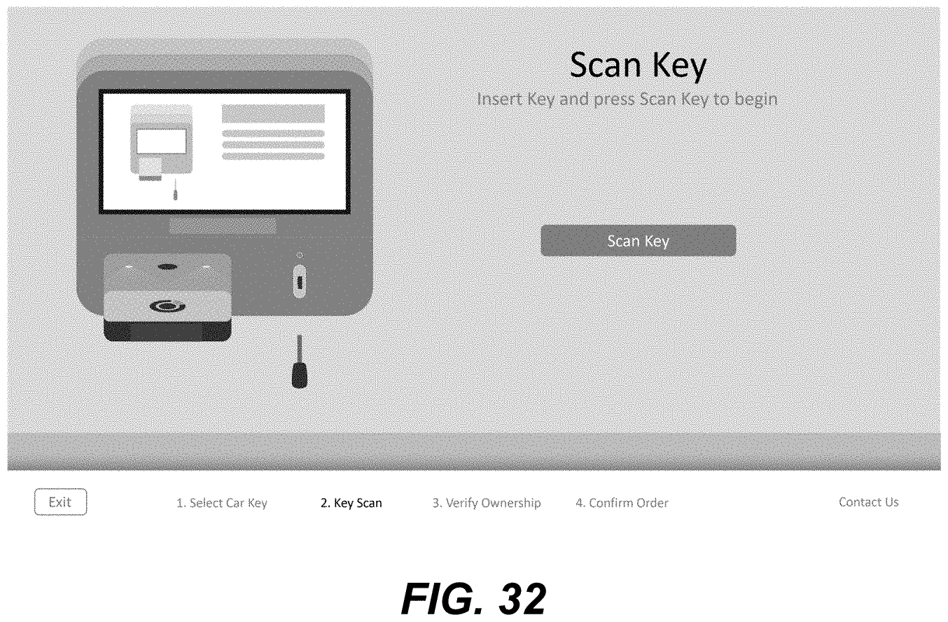

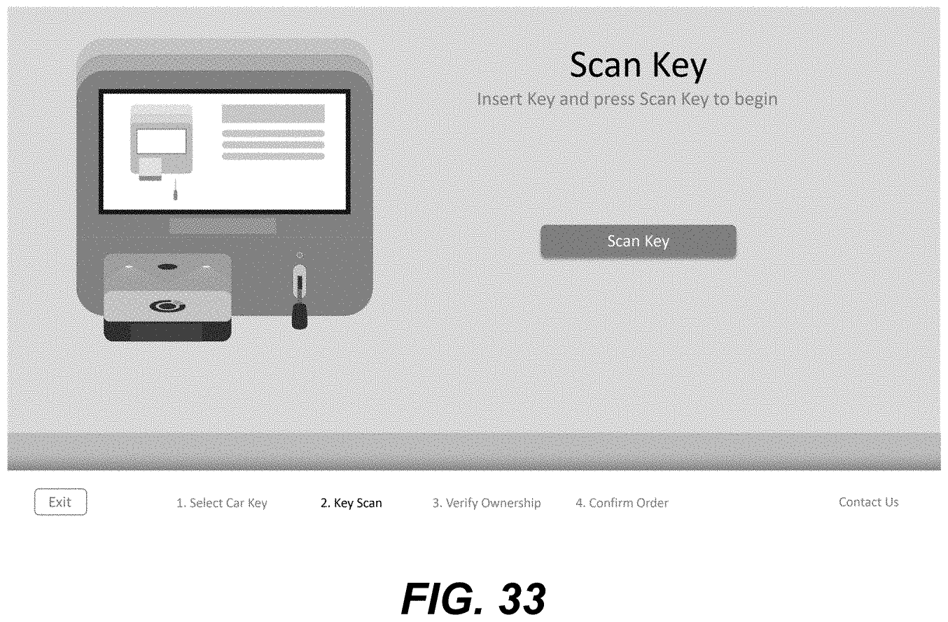

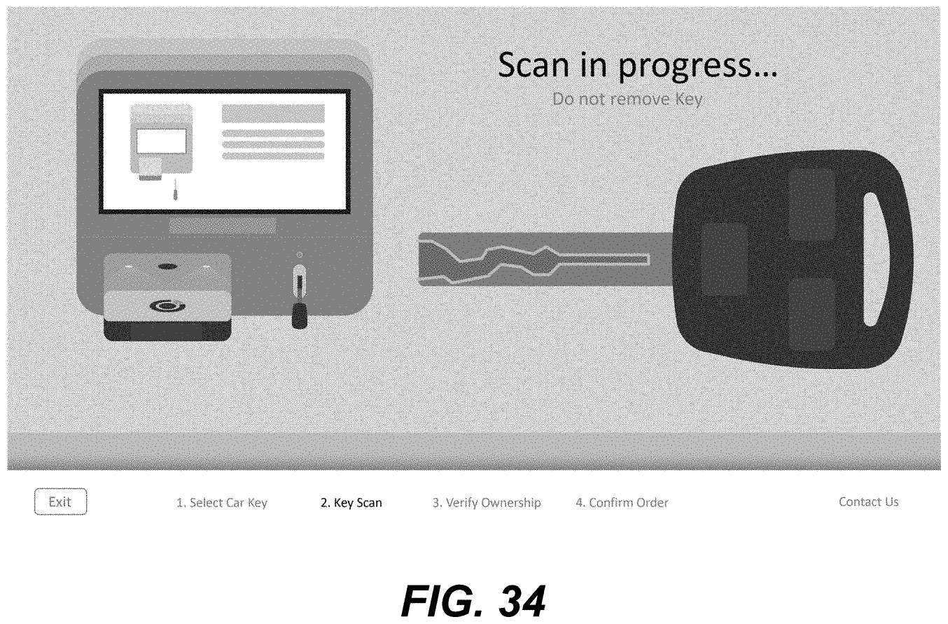

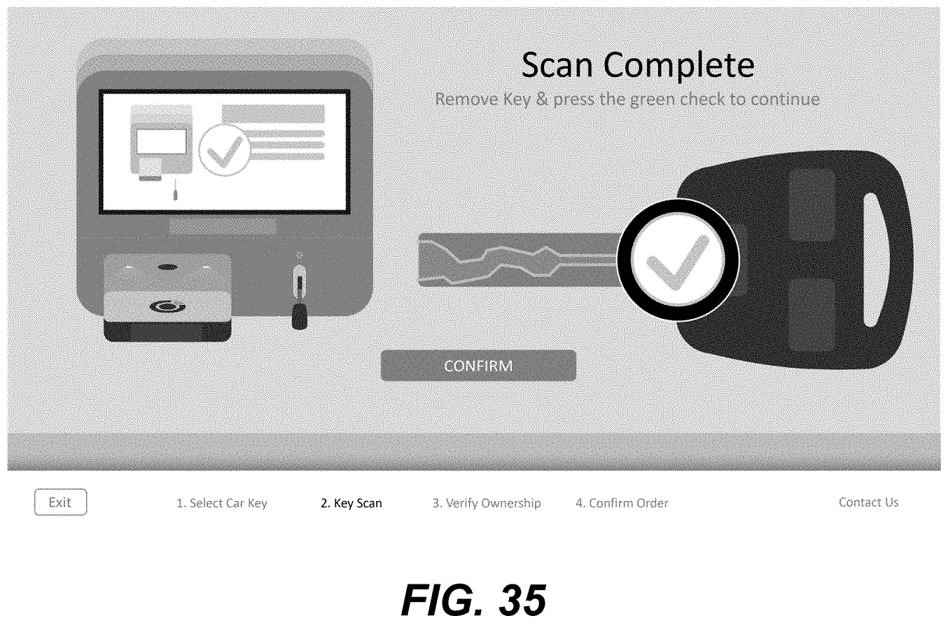

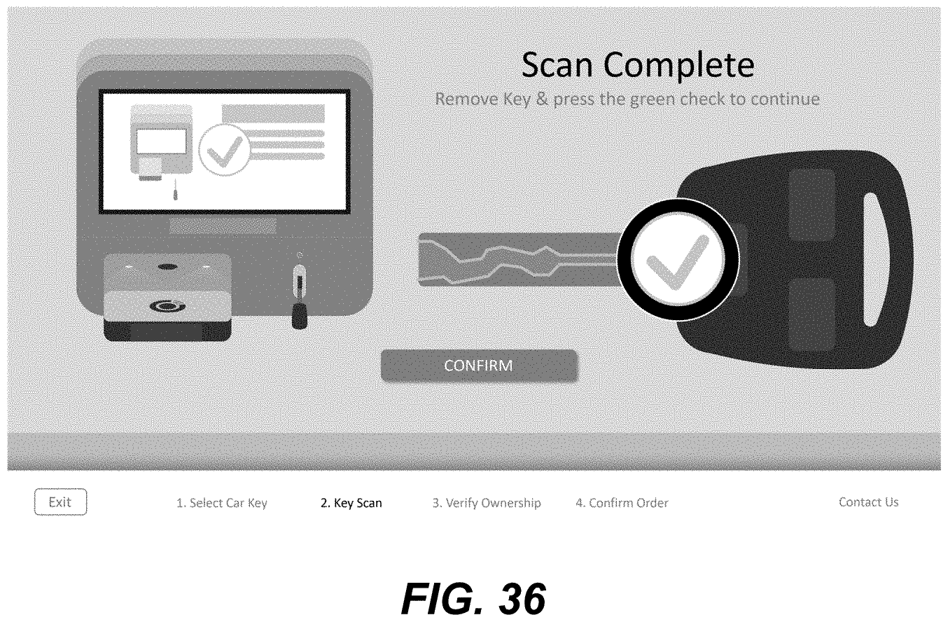

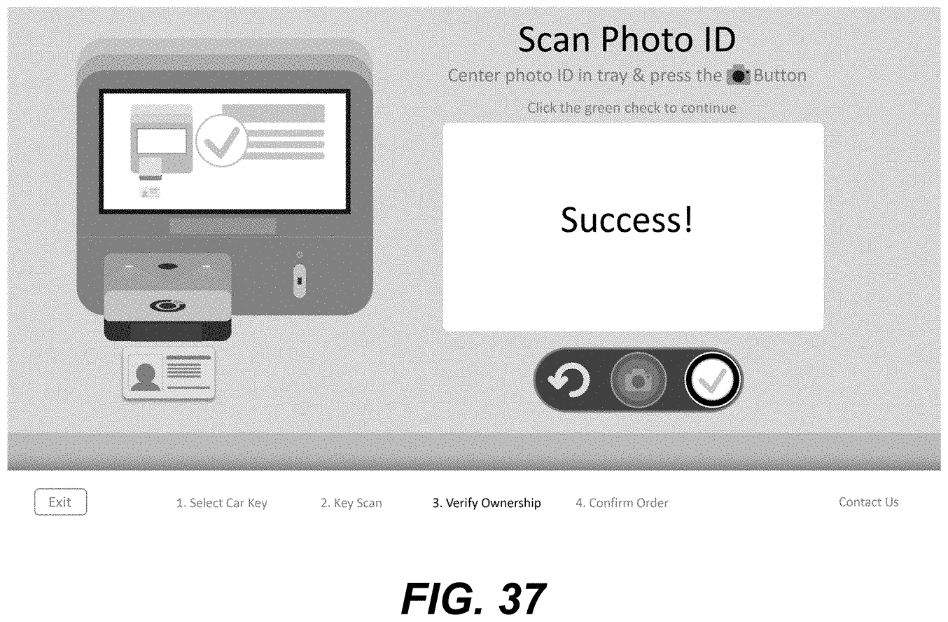

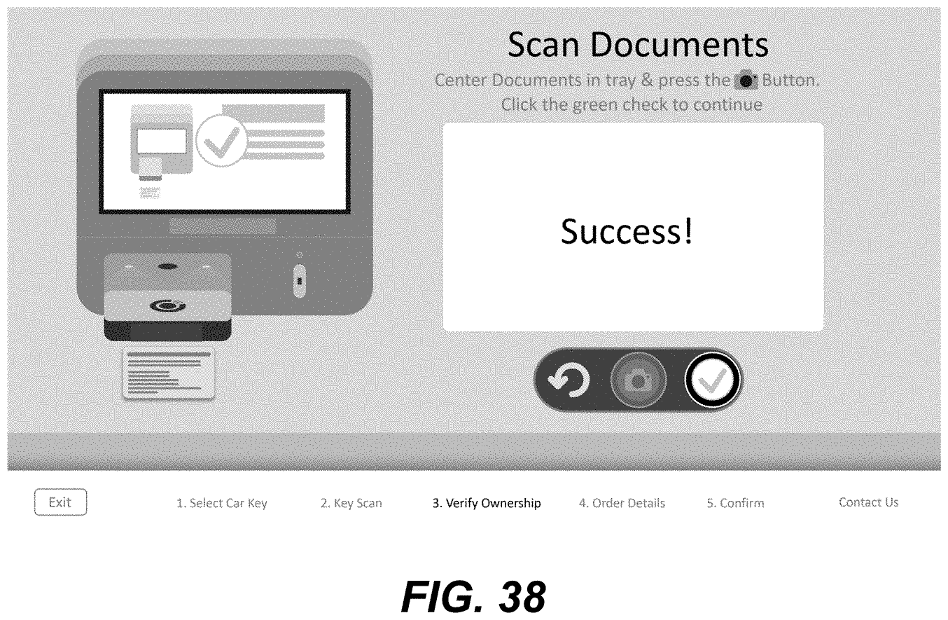

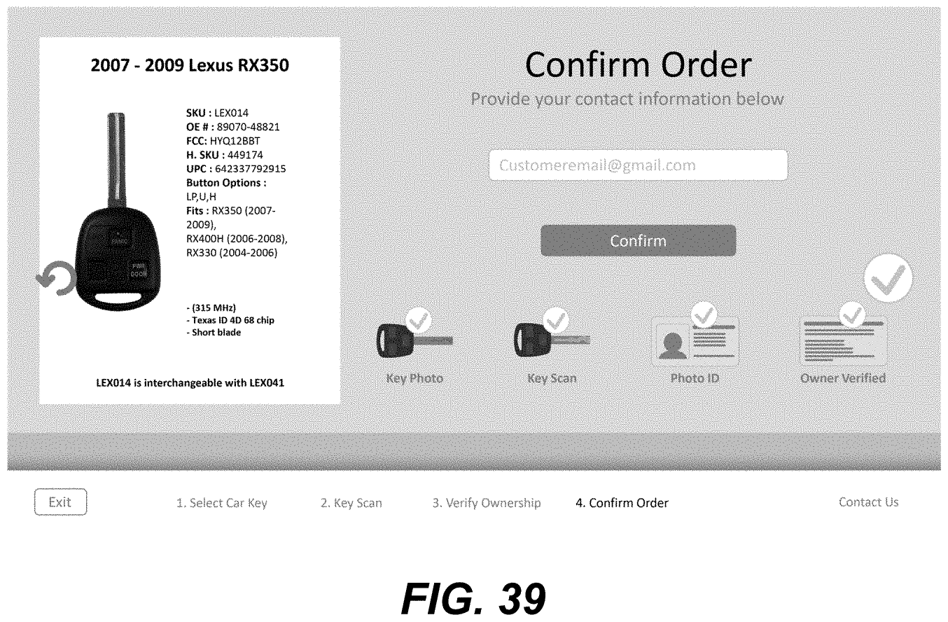

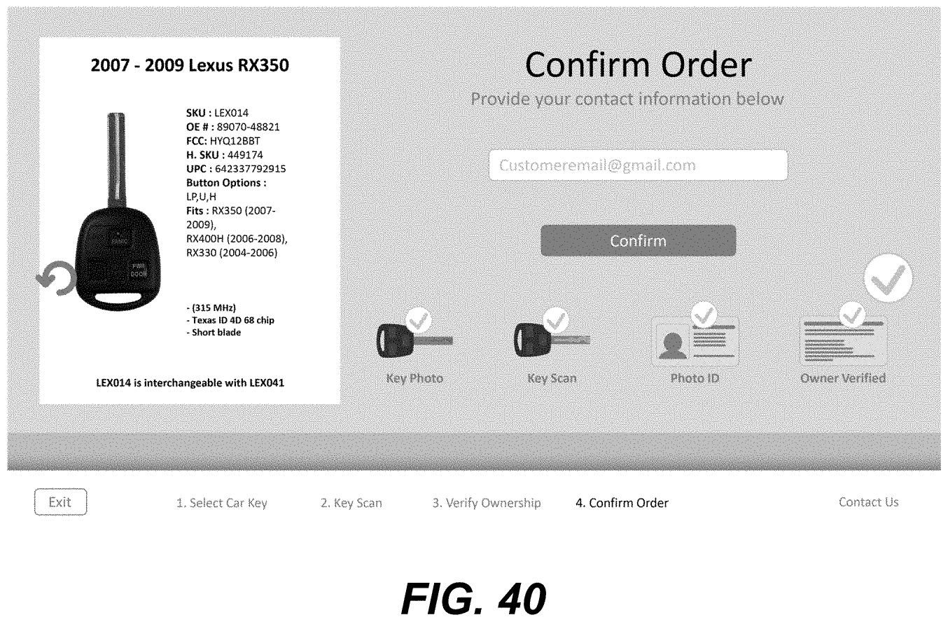

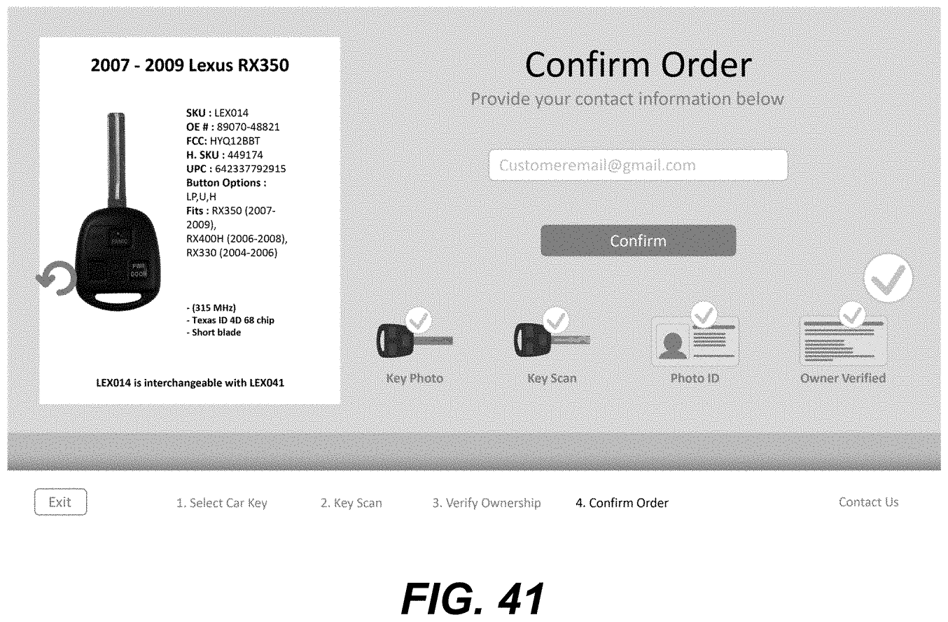

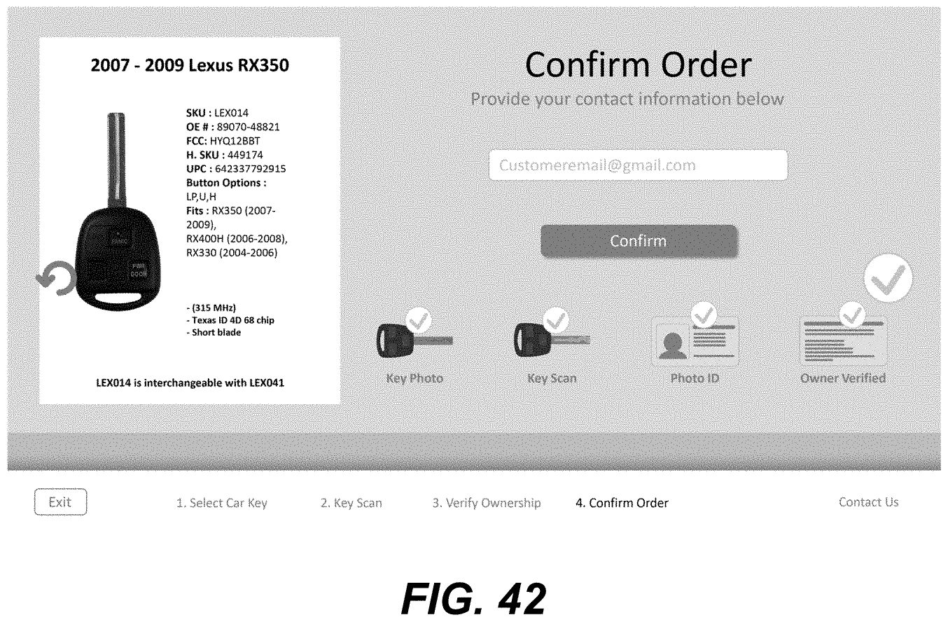

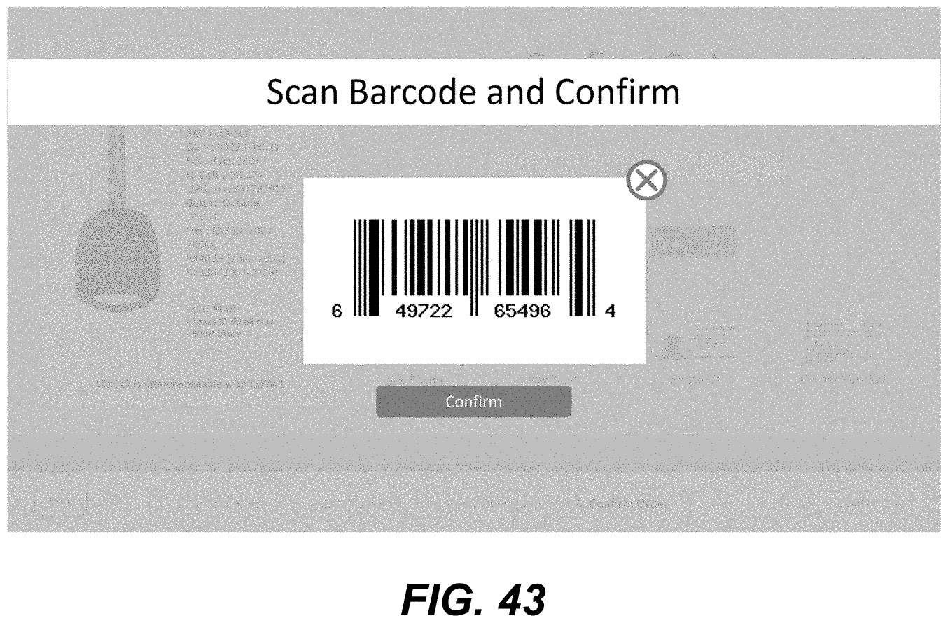

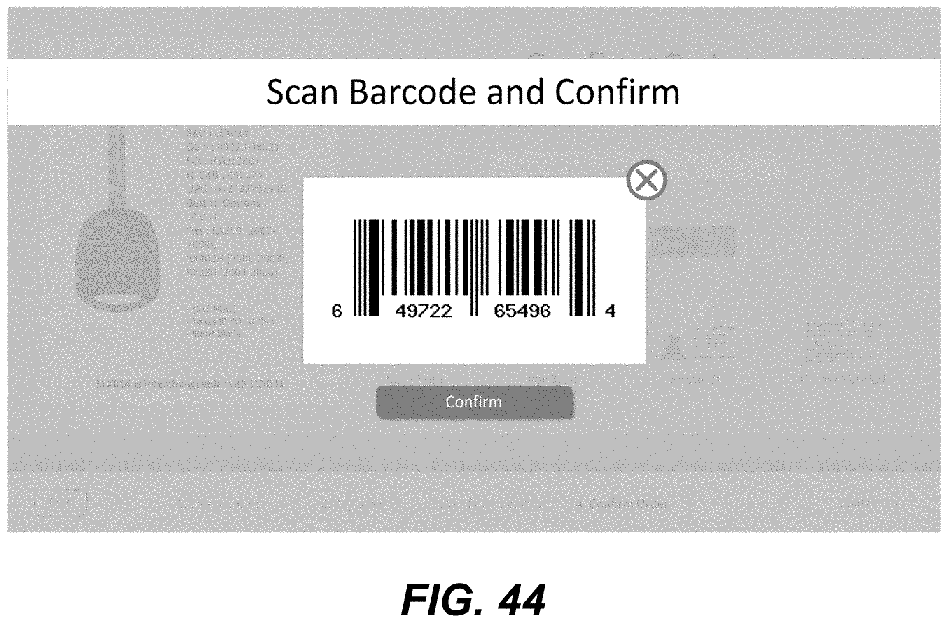

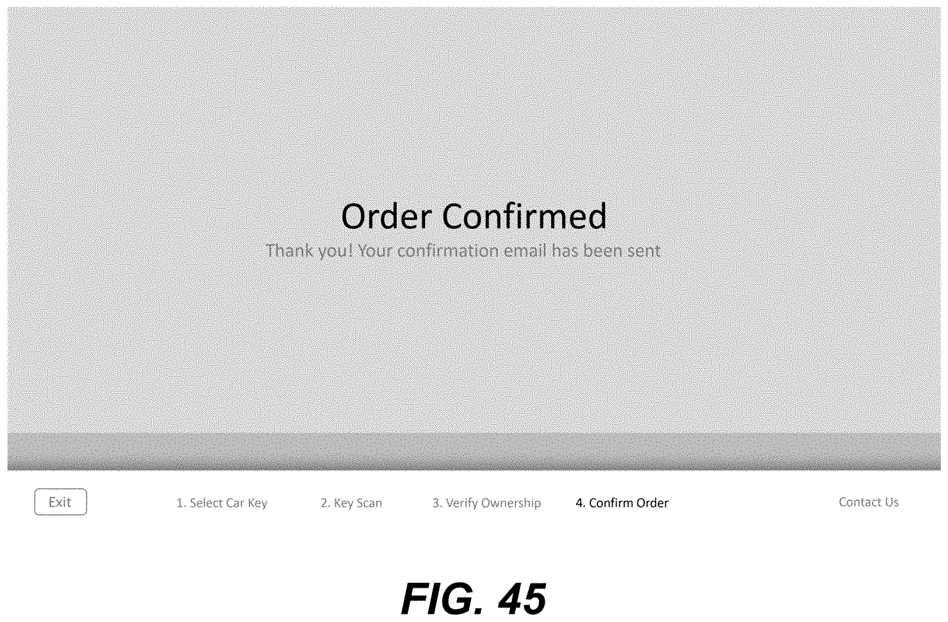

FIGS. 6-45 illustrate exemplary graphical user interface (GUI) displays that may be presented to a user on, for example, display 230 of kiosk 220. As illustrated in FIGS. 6 45, these GUI displays may allow a user to select a make, model, and/or year of their vehicle, provide additional information regarding the key the user wishes to duplicate and select an appropriate key that matches the user's key. The GUI displays may also provide instructions to the user to place the key and/or documents on platform 252, and/or insert the user's key into slot 240 to allow the one or more imaging devices associated with kiosk 220 to capture images of the user's key and/or documents. In addition, the GUI displays may allow the user to enter contact information such as email, phone number, address etc. The GUI displays may also display a bar code or QR code as discussed above. Although FIGS. 6-45 illustrate GUI displays for duplicating a vehicle key, it is to be understood that these illustrations are exemplary and the disclosed key identification and duplication system may be used for duplication of other types of side-milled keys that may not be associated with a vehicle.

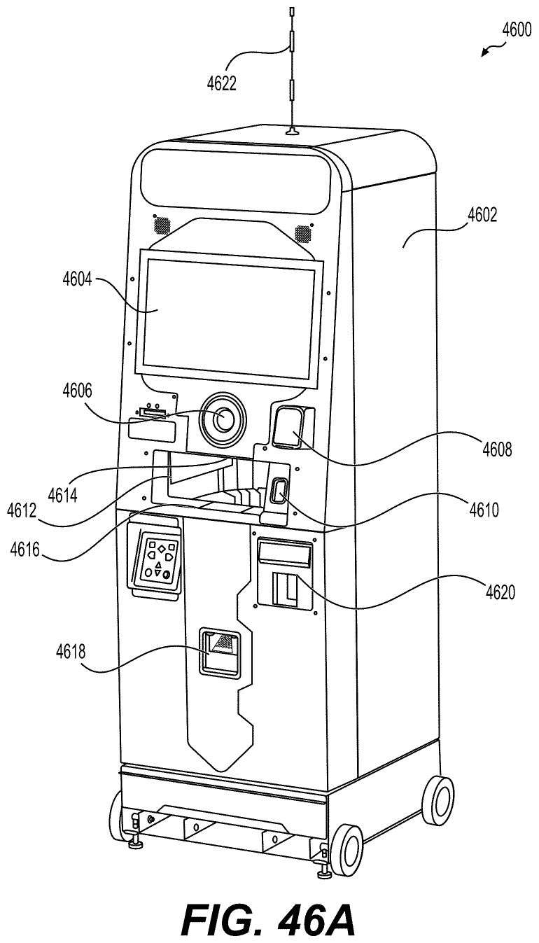

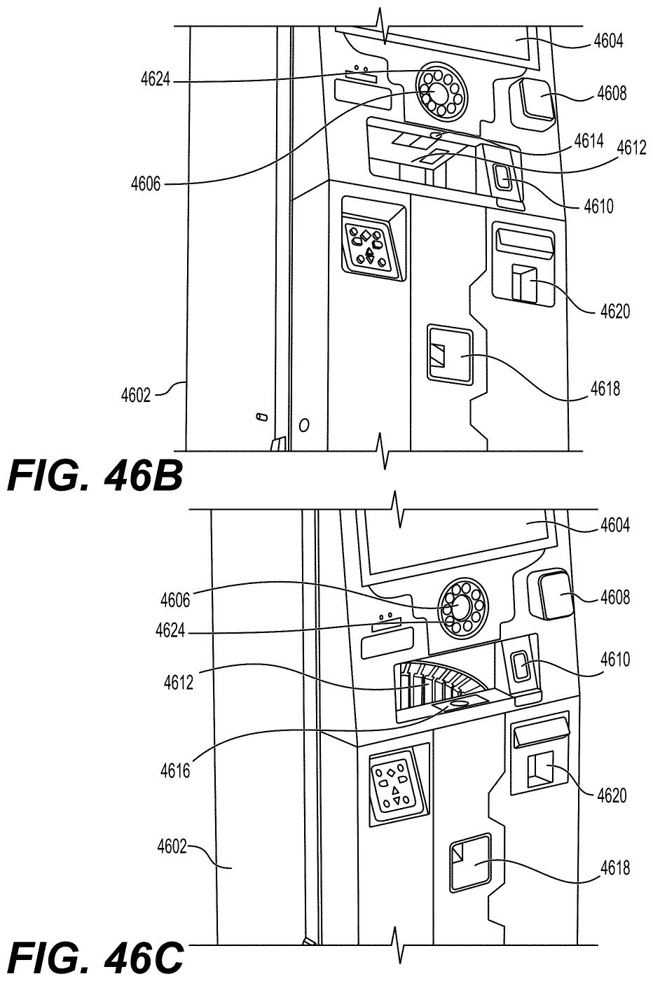

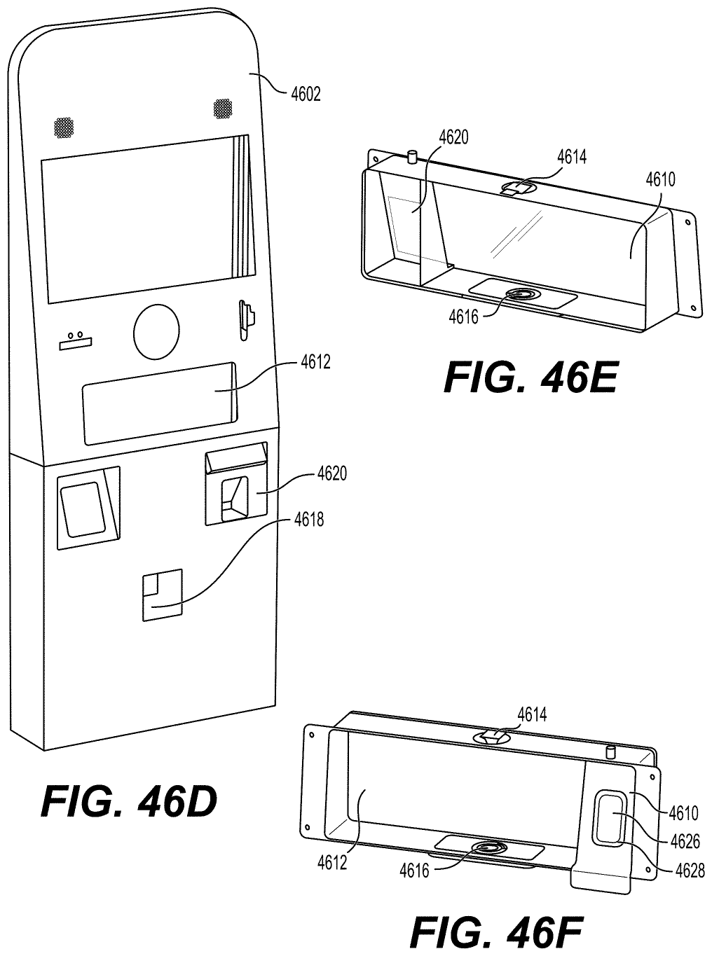

FIG. 46A illustrates an exemplary kiosk 4600 consistent with this disclosure. Kiosk 4600 may be located in a retail location, for example, a grocery or hardware store, shopping mall, or airport, etc. Kiosk 4600 may be configured to identify and duplicate keys or other objects related to access control. Kiosk 4600 may include housing 4602 that may enclose one or more components of kiosk 4600. Kiosk 4600 may also include display 4604, key insertion slot 4606, payment capture device 4608, transponder key reader 4610, viewing window 4612, camera 4614, key fob reader 4616, duplicate key dispenser 4618, and RFID key fob dispenser 4620.

Display 4604 may be positioned anywhere on kiosk 4600. Display 4604 may include a conventional display device, for example, an LCD screen, an LED screen, a cathode ray tube screen, etc. In some exemplary embodiments, display 4604 may be configured to display a graphical user interface, including instructions, advertising, and/or other information. In some exemplary embodiments, display 4604 may additionally or alternatively include a touch screen device configured to receive one or more inputs from a user. Thus, for example, a graphical user interface displayed on display 4604 may allow a user to provide additional information regarding the object, key, or key fob to be duplicated and/or additional information about the user, accept or reject a displayed price, and/or request help on using kiosk 4600. In some exemplary embodiments, display 4604 may be configured to display a virtual keyboard or numeric keypad, which may allow a user to enter payment information, address information, and/or other information associated with duplicating a key or a master RFID key fob.

Key insertion slot 4606 may be configured to allow a user to insert the shank of a physical key that the user wishes to duplicate. For example, display 4604 may display instructions to the user to insert the shank of an existing key into key insertion slot 4606. Kiosk 4600 may include one or more sensors configured to detect insertion of the shank into key insertion slot 4606. As illustrated in FIGS. 46A-C, key insertion slot 4606 may be covered by a door when not in use to prevent debris from entering the system and to prevent damage to internal components. In these embodiments, the door covering slot 4606 may be controlled by one or more processors within kiosk 4600, and may include various switches, levers, springs, etc. to regulate the position and operation of the sliding door.

Kiosk 4600 may include one or more processors, memories, and/or databases and may be configured to determine geometric features of the key inserted into key insertion slot 4606. In alternative embodiments, kiosk 4600 may transmit information, images, etc. over a network such as network 410 to a remote system such as server(s) 420 that may include additional processors, memories, and/or databases. Kiosk 4600 may include an antenna 4622 for purposes of wireless transmission and receipt of information. Antenna 4622 may be configured to connect to a wireless network such as WiFi, a LAN, a WAN, etc.

In some embodiments, kiosk 4600 may include key cutting components within housing 4602. Such key cutting components may include, for example, cutting wheels, edge milling cutters, side milling cutters, drills, saws, laser cutters, etc. Components within kiosk 4600 may be programmed to identify an appropriate key blank within an included magazine or carousel, position the key blank, and to cut notches or other features into the key blank for duplicating the existing key, as discussed in further detail below. Once the key blank has been cut, the duplicate key may be dispensed to the user via duplicate key dispenser 4618. In some embodiments, key dispenser 4618 and RFID key fob dispenser 4620 may be the same; in other embodiments, they may be separate openings in housing 4602.

Kiosk 4600 may be equipped with one or more payment mechanisms configured to receive payment from the user for the desired identification and/or duplication services. In one exemplary embodiment, display 4604 of kiosk 4600 may be configured to display an image of, for example, a bar code or a QR code in a graphical user interface. In other embodiments, an associate at the retail location may be able to scan the bar code or QR code allowing information from the bar code or QR code (e.g., payment information) to be directly imported into the retail location's native payment processing system. In these embodiments, kiosk 4600 may not be equipped with a bill or card acceptor on housing 4602.

In another exemplary embodiment, one or more payment capture devices 4608 associated with kiosk 4600 may include, for example, a cash acceptor, a credit or debit card reader, etc. For example, the cash acceptor may be located on an outer surface of housing 4602 of kiosk 4600. The cash acceptor may be configured to receive currency in the form of bills or coins as payment from a user. In some exemplary embodiments, the payment capture device 4608 may be configured to accept other types of payment such as checks or other forms of electronic payment. In some exemplary embodiments, the payment capture device may be configured to receive payment via wireless, Bluetooth, or NFC communication with another electronic device, for example, a mobile phone, a tablet computer, a laptop computer, a remote server, etc.

Kiosk 4600 may also include a viewing window 4612 that may allow a user to view one or more components located within housing 4602. Window 4612 may also allow a user to view the operation of various components within kiosk 4600 when conducting various object identification and duplication processes. As illustrated in FIG. 46A, in some embodiments viewing window 4612 may be positioned in a manner such that it is set back into a recess. A camera 4614 may be positioned on one surface of the recess, and RFID key fob reader 4616 may be positioned opposite camera 4614. Camera 4614 may be a 2D or 3D camera, video camera, or other type of imaging device. In some embodiments, camera 4614 may be configured to capture one or more images of, for example, an RFID key fob placed by a user onto the surface of key fob reader 4616. In other embodiments, camera 4614 may be configured to capture one or more images of an automobile key that a user of kiosk 4600 wishes to duplicate, such as a remote control device for newer model automobiles that may contain various buttons. The images captured by camera 4614 may be utilized to confirm the proper key blank for duplication of the remote control device (i.e., if the car has a button start or an ignition start requiring a bladed key, whether doors or liftgates are controlled by the remote device, etc.). In still other embodiments, camera 4614 may be configured to capture images comprising information or data associated with the user, including but not limited to identification documents, vehicle registrations, driver's licenses, etc. These examples are not intended to be limiting and camera 4614 can be used for any application where image capture and processing may be useful in object identification.

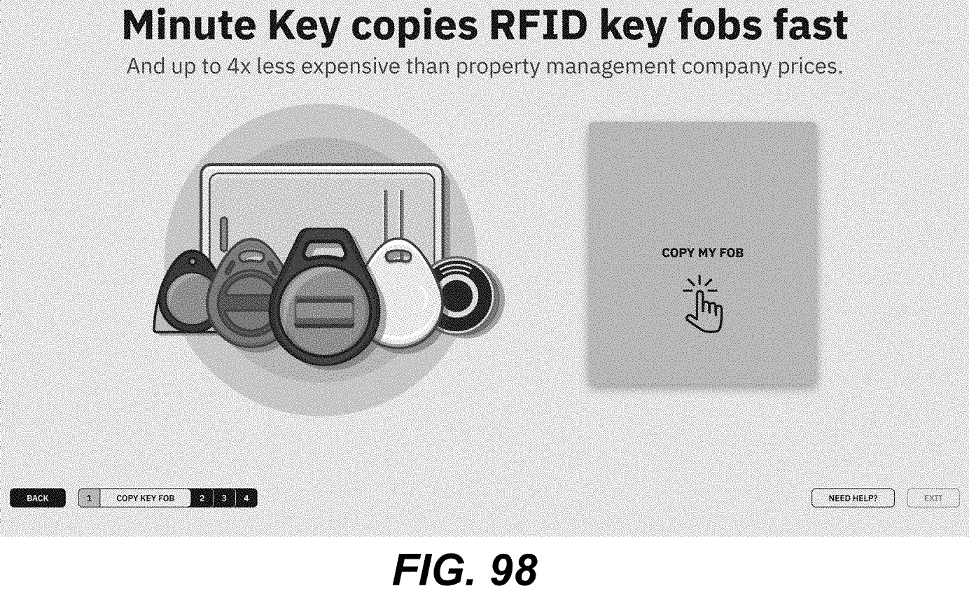

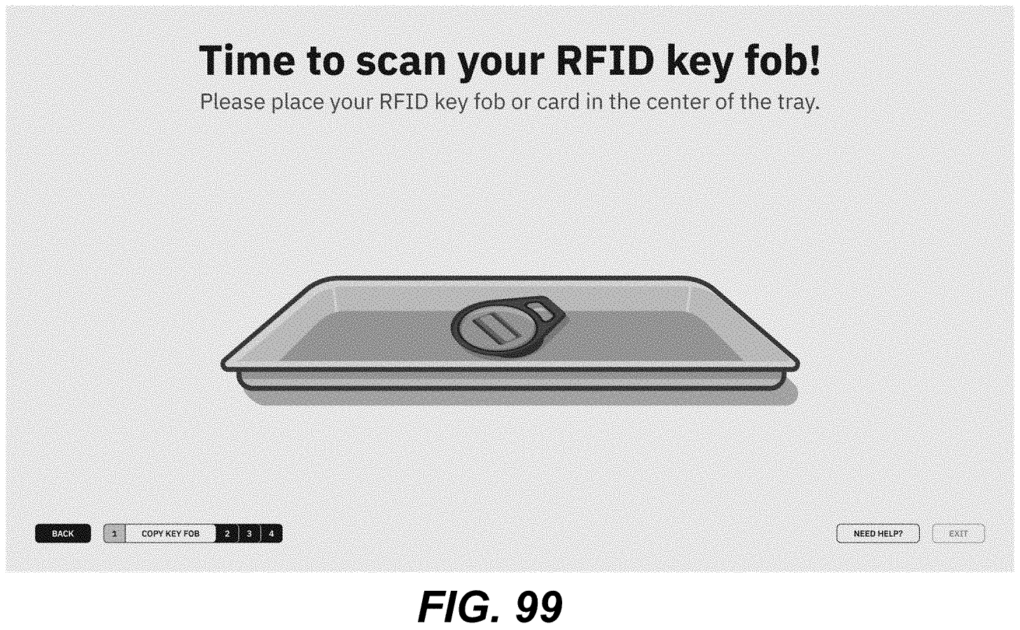

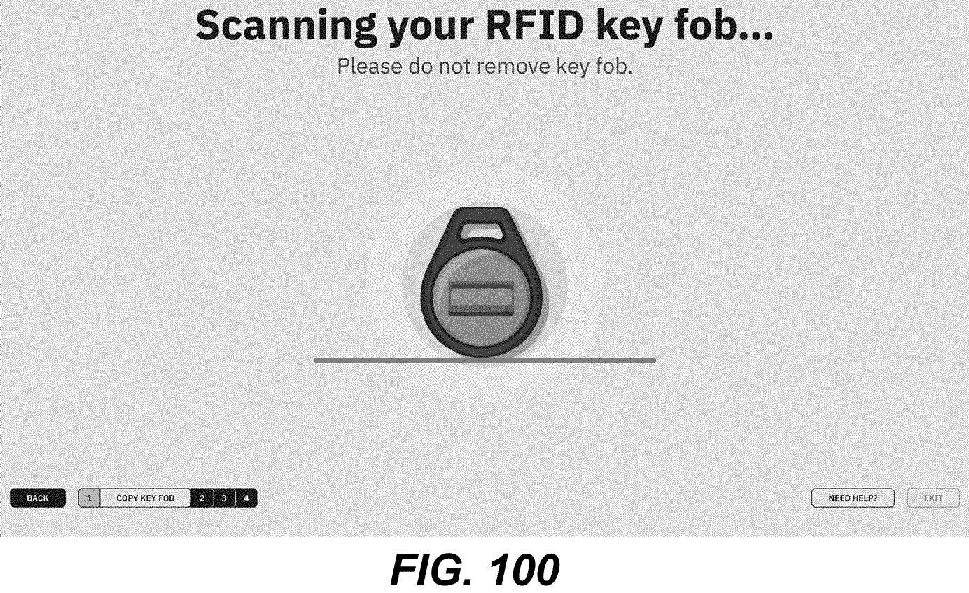

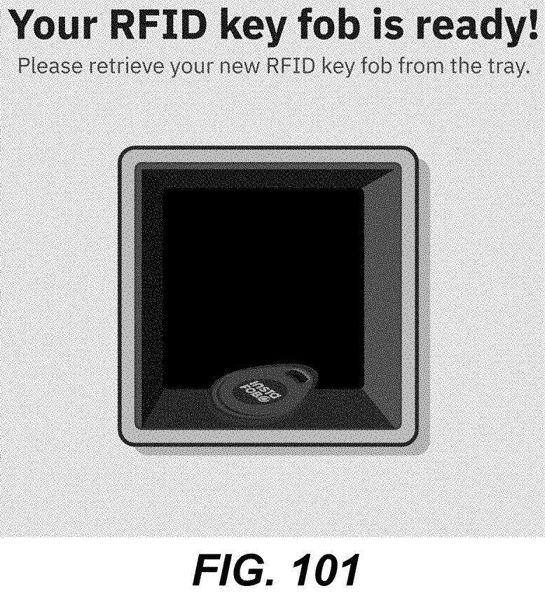

Key fob reader 4616 may include an antenna. Upon detecting the presence of a master RFID key fob, one or more processors of kiosk 4600 may activate the included antenna within key fob reader 4616 to emit an electromagnetic field. A master RFID key fob when placed on key fob reader 4616 may receive the electromagnetic field and in response, the master RFID key fob may transmit data (e.g., one or more codes) stored on the master RFID key fob to key fob reader 4616 and associated hardware. The one or more processors of kiosk 4600 may also cause display 4604 to display instructions to the user regarding duplication of the master RFID key fob (see, e.g., FIGS. 98-101 below). In addition, the one or more processors of kiosk 4600 may cause payment capture device 4608 to receive and/or process payment for duplication of the master RFID key fob.

FIGS. 46B-46C are enlarged detailed front perspective views of the features of kiosk 4600. In some embodiments, the bezel surrounding key insertion slot 4606 and its door may be equipped with a series of LED lights 4624. In these embodiments, these lights may be used for various purposes, including attracting users to kiosk 4600, providing updates on various key identification and duplication tasks, etc. In some embodiments, lights 4624 may all be a single color; in other embodiments, lights 4624 may be multicolor LEDs that can change colors depending on various events.

FIG. 46D is a cutaway view of the front door panel of housing 4602 of kiosk 4600. FIG. 46D shows the various slots and openings that allow kiosk 4600 to receive and dispense various objects, including key and fob dispensers, window 4612, etc.

FIGS. 46E-46F illustrate rear and front detail views, respectively, of window 4612 as well as nearby hardware components such as fob reader 4616, camera 4614, and the transponder key insertion assembly.

In some embodiments, kiosk 4600 may include hardware configured to identify and/or duplicate a key for an automobile or other vehicle that contains a transponder chip. As illustrated in FIG. 46F, transponder key reader 4610 may be positioned in or on the housing 4602 of kiosk 4600. In some embodiments, transponder key reader 4610 and key insertion slot 4606 may be separated. In other embodiments, transponder key reader 4610 and key insertion slot 4606 may be co-located in the same position. FIGS. 46E-F illustrate an exemplary embodiment where the two slots are separated, but one of skill in the art would recognize that the two slots could be configured to be placed in the same location, minimizing any potential electromagnetic interference.

In the embodiment illustrated in FIG. 46F, transponder key reader 4610 has an insertion slot covered by door 4626. Like the door associated with key insertion slot 4606, door 4626 prevents dust and debris from reaching sensitive electronics, and also prevents external tampering. In these embodiments, door 4626 may also be surrounded by LEDs 4628. Like LEDs 4624 associated in some embodiments with key insertion slot 4606, LEDs 4628 may serve multiple purposes with respect to kiosk 4600, such as attracting users to the kiosk, helping users find transponder key reader 4610, providing information about the status of a transponder key identification process, etc.

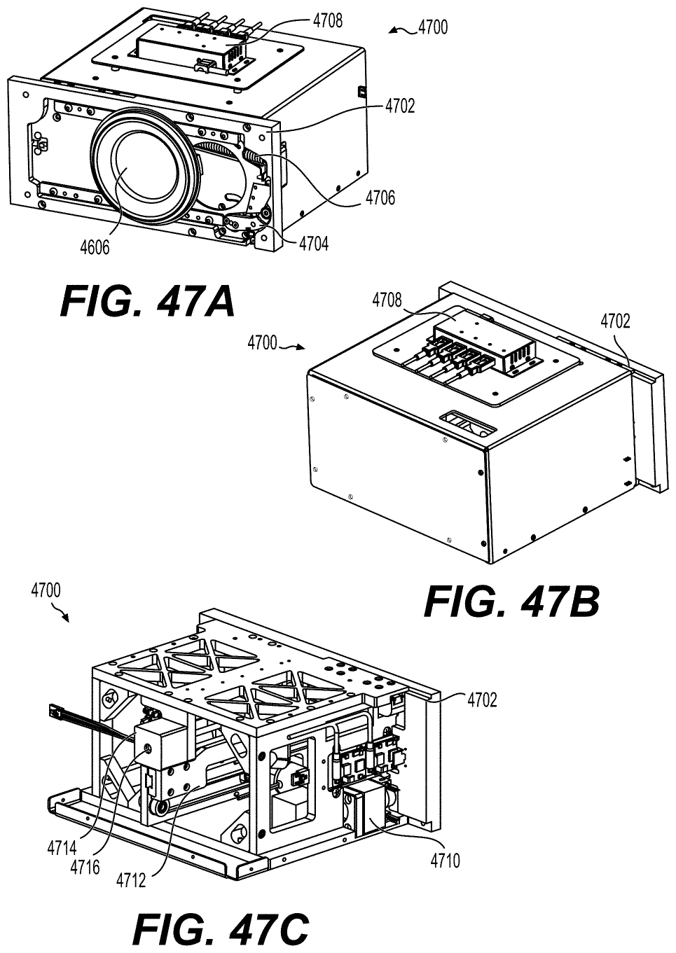

FIG. 47A illustrates an exemplary key identification system 4700. In some embodiments, key insertion slot 4606 is covered when not in use by a door, as described above. Door assembly 4702 is one potential configuration for such a covering. In these embodiments, door assembly 4702 and associated hardware, such as door cam 4704 and door spring 4706, may be configured to provide security for the components of kiosk 4600 while also keeping users safe. Door assembly 4702 may be configured in a manner that prevents human fingers from being trapped and/or cut by the opening and closing of the door. The movement of door assembly 4702 may be regulated by a stepper or servo motor (not shown), as well as various sensors and optical switches. In some embodiments, door assembly 4702 may be configured to release or otherwise translate in the case of power failure, to prevent a user's key from being stuck indefinitely in key insertion slot 4606.

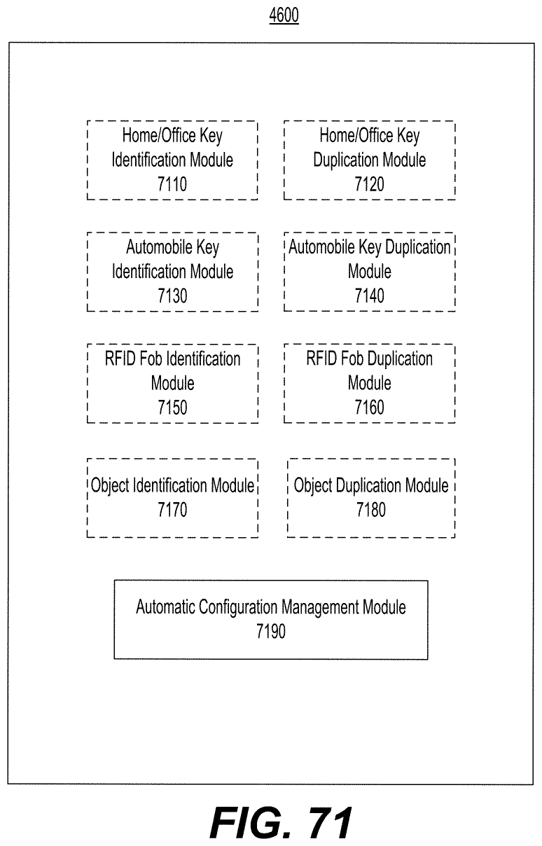

USB hub 4708 may be situated atop the box surrounding key identification system 4700, or anywhere else convenient. USB hub 4708 may be configured to facilitate customization of kiosk 4600 for different retail environments and scenarios, by allowing easy plug-and-play capabilities for various identification, duplication, and software modules. As will be described in further detail below in association with FIG. 71, there are no set minimum or maximum number of modules that can be equipped for a particular kiosk 4600. A particular kiosk within a network of kiosks may have a key identification system, a key duplication system, a transponder key identification system, a transponder key duplication system, an RFID fob identification system, an RFID fob duplication system, all, none, etc. Each system or subsystem is USB-equipped and can be swapped in and out of kiosk 4600 within minutes via USB hub 4708.

FIGS. 47B-47C illustrate rear views of key identification system 4700. When an existing key is inserted into key insertion slot 4606, in some embodiments it may be clamped to facilitate improved image resolution. In these embodiments, clamp motor 4710 may provide force to an associated clamp assembly (not shown). The key clamp may comprise any suitable hardware configuration known in the art, such as actuators, grips, H-bridges, etc.

In some embodiments, key identification system 4700 may include a tip stop assembly, including tip stop gantry 4712. The tip stop assembly may serve multiple functions within key identification system 4700, including providing haptic feedback to a user as they insert an existing key into key insertion slot 4606, ejecting keys and other implements inserted into key insertion slot 4606, and assisting with key measurements based on the displacement of the tip stop as the key is inserted. The tip stop assembly may include or be associated with a motor, such as a servo motor, that provides the resistive force.

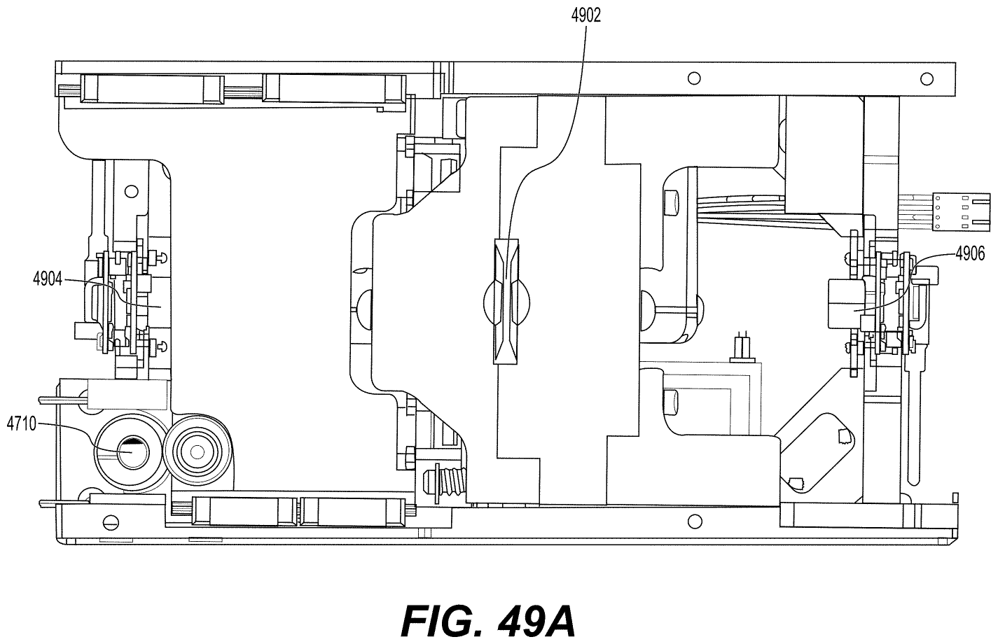

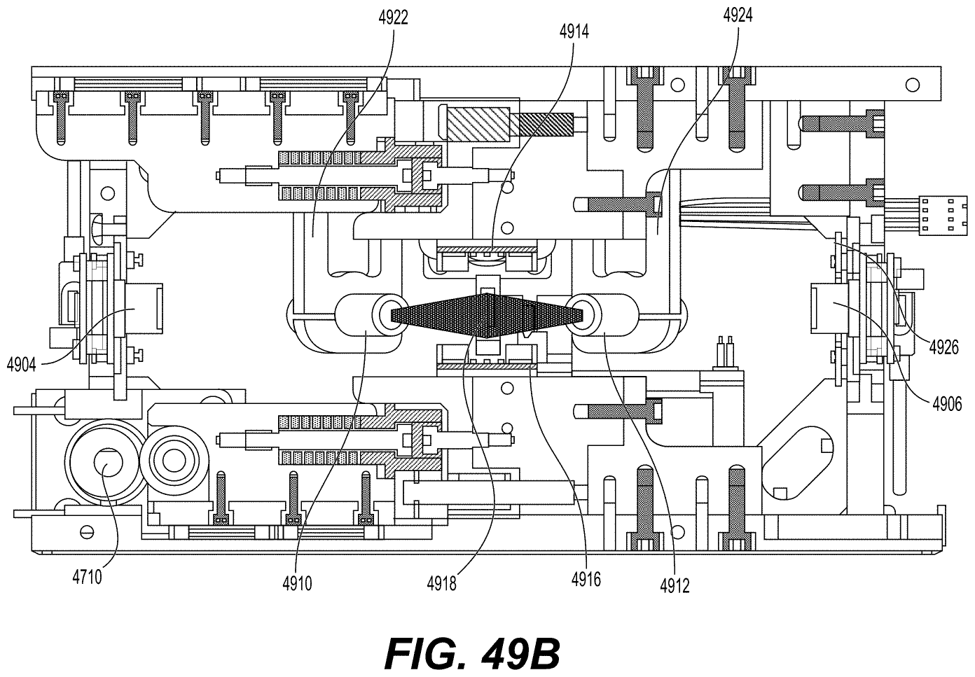

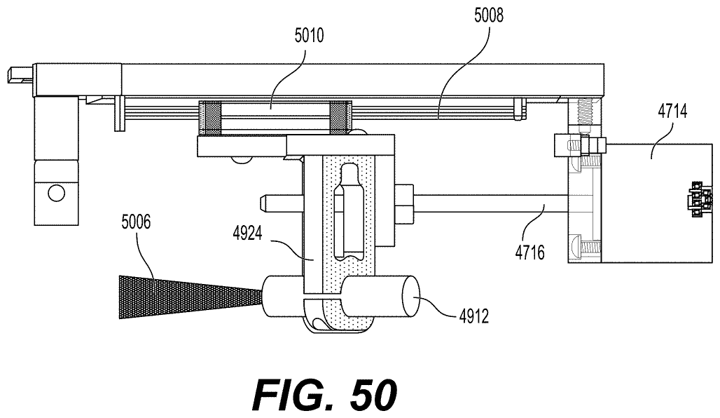

Also illustrated in FIG. 47C is the rear elements of the dual laser assembly that allows laser striping of the inserted key. As will be discussed in further detail below in association with FIGS. 49A-50, key identification system 4700 may include one or more lasers that travel on gantries via lead screw 4716. The travel of the gantries and the lasers may be regulated by laser motor 4714, which may be a stepper or servo motor with associated homing switches and other sensors.

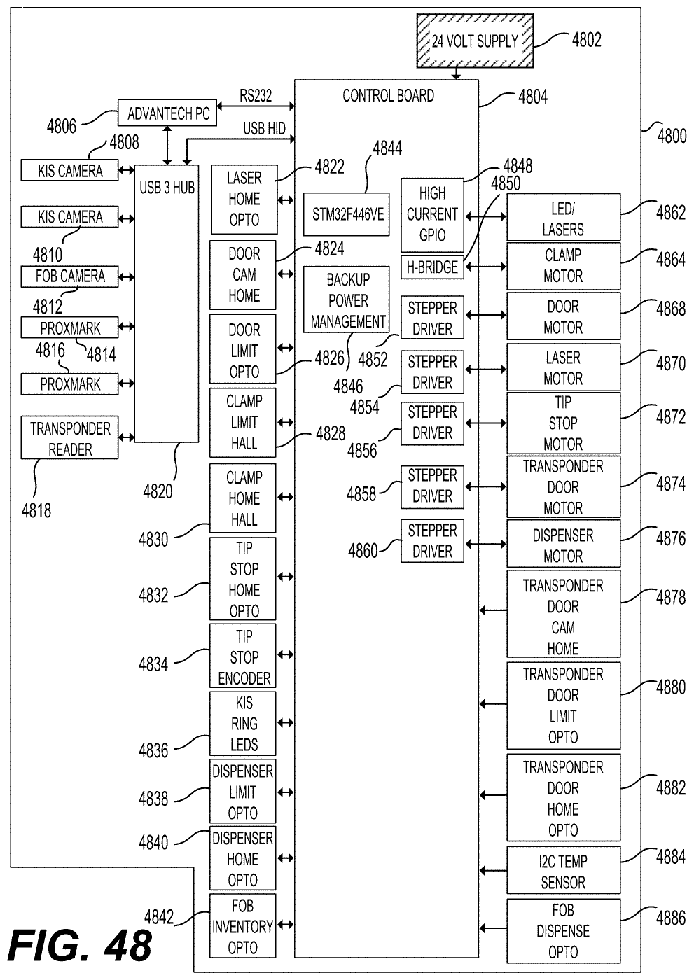

FIG. 48 is a schematic block diagram of an exemplary controller 4800 of kiosk 4600. It should be understood that various configurations of such a controller are possible depending on which functions or modules of any particular kiosk 4600 are present, and the example controller 4800 is but one such configuration.

Various components are illustrated in the schematic of FIG. 48, including a power supply 4802, a control board 4804, a PC/processor 4806, and camera processors 4808-4810. Also included is a processor 4812 associated with camera 4614, and RFID antenna processors 4814-4816. Finally, a processor 4818 is provided for transponder key reader 4610. Each of these interface with other components of kiosk 4600 through a USB hub 4820, which may be the same as USB hub 4708. Control board 4804 may interface with a multitude of motors, sensors, and switches depending on the particular configuration of a kiosk 4600. In the example of FIG. 48, various optical switches (i.e. laser home opto 4822, door limit opto 4826, tip stop home opto 4832, dispenser limit opto 4838, dispenser home opto 4840, fob inventory opto 4842, fob dispense opto 4886, transponder door home opto 4882, transponder door limit opto 4880) are present, as well as various Hall sensors that may be configured to detect electromagnetic fields (i.e. clamp limit hall 4828, clamp home hall 4830). Control board 4804 may include a dedicated processor, such as processor 4844. In addition, control board 4804 may interface with the various motors of key identification system 4700, including clamp motor 4864, door motor 4868, laser motor 4870, tip stop motor 4872, transponder door motor 4874, and dispenser motor 4876. These motors may interface with particular drivers or other features on control board 4804, such as drivers/bridges 4850-4860. A temperature sensor such as sensor 4884 may also be operatively connected to the control board to ensure a safe operating temperature for kiosk 4600. Other components, assemblies, and connections are possible for various configurations of controller 4800.

FIGS. 49A-49B illustrate front views of key identification system 4700. In FIG. 49A, the door of key insertion slot 4606 has been removed to show opening 4902. Cameras 4904 and 4906 for imaging features of an inserted key are situated on the left and right walls of system 4700.

In FIG. 49B, the front panel has additionally been removed to illustrate further components of key identification system 4700. Lasers 4910 and 4912 are situated on laser gantries 4922 and 4924, respectively, and are depicted as shining laser beams 4918 onto an existing key. Images and/or streaming video of the laser stripes on the key may be taken by cameras 4904 and 4906. Illumination of the existing key for imaging may be provided by LED banks 4916 and 4920, situated directly above and below opening 4902. In these embodiments, the LEDs may be selectively controlled, such as by control board 4804 of controller 4800, to create a variety of different illumination and reflection scenarios that reveal geometric features of the inserted existing key. As a non-limiting example, if camera 4904 is configured to capture a sidelight image of the existing key, the portions of LED banks 4916 and 4920 directly over the key and those between the key and camera 4904 may be illuminated as images are taken. LEDs behind the key would not be illuminated for these sidelight images. Similarly, for images taken of the other side of the existing key by camera 4906, the portions of LED banks 4916 and 4920 proximate to camera 4906 would illuminate instead of those proximate to camera 4904.

In some embodiments, LED banks 4916 and 4920 may include guard rails (not shown) adjacent to the lights themselves. The guard rails may be made of acrylic or other non-reflective material. The guard rails may be polarized, shaded, tinted, or otherwise at least partially opaque. In these embodiments, the guard rails may reduce glare from the LEDs before the light reaches the key. Additionally, the guard rails may prevent dust and debris from accumulating on and blocking the LEDs.

In some embodiments, key identification system 4700 may include additional LED banks on the side walls of the unit near the cameras, such as side LED bank 4926 illustrated in FIG. 49B. In these embodiments, these side LED banks are not used for imaging of the key, but rather may be configured to provide ambient light for calibration or maintenance purposes.

FIG. 50 illustrates a detailed view of the laser assemblies for generating laser stripe imaging of an existing key. One such assembly is shown in FIG. 50 with exemplary laser beam 5006; there may be two such assemblies in each key identification system 4700.

In some embodiments, as laser motor 4714 provides force via lead screw 4716, laser gantry 4924 and laser carriage 5010 are propelled forward and backward along profile rail 5008. In these embodiments, control board 4804 of controller 4800 may control the stepping of laser motor 4714, and home switches and other sensors (not shown) may be configured to regulate the movement and position of the assembly to ensure consistent translation and accordingly consistent imaging.

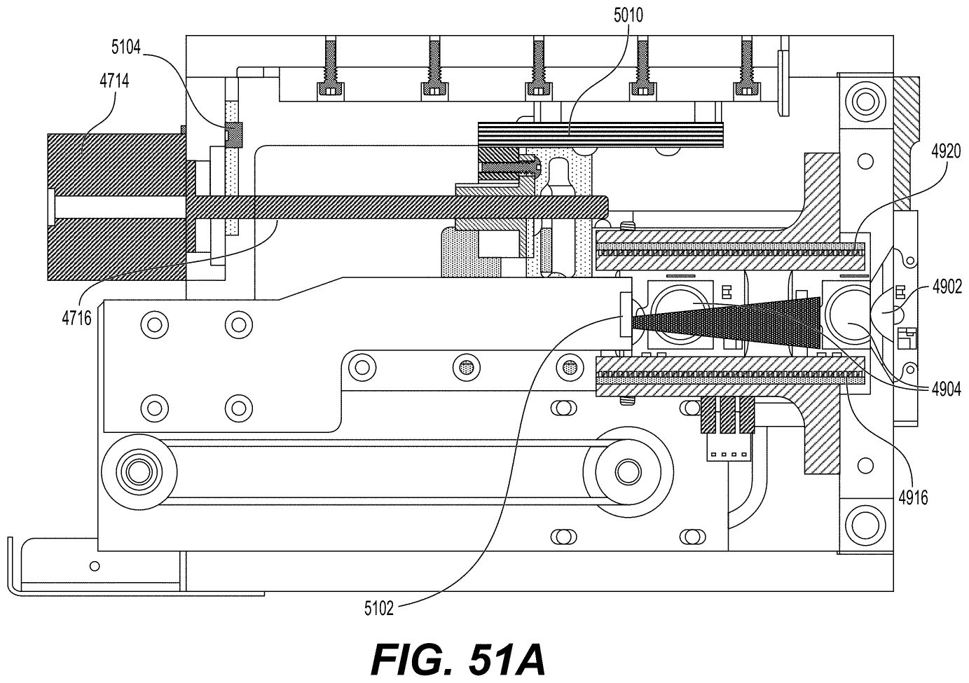

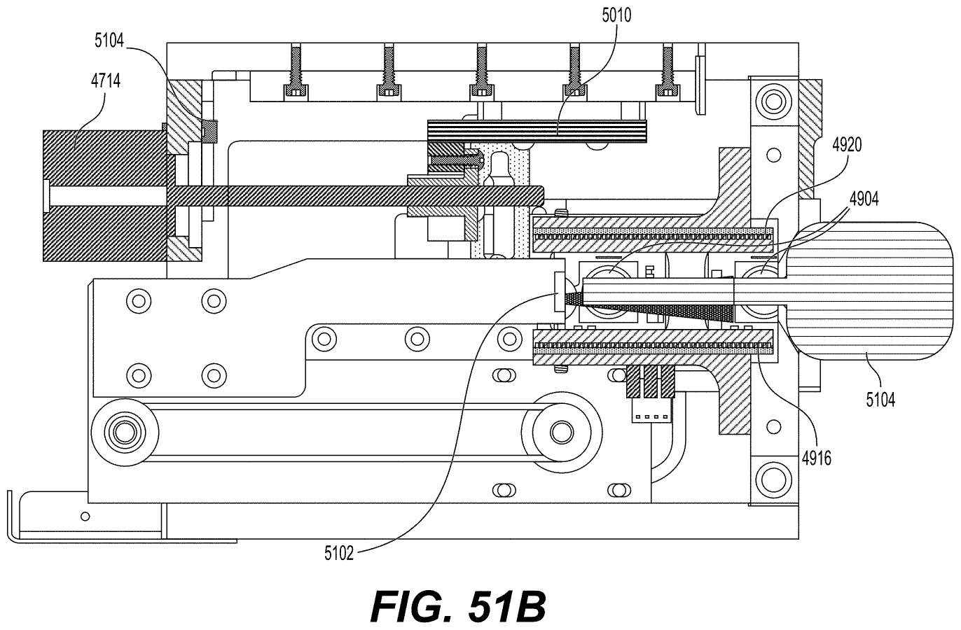

FIGS. 51A-B illustrate a side view of key identification system 4700. In some embodiments, such as the embodiment depicted in FIGS. 51A-B, there may be two cameras 4904 and/or two cameras 4906 rather than one of each camera. In these alternative embodiments, longer keys may be capable of identification and imaging since additional imaging visibility will be available.

Tip stop 5102 is visible in FIGS. 51A-B, and may be configured to provide the various haptic and measurement functions described above in association with FIG. 47C. Also visible in FIGS. 51A-B is home switch 5104, which regulates the position of the laser assemblies as discussed above in association with FIG. 50. FIG. 51B illustrates the same view as FIG. 51A, but with an existing key 5104 inserted into key insertion slot 4902.

It should be understood that the configuration of key identification system 5700 is exemplary, and that other configurations are possible. As but one example, only half of the system (i.e. one camera, one laser assembly, half the LED banks, etc.) may be deployed in a particular key identification system 5700.

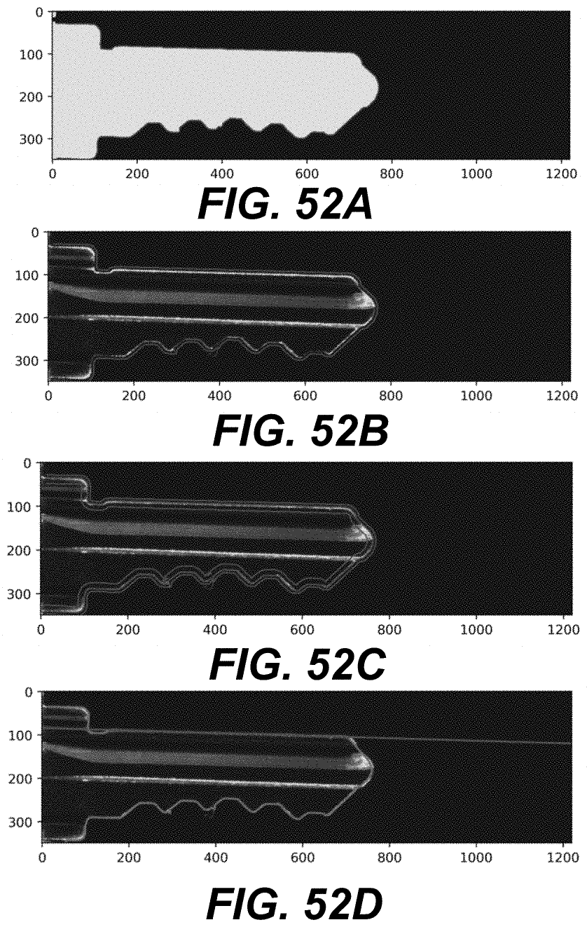

FIGS. 52A-52D depict progressive steps in the image processing algorithm utilized by the disclosed systems and methods, including kiosk 4600 and/or server(s) 420. As discussed above, the arrangement of components inside of the systems within the housing 4602 of kiosk 4600 enables a user to insert an existing key through insertion slot 4606 in either a “teeth up” or “teeth down” orientation. As the determination of the geometric features of the key is done digitally, it makes no difference how the existing key is inserted, whether the key is a single-edge cut key or cut on both edges. In doing so, the systems herein represent a significant improvement over existing systems, which often failed if an untrained or inexperienced user inserted the key incorrectly.

In order to create a precise measurement of an existing key inserted into the key insertion slot of the kiosk, a series of images may be acquired by cameras 4904-4906 using different lighting configurations and different exposure times. Light from LED banks 4916-4920 and lasers 4910-4912 may be used in various combinations to reveal features of the existing key that must be duplicated in a key blank. Reflections of light from various angles off of edge features can assist in developing an outline profile for an edge-cut existing key, and reflections off of internal edges may be used to determine milling geometry and an associated code for a sidewinder automobile key.

In some embodiments, to enhance the accuracy of image processing, an unlit background image is also captured by cameras 4904-4906, which permits removal of any light leakage or debris signals. Image processing may be performed in some embodiments by processors or computers within kiosk 4600. Alternatively, the image processing described herein may be performed by remote processors and systems, such as server(s) 420.

As shown in FIG. 52A, the starting point for analyzing geometric features of an edge cut key is to create a rough outline of the key. In some embodiments, a rough outline may be created by way of a “flood fill,” represented by the solid key-shaped field in FIG. 52A. This mask, which comprises a series of points running the perimeter of the key, can be used to detect contours.

This initial perimeter detection, as shown in FIG. 52B, may extend several pixels offset from the true edge of the key. The largest contour detected by the system is selected as the key by the image processing system, which prevents dust, metal shavings, or other contaminants on the existing key from biasing the data set and fouling detection of geometric features. The result is an ordered contour line encompassing both sides of the key.

To inspect the shape of the key, the goal is to detect the key edge just inside of the key perimeter contour line. As shown in FIG. 52C, this may be done in the disclosed systems by calculating an approximate tangent for every point along the key, and then rotating 90 degrees. This process creates a strip of pixels around the key that contains the edge. In some embodiments, further processing may involve bilinear interpolation to achieve a single-pixel thick layer across the edge. In some embodiments, subpixel resolution of the key edge can be achieved by approximating the first derivative, looking for the first peak above a given threshold value. This peak may then be used to interpolate a zero crossing in the second derivative, resulting in a fractional pixel position. A precise edge position may be revealed by multiplying this scalar subpixel position times the normal vector and adding back in the start position. Once done across the entire length of the perimeter, the result is a subpixel-accurate ordered point list of the key edge.

Additional processing may be required in some embodiments to correct for other deviations in the image and in the orientation of the key, such as parallax errors and perspective errors. In some embodiments, any deviation of the camera positioning or the key positioning from horizontal may cause trapezoidal perspective distortion errors over the length of the key. In some embodiments, the system processors may be configured to detect inflection points consisting of more than two pixels in length in the key data. These line segments can then be ordered by their length, revealing the lengths of various features of the edge of the key. As shown in FIG. 52D, the longest such segment typically comprises the spine of the key for a single-edge cut key. The spine can then be linearly fit, and the slope and y-intercept of that fit can be used to correct the orientation of the key. Other processing may be required for double-edged keys, using mathematical algorithms familiar to those of skill in the art.

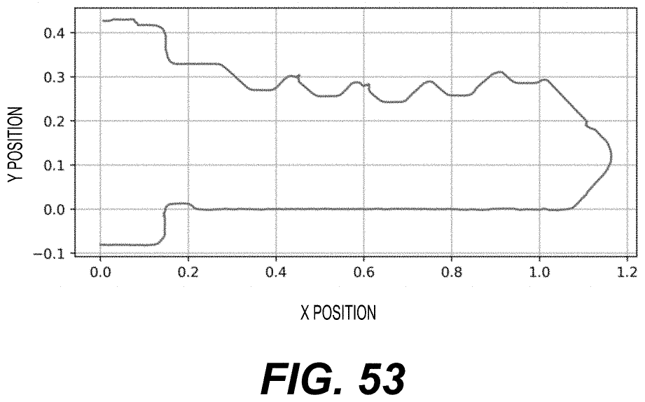

FIG. 53 is an example of an output of the image processing algorithm. FIG. 53 essentially represents the profile of the key, derived from the various images taken by the key identification system 4700. Using the orthogonal data and points isolated from the processed key images received from cameras 4904-4906, a model may be built including the shoulder of the existing key and the determined bitting pattern of the edge(s) of the key. In some embodiments, a profile image such as that depicted in FIG. 53 may be transmitted to a key duplication system within the housing 4602 of kiosk 4600 to assist in cutting a key blank. In other embodiments, a profile image such as that depicted in FIG. 53 may be transmitted to a remote system, such as server(s) 420, in order to facilitate cutting of the key by a remote system.

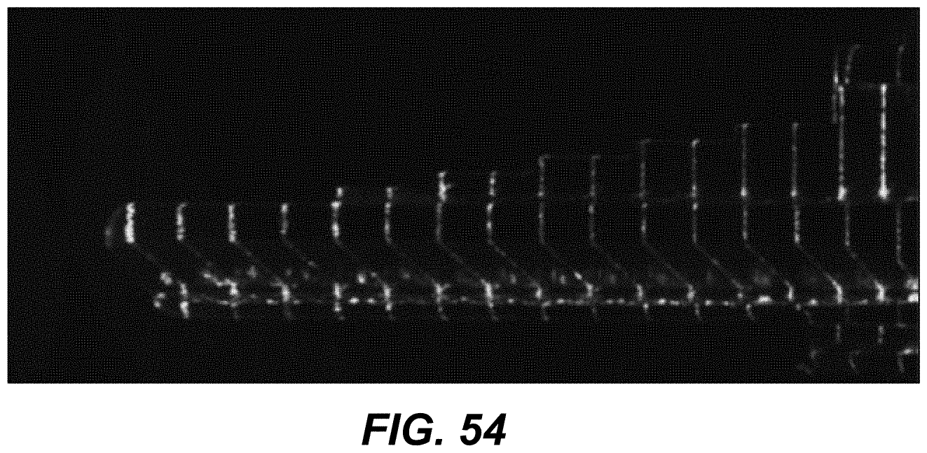

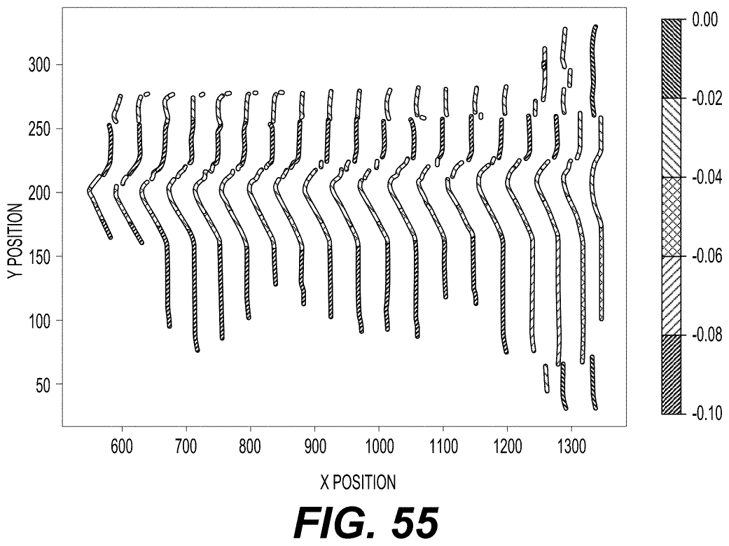

FIG. 54 is an example of a composite stream of images taken of laser stripes from, e.g., lasers 4910-4912. These laser scan images may serve several purposes. For edge cut keys such as home or office keys, laser scan images may assist in correcting parallax errors introduced due to the orientation of the camera lenses. The laser scans establish multiple depth stripes of the key blade, resulting in a three-dimensional cloud of points that can be used to interrogate the position of the key in the X, Y, and Z dimensions. Prior to imaging of a key, key identification system 4700 may be calibrated along with lasers 4910-4912 and cameras 4904-4906. During calibration, known positions of the lasers are calibrated to known depths, thus mapping a “flat” object in space. When a key is scanned by the lasers, the captured scan frames can be compared to the calibrated known flat positions to reveal a Z-depth at the point where the laser line hits the various features of the key. In some embodiments, with a known camera position relative to the key, the system may “project” the key image into the plane of the flat calibration panel, where the laser depth reading is zero in the Z-direction. FIG. 55 is an exemplary diagram showing the positional data that can be derived from the synthesized laser stripe images of, e.g., FIG. 54.

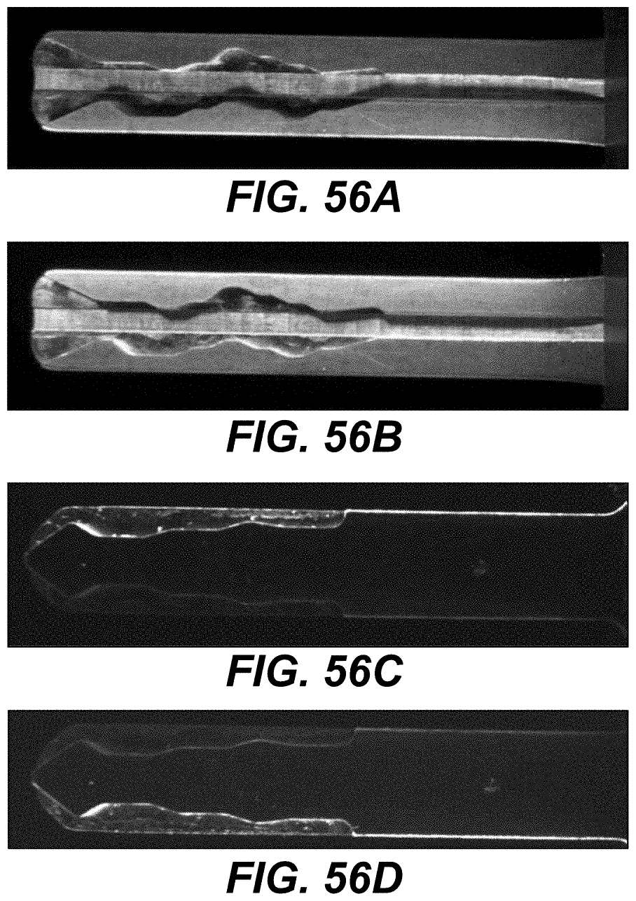

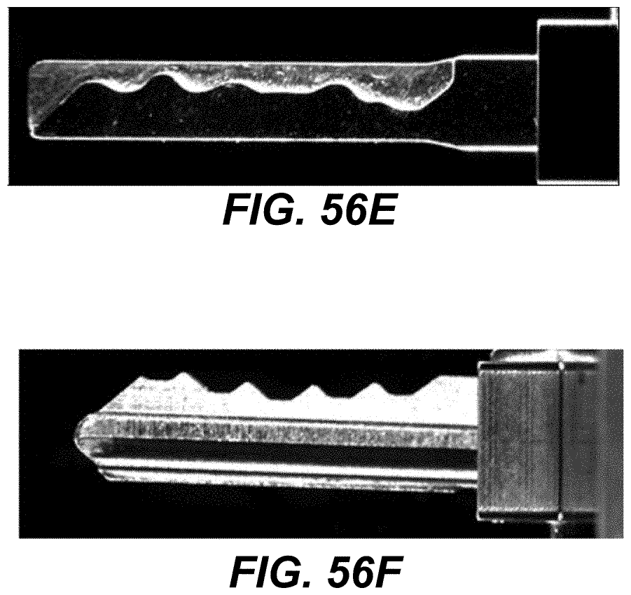

FIGS. 56A-56F depict a variety of examples of different kinds of keys that can be detected and identified by disclosed systems such as key identification system 4700. FIGS. 56A and 56B show top reflection and bottom reflection images of an internal sidewinder key that may be exemplary of various automobile keys. FIGS. 56C and 56D show top reflection and bottom reflection images of an “external” sidewinder key that may be exemplary of various automobile keys. This type of key resembles a traditional double-edged key, but set within a square or rounded blade. FIG. 56E is a further variation, showing a single-edged external sidewinder key as imaged by camera 4904. FIG. 56F depicts a traditional edge-cut key that may be exemplary of various home or office keys.

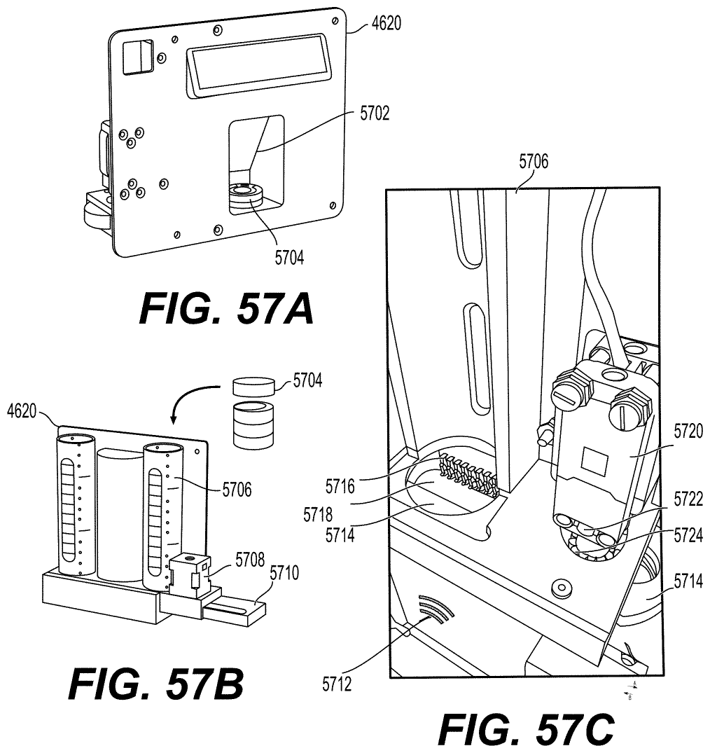

FIG. 57A illustrates a magnified front view of an exemplary RFID key fob dispenser 4620 of kiosk 4600. As illustrated in FIG. 57A, RFID key fob dispenser 4620 includes a recess extending into housing 4602, and dispensing slot 5702. In some embodiments where kiosk 4600 is equipped with RFID key fob duplication capabilities, a programmed RFID key fob may be dispensed within RFID key fob container 5704 to a user of kiosk 4600 through slot 5702.

FIG. 57B illustrates a rear view of key fob dispenser 4620. As illustrated in FIG. 57B, key fob dispenser 4620 may include one or more key fob container magazines 5706 disposed on the inner surface of dispenser 4620 at the interface with housing 4602. Magazine(s) 5706 may be configured to hold a plurality of RFID key fob containers 5704 that may be stacked on top of each other. Any number of magazines 5706 may be included. In one exemplary embodiment, key fob dispenser 4620 may be equipped with two magazines 5706. In other embodiments, only one magazine 5706 may be included. In further embodiments, different magazines 5706 may be included within kiosk 4600 that contain different shapes or types of blank RFID key fobs and/or RFID key fob containers 5704.

The one or more processors of kiosk 4600 may also be programmed to activate antenna 5712, as shown in FIG. 57C, to emit an electromagnetic field that may be received by a blank RFID key fob inside of an RFID key fob container 5704 within kiosk 4600. The data read by key fob reader 4616 from a master RFID key fob may be written to a blank RFID key fob when it is activated by the electromagnetic field emitted by antenna 5712. Further, the one or more processors of kiosk 4600 (such as controller 4800 or any hardware component therein) may be configured to release a duplicated RFID key fob via key fob dispenser 5702. Although two antennae have been described above (key fob reader 4616 and antenna 5712), it is contemplated that in some exemplary embodiments, kiosk 4600 may have only one read/write capable antenna that may be used to emit an electromagnetic field to activate both a master key fob placed on key fob reader 4616 and the blank RFID key fob situated within an RFID key fob container 5704.

As described above, antenna 5712 may be configured to write a code associated with a master key fob into one of the blank RFID key fobs located within the stack of RFID key fob containers 5704 inside of magazine(s) 5706. Antenna 5712 may have any shape or orientation (e.g., curvilinear shape, coil shape, or any other shape) capable of emitting an electromagnetic field.

Each RFID key fob container 5704 within a magazine 5706 may include a blank (e.g., writeable) RFID key fob. One or more processors of kiosk 4600 may be configured, via antenna 5712 and associated hardware, to write the data and/or information read from a master RFID key fob placed on key fob reader 4616 onto a blank RFID key fob located within an RFID key fob container 5704. It is contemplated that the data and/or information may be written to a blank key fob in a bottom-most key fob container 5704 located in a magazine 5704 of key fob dispenser 4620. In other embodiments, other orientations of magazine(s) 5706 and antenna 5712 are possible and will be readily contemplated by one of ordinary skill in the art.

RFID key fob dispenser 4620 may also include a dispensing mechanism, such as the exemplary mechanism illustrated in FIG. 57C, that may include an included actuator and a slider 5714. The actuator, when present, may be configured to cause a reciprocating movement of slider 5714 (e.g., in directions A and B), which in turn may be configured to push a bottom-most RFID key fob container 5704 from a magazine 5706 into a recess of key fob dispenser 4620.

In one exemplary embodiment, slider 5714 of the disclosed dispensing mechanism may include one or more teeth 5716. The actuator assembly, when present, may include motor 5720, shaft 5722, and gear 5724 mounted at one end of shaft 5722. Gear 5724 may be configured to engage with the one or more teeth 5716 forming a rack and pinion type arrangement. Rotation of shaft 5722 and gear 5724 in a clockwise or counter-clockwise direction may cause slider 5714 to move linearly in opposing directions A and B. Thus, for example, rotation of gear 5724 in one direction may cause slider 5714 to move from a left side towards a right side of FIG. 57C in direction A, and a rotation of gear 5724 in an opposite direction may cause slider 5714 to reverse its direction of movement to direction B. In operation, the one or more processors of kiosk 4600 may cause gear 5724 to rotate in one direction, causing slider 5714 to move all the way towards the right (e.g., in direction A). Moving slider 5714 to its right-most position may expose cavity 5718 below a magazine 5706, allowing a bottom-most RFID key fob container 5704 to drop down from a magazine 5706 into the cavity 5718 and in a position in front of slider 5714. The one or more processors of kiosk 4600 may then cause gear 5724 to rotate in an opposite direction causing slider 5714 to move in a direction B, thereby pushing RFID key fob container 5704 from below a magazine 5706 into dispensing slot 5702. Although a rack and pinion type system (e.g., teeth 5716 and gear 5724) has been described above, it is contemplated that other types of mechanisms may be used to cause reciprocating movement of slider 5714 in directions A and B. Such mechanisms may include without limitation, crankshaft mechanisms, cams, spring loaded actuators, linear actuators, rotational actuators, vacuums, or any other type of device capable of moving slider 5714 in directions A and B.

The disclosed systems may provide a simple way for a user to duplicate RFID key fobs using a key duplication kiosk generally available at a retail location without having to find and visit a specialized RFID key fob duplication location such as a vehicle dealership and/or a particular locksmith capable of duplicating RFID key fobs. Thus, the disclosed self-service kiosk may provide advantages such as increased user convenience for duplicating RFID key fobs at a retail location. Further, the disclosed kiosk may enhance the user experience and improve user convenience by dispensing a fully programmed duplicated RFID key fob inside of a key fob container, containing one or more codes retrieved from a master key fob. This reduces customer confusion and frustration, and increases sales without the need for added labor.

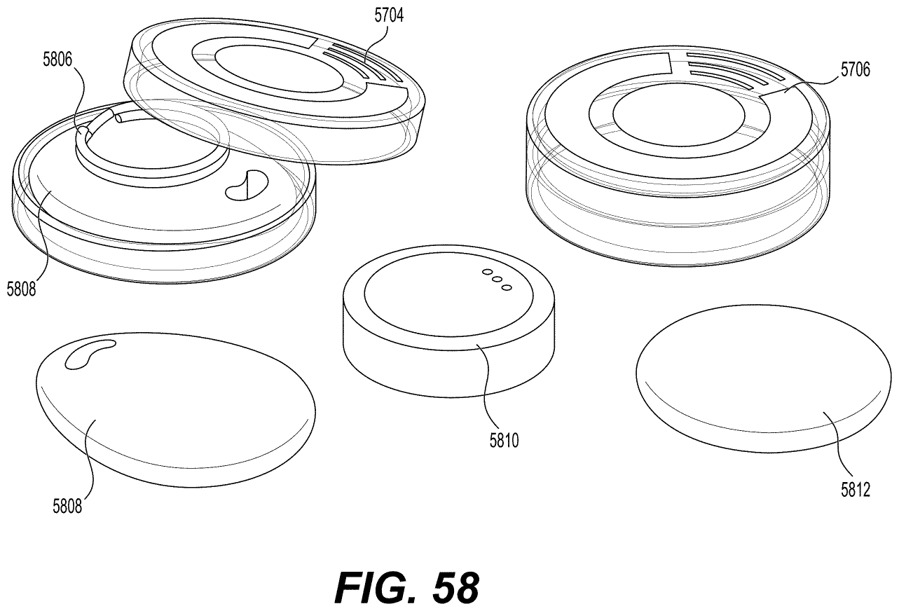

As illustrated in FIG. 58, key fob container 5704 may include a bottom tray configured to hold an RFID key fob blank, such as fobs 5808, 5810, and 5812. Key fob container 5704 may also include cover 5706. In one exemplary embodiment as illustrated in FIG. 58, key fob container 5704 may have a generally circular shape. However, it is contemplated that key fob container 5704 may have any other shape (e.g., square, rectangular, polygonal, elliptical, or any other three dimensional shape). Key fob container 5704 may be a two-piece container as illustrated in FIG. 58, or alternatively, it may be a single-piece container that may include one or more slots that may allow a user to extract an RFID key fob, such as fob 5808, from key fob container 5704. It will be understood that the shapes and sizes of key fob 5704 illustrated in FIG. 58 are exemplary, and key fob 5704 may have any other shape or size consistent with this disclosure. As further illustrated in FIG. 5704, key fob container 302 may include a removable ring 5806 inside of the container to aid the user in placing a duplicated key fob onto their keychain.

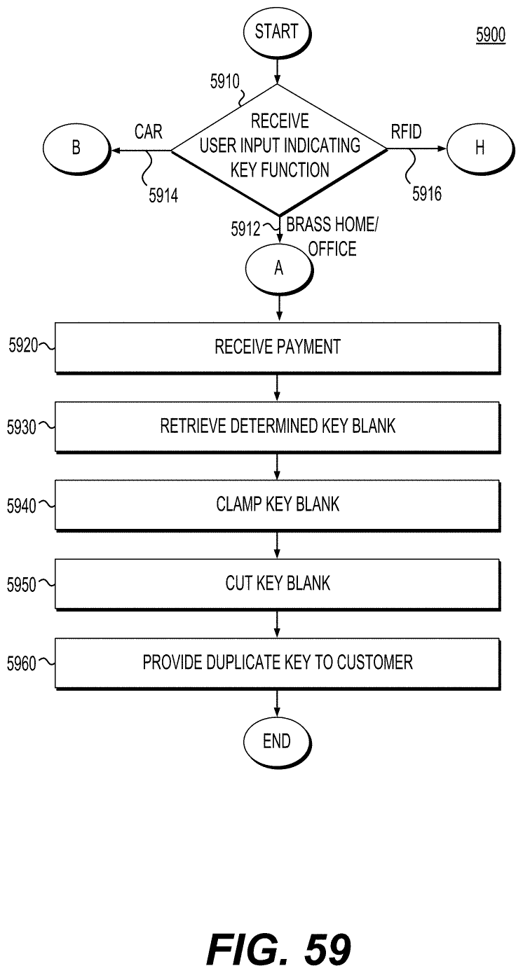

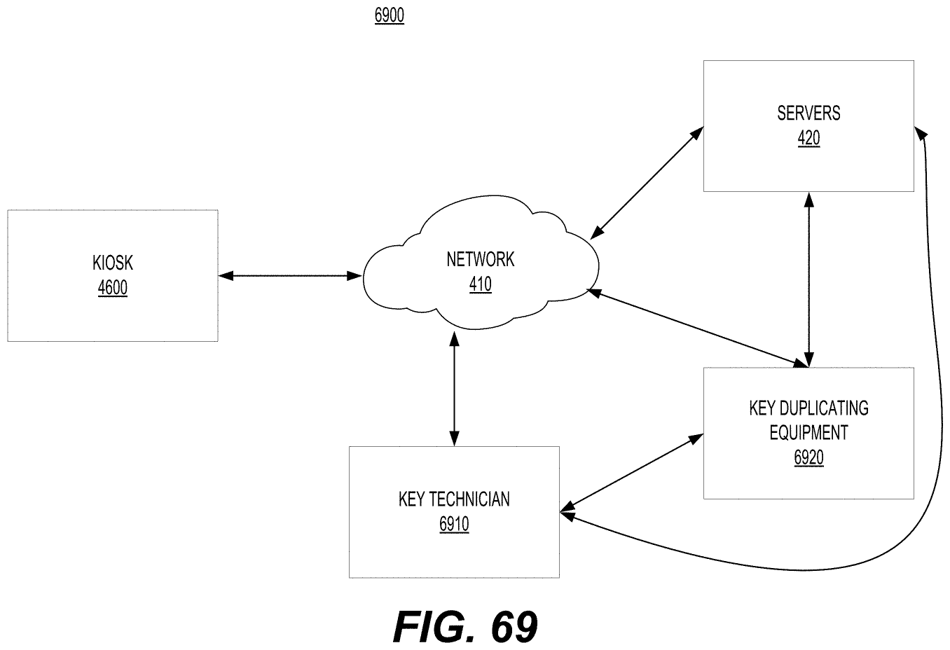

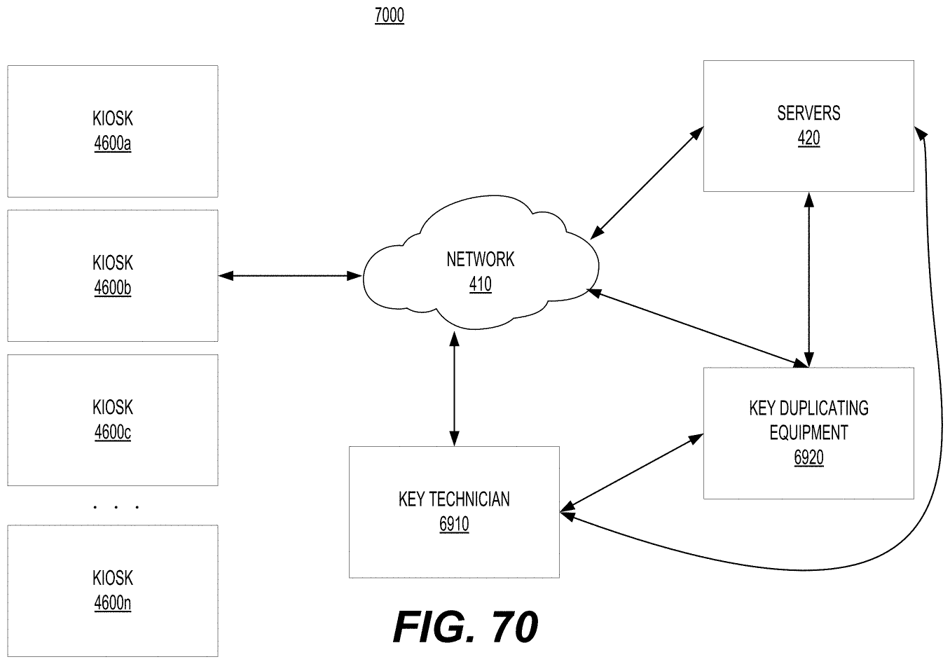

FIG. 59 is a flowchart of an exemplary process 5900 for identifying and duplicating various objects, including access control devices such as home/office keys, automobile keys, and RFID key fobs. Process 5900 will be described in an exemplary fashion as being performed by kiosk 4600, but other embodiments may incorporate different system components, such as those described below in association with FIGS. 69-70.

At step 5910, display 4604 of kiosk 4600 may receive user input indicating the function of a key or other access device. The user of kiosk 4600 may be prompted via graphical user interface prompts to select what type of key or other access device he or she wishes to duplicate. Different combinations of options may be presented for any particular configuration of modules and subsystems of kiosk 4600 in a particular retail environment; see FIG. 71 below.

In the example of process 5900, three potential options for duplication are illustrated. At step 5912, display 4604 may receive input that the user wishes to duplicate a brass (or aluminum, plastic, etc.) home or office key. At step 5914, display 4604 may receive input that the user wishes to duplicate an automobile or car key. And at step 5916, display 4604 may receive input that the user wishes to duplicate an RFID key fob. Each of these branches will be described in detail below.

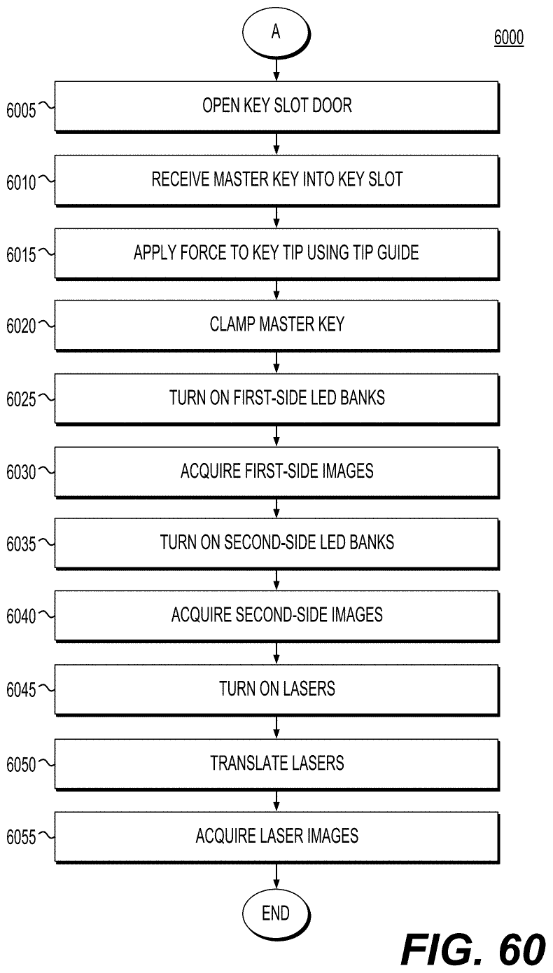

If display 4604 receives input indicating that the user wishes to duplicate a home or office key, kiosk 4600 may execute subprocess A, which is exemplary process 6000 depicted in association with FIG. 60. Process 6000 will be described in an exemplary fashion as being performed by kiosk 4600 via key identification system 5700, but other embodiments may incorporate different system components, such as those described below in association with FIGS. 69-70.

At step 6005, key identification system 5700 may open the key insertion slot door via door assembly 5702. Next, at step 6010, key identification system 5700 may receive an existing, or “master” key via key insertion slot 4606/opening 4902. At step 6015, tip stop/guide 5102 provides tactile force to the tip of the master key by way of tip stop gantry 4712 and associated hardware and/or motors. Once the force indicates to the user and/or to the processors of kiosk 4600 that the insertion of the key is complete, at step 6020 key identification system 5700 may clamp the master key via clamp motor 4710 and associated hardware. Securing the master key before imaging increases the accuracy of the imaging and reduces the chances of misidentification and eventual miscuts.

Steps 6025-6055 involve imaging the existing/master key, as illustrated in FIGS. 52 and 54. At step 6025, the individual LEDs within LED banks 4916 and/or 4920 required to image a first side of the master key are turned on. In some embodiments, as described above, a background image is captured prior to the LED activation in order to assist with subtraction of noise. In some embodiments, processors and software associated with kiosk 4600, key identification system 4700, and controller 4800 may be configured to determine the various lighting scenarios and images necessary to image the key. This determination may be informed by various factors, including the type of key, the size and/or length of the key, the number of bits of the key, the amount of background noise in the image, whether the key is a sidewinder key or an edge cut key, etc. At step 6030, cameras 4904 and/or 4906 capture still images and/or streaming video of the inserted portion of the master key. In some embodiments, these images are sidelight images based on the lighting provided by LED banks 4916 and/or 4920.

At steps 6035 and 6040, the process repeats for the other side of the key, if key identification system 5700 is so configured. At step 6045, lasers 4910 and 4912 are turned on, and then at step 6050 each laser assembly as illustrated in association with FIG. 50 is translated down rail 5008. As the translation occurs, at step 6055, cameras 4904 and/or 4906 capture still images and/or streams of frames of the laser stripe(s) proceeding down the blade of the master key.

Returning to process 5900 as depicted in FIG. 59, at step 5920, kiosk 4600 may be configured to receive payment for the duplication task via display 4604, payment receptacle 4608, or other methods. In some embodiments, payment may not be collected at kiosk 4600 and may be collected either at another physical location within the retailer or electronically, such as via a user's mobile device.

At step 5930, in some embodiments, kiosk 4600 proceeds to retrieve a key blank determined to be associated with the inserted master key via processors and associated hardware, including robots (see FIG. 48). The key blank is clamped at step 5940, and cut using equipped cutting hardware at step 5950. The final cut duplicated key blank is then dispensed to the user at step 5960 via key dispenser 4618.

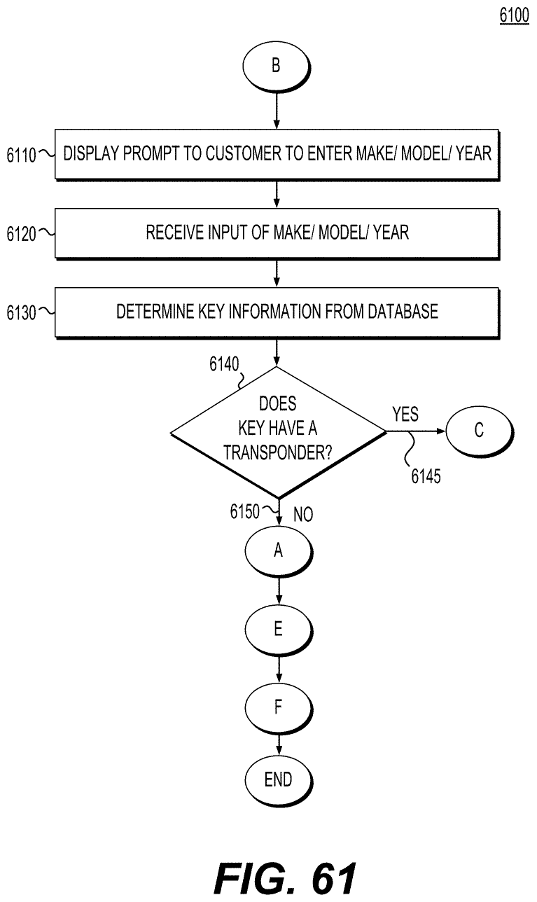

FIG. 61 is a flowchart of an exemplary process 6100, also labeled in other figures as subprocess B. Process 6100/B may be used for identifying automobile keys. Process 6100 will be described in an exemplary fashion as being performed by kiosk 4600 and controller 4800, but other embodiments may incorporate different system components, such as those described below in association with FIGS. 69-70.

Process 6100 begins at step 6110, where a prompt is generated by a processor of controller 4800 and displayed to a user of kiosk 4600 via display 4604 once the user has indicated that they wish to duplicate an automobile key. The display may prompt the user to enter a make, model, and/or year of an automobile associated with the automobile key that the user wishes to duplicate. Display 4604 may receive the input from the user at step 6120.

At step 6130, one or more processors associated with controller 4800 of kiosk 4600 may determine information about one or more keys and/or remote control devices associated with automobiles of the make, model, and year that were input by the user via display 4604. The information may vary based on the automobile. In some embodiments, the information may include whether the access device is a key versus an access control device; the shape and configuration of the device(s); and/or whether the device contains a transponder.

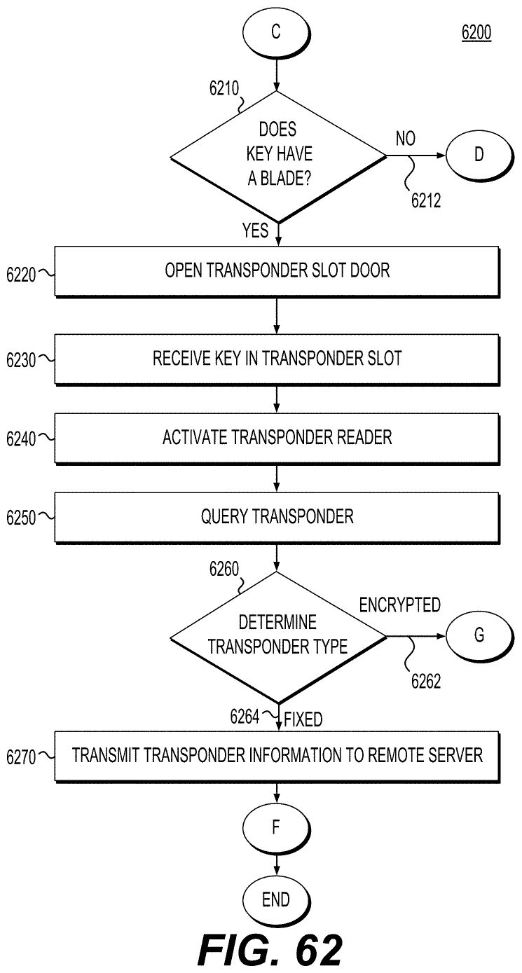

At step 6140, the processors of controller 4800 determine whether the access device for an automobile that the user wishes to duplicate has a transponder chip integrated within it. If yes, kiosk 4600 may execute subprocess C, which is exemplary process 6200 depicted in association with FIG. 62. Process 6200 will be described in an exemplary fashion as being performed by kiosk 4600 and controller 4800, but other embodiments may incorporate different system components, such as those described below in association with FIGS. 69-70.

At step 6210 of process 6200, kiosk 4600 determines, by one or more processors associated with controller 4800, whether or not the transponder-equipped automobile key has a blade. If yes, the process proceeds to step 6220. Controller 4800 may send a signal to open the door 4626 covering transponder reader 4610. At step 6230, the system may receive the bladed transponder key into transponder reader 4610. The user of kiosk 4600 may be guided by LEDs 4628, and/or prompts on display 4604.

At step 6240, controller 4800 may activate the transponder reader 4610, by generating an electromagnetic field. At step 6250, reader 4610 may query the transponder chip within the inserted key. At step 6260, reader 4610 and controller 4800 may determine a type of the transponder based on signals exchanged with the transponder chip. If the transponder chip is a fixed transponder (step 6264), controller 4800 may transmit information associated with the transponder chip to a remote server, such as server(s) 420, at step 6270 of process 6200.

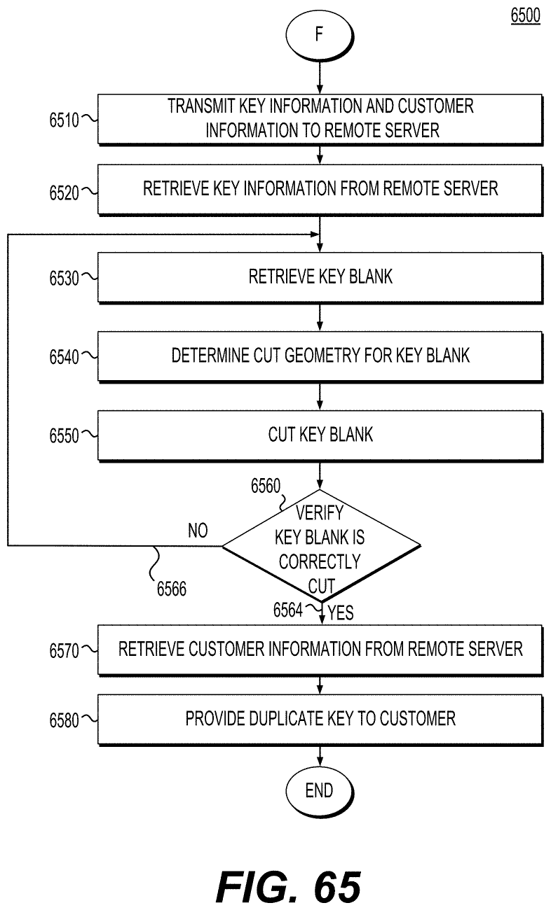

As shown in FIG. 62, kiosk 4600 may then execute subprocess F, which is exemplary process 6500 depicted in association with FIG. 65. Process 6500 will be described in an exemplary fashion as being performed by server(s) 420 and key duplication equipment 6920 (see FIG. 69 description below), but other embodiments may incorporate different system components, such as those described below in association with FIGS. 69-70, including kiosk 4600 itself if so equipped.

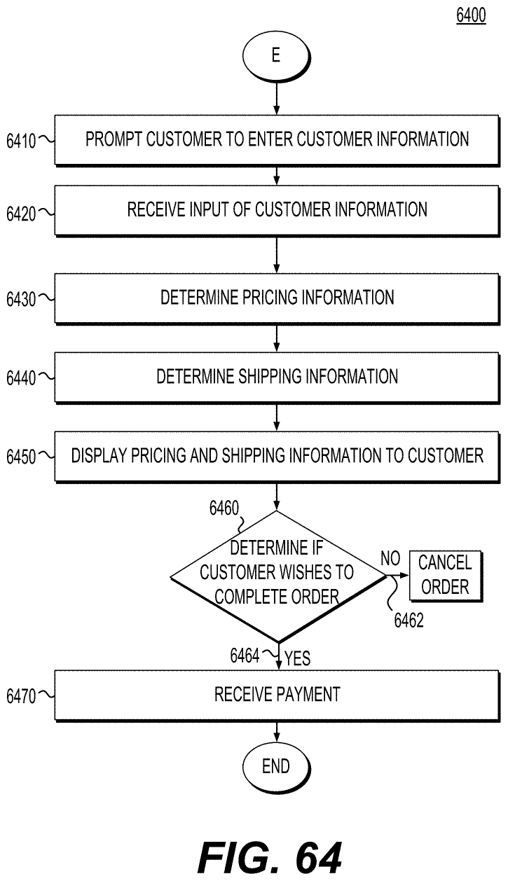

At step 6510, kiosk 4600 via controller 4800 may transmit key information, such as the type of key blank associated with the key, the type of transponder chip, the make/model/year of the automobile, etc. as well as customer information to a remote server, such as server(s) 420. The customer information may vary based on application or geographic location, but may include identifying information such as name, contact information, etc. See also subprocess E in association with FIG. 64 below.

At step 6520, in some embodiments, key duplication equipment 6920 may retrieve the key information from server(s) 420. After retrieval, key duplication equipment 6920 and/or key technician 6910 may confirm and/or determine de novo a key blank associated with the user's key and the transmitted key information. At step 6530, key duplication equipment 6920 and/or key technician 6910 may retrieve the key blank.

Using the key information transmitted from kiosk 4600, one or more processors associated with key duplication equipment 6920 and/or key technician 6910 may determine cut geometry for the key blank to replicate the features of the blade of the user's key onto the key blank. In some embodiments, the cut geometry may be determined, for example, from image data sent by kiosk 4600 and key identification system 4700. In other embodiments, the cut geometry may be determined from a geometry profile, such as that illustrated in exemplary fashion in association with FIG. 53. In still other embodiments, the cut geometry may be received by server(s) 420 as a code, and transmitted to key duplication equipment 6920 and/or key technician 6910 in that fashion. At step 6550, key duplication equipment 6920 and/or key technician 6910 proceeds to cut the retrieved key blank with the determined cut geometry information. In addition, key duplication equipment 6920 and/or key technician 6910 may program the fixed transponder chip in the key blank with a transponder code determined by transponder reader 4610 of kiosk 4600.

At step 6560, key duplication equipment 6920 and/or key technician 6910 and/or server(s) 420 may proceed to verify whether the bladed transponder key has been correctly cut and/or cloned. This verification may comprise comparisons with the received key information, comparisons with databases, or other verification means known in the art. If no (step 6566), the process reverts back to step 6530 and a new key blank is retrieved and cut/programmed.

If the key blank is verified as correct (step 6564), then process 6500 proceeds to step 6570, whereby key duplication equipment 6920 and/or key technician 6910 retrieves the customer information from server(s) 420. The information may include a delivery address for the customer, such as the customer's home, the retail location of kiosk 4600, or another location. In other embodiments, the information may comprise contact information for the customer by telephone, social messaging, text messaging, SMS messaging, or email.

At step 6580, key duplication equipment 6920 and/or key technician 6910 provides the duplicated key back to the customer using the retrieved customer information. This may include shipping the key to the customer, to the retail location of kiosk 4600, or another location. Key duplication equipment 6920 and/or key technician 6910 may further send a notification to the customer via the means above to inform the customer that the key is in transit.

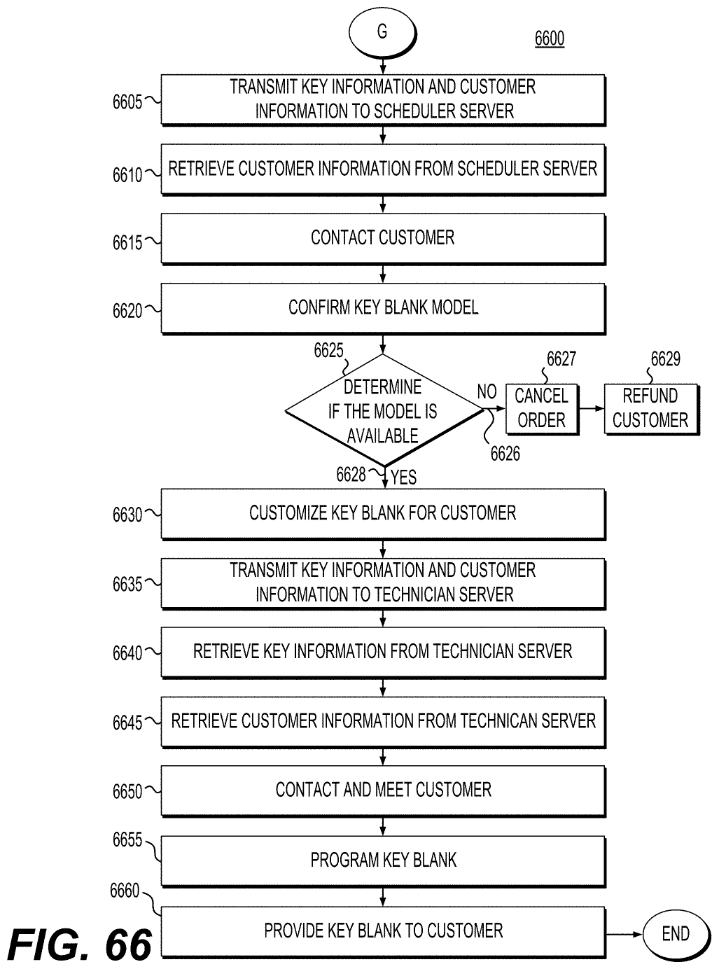

Returning to process 6200 (FIG. 62) at step 6260, if controller 4800 instead determines that the transponder chip is an encrypted transponder chip, kiosk 4600 may then execute subprocess G, which is exemplary process 6600 depicted in association with FIG. 66. Process 6500 will be described in an exemplary fashion as being performed by server(s) 420, key technician 6910 and key duplication equipment 6920 (see FIG. 69 description below), but other embodiments may incorporate different system components, such as those described below in association with FIGS. 69-70, including kiosk 4600 itself if so equipped.

At step 6605 of process 6600, kiosk 4600 via controller 4800 may transmit key information, such as the type of key blank associated with the key, the type of encrypted transponder chip, the make/model/year of the automobile, etc. as well as customer information to a remote scheduling server, such as server(s) 420 or a server associated with key technician 6910. Prior to sending the information, kiosk 4600 may decode, decrypt, or otherwise “crack” the encrypted transponder code via processors and software associated with transponder reader 4610, controller 4800, or an outside system. The customer information may vary based on application or geographic location, but may include identifying information such as name, contact information, etc. See also subprocess E in association with FIG. 64 below.

At step 6610, customer information is retrieved from the remote scheduling server. Using the customer information, which may comprise contact information for the customer by telephone, social messaging, text messaging, SMS messaging, or email, the server and/or users thereto may contact the customer at step 6615 to set up an appointment with key technician 6910. Elements of systems 6900 or 7000 described below may then confirm the proper key blank model for the customer, be it a bladed transponder key with no buttons, a bladed transponder key with buttons, or a bladeless key fob that may include an associated sidewinder valet key. The proper key blank may be confirmed by comparison to databases, etc. by one or more associated processors. At step 6625, systems 6900 or 7000 may determine if the confirmed key blank model is available in inventory. If no (step 6626), the system proceeds to cancel the order (step 6627) and refund the customer (step 6629). If the blank is in inventory (step 6628), then the key blank is customized for the customer via key duplication equipment 6920 or other elements of systems 6900 or 7000 at step 6630. The system may then transmit the same key information and customer information received at step 6605 to a server associated with key technician 6910 (step 6635). Key technician 6910 may retrieve the key information (step 6640) and the customer information (step 6645) from the relevant server such as server(s) 420 via network 410.

At step 6650, key technician 6910 may contact the customer using the customer information and/or other information received from the scheduler and/or systems 6900 and 7000, and may proceed to meet the customer at an agreed physical location. At step 6655, key technician 6910 may program the already-customized key blank with the proper encrypted transponder code as received from kiosk 4600, using key duplication equipment 6920 or other equipment as needed. In some embodiments, the programming may need to occur at a known proximity from a processor associated with the customer's automobile. Finally, key technician 6910 may provide the programmed key to the customer.

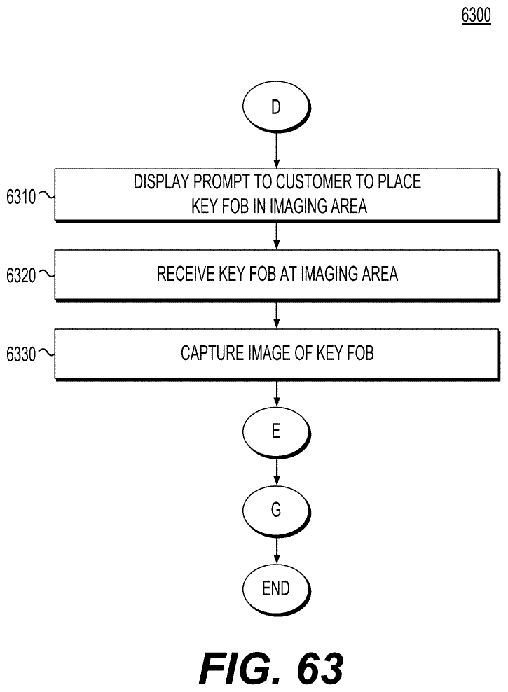

Returning to exemplary process 6200 (FIG. 62, subprocess “C”), if kiosk 4600 determines via controller 4800, display/user interface 4604, or other means that the user's automobile key does not have a blade (step 6212), kiosk 4600 may then execute subprocess D, which is exemplary process 6300 depicted in association with FIG. 63. Process 6300 will be described in an exemplary fashion as being performed by kiosk 4600, but other equipment may be used in alternative embodiments, such as elements of systems 6900/7000.

At step 6310 of process 6300, kiosk 4600 may display a prompt to the user via display 4604 and controller 4800 prompting the customer to place their bladeless automobile key in an imaging area. The user may be guided in this process by visual prompts, audio prompts, or lights associated with housing 4602 and/or window 4612.

At step 6320, kiosk 4600 may receive the user's key at an imaging location proximal to camera 4614. Camera 4614, via controller 4800, may proceed to capture one or more images of the user's key sufficient to inform components of systems 6900/7000 (such as key technician 6910) of a proper key blank. Kiosk 4600 may then execute subprocess E, which is exemplary process 6400 depicted in association with FIG. 64 and described below. After execution of subprocess E/process 6400, kiosk 4600 may complete process 6300 by executing subprocess G in full, which was described above in association with FIG. 66 and process 6600.

Subprocess E/process 6400 will be described in an exemplary fashion as being performed by kiosk 4600, but other equipment may be used in alternative embodiments, such as elements of systems 6900/7000.

At step 6410, kiosk 4600 may prompt the user of the self-service kiosk to enter customer information via display 4604. As discussed above, this may include location information for the customer, contact information, etc. The input may be received from the customer via display 4604 at step 6420.

Based on the user input and information determined about the user's key, controller 4800 may proceed to determine pricing information (step 6430), i.e. a final price for the order inclusive of tax, order quantity, and/or discounts, and determine shipping information (step 6440), i.e. the cost of shipping the key(s) to the user based on the input customer information. Once determined, controller 4800 may display the pricing and shipping information to the customer via display 4604 (step 6450). Kiosk 4600 may determine whether the customer wishes to complete the order (step 6460). If no (step 6462), determined either by an affirmative declining of the transaction by the user via display 4604, or by a timing out of the response as gauged by controller 4800, the order terminates and is cancelled.

If the user does agree via input on display 4604 to proceed (step 6464), then kiosk 4600 may receive payment for the transaction, such as through payment receptacle 4608 (step 6470).

Returning to step 6140 of process 6100 (FIG. 61, subprocess “B”), in the relatively rare event that a customer presents an automobile key for duplication that has a blade but does not have a transponder (step 6150), then kiosk 4600 and controller 4800 conclude process 6100 by serially executing subprocesses A (FIG. 60; process 6000), E (FIG. 64; process 6400), and F (FIG. 65, process 6500), all of which are described above.

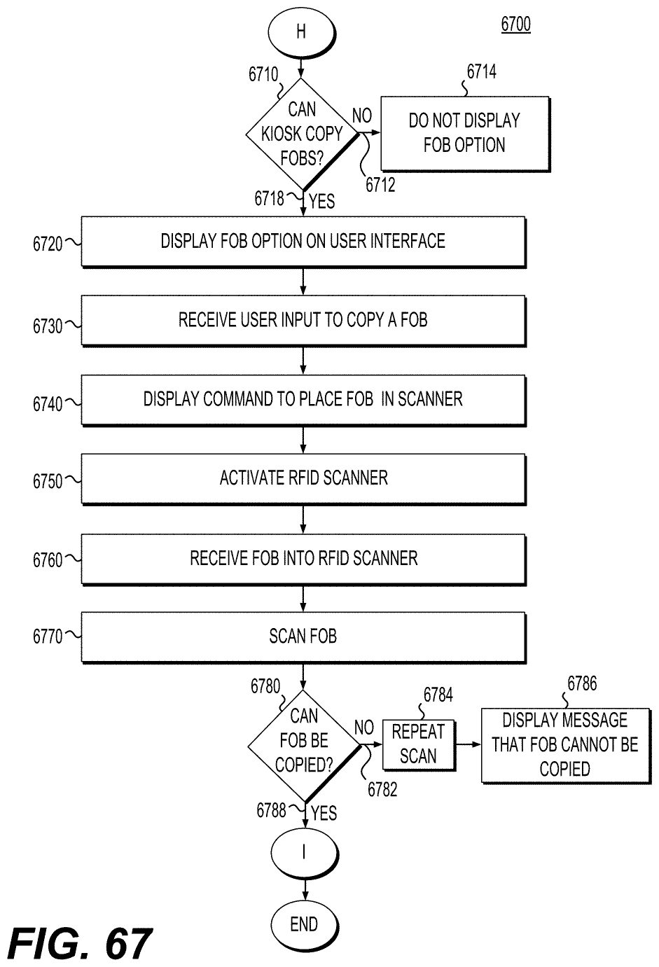

Returning to step 5910 of process 5900 (FIG. 59), if kiosk 4600 receives input from the user via display 4604 that the user wishes to duplicate an RFID key fob (step 5916), then kiosk 4600 may execute subprocess H, which is exemplary process 6700 depicted in association with FIG. 67. Process 6700 will be described in an exemplary fashion as being performed by kiosk 4600, but other equipment may be used in alternative embodiments, such as elements of systems 6900/7000.

As an initial matter, kiosk 4600 may determine via controller 4800 whether kiosk 4600 is configured to duplicate RFID key fobs, and/or if key fob reader 4616 is enabled and working properly (step 6710). If no (step 6712), the process terminates and no further options for duplicating the RFID fob are offered (step 6714). Information to that effect may be displayed to the user via display 4604.

If kiosk 4600 is able to duplicate fobs (step 6718), then further options for the duplication may be presented to the user via display 4604 (step 6720). Display 4604 may receive input from a user regarding copying a fob (step 6730). In some embodiments, the input may comprise a type, shape, or color, etc. of RFID fob to be duplicated, or may comprise a desired quantity.

At step 6740, kiosk 4600 may display a command or other instructions to the user to place their master RFID key fob in key fob reader 4616. The instructions may appear on display 4604, or otherwise be communicated to the user by audio prompts or lights associated with housing 4602 or window 4612. While displaying the instructions, kiosk 4600 may activate key fob reader 4616 and its included antenna via controller 4800 (step 6750).

RFID key fob reader 4616 may receive the user's master RFID fob in proximity of its included antenna (step 6760) and interrogate/scan the fob using the antenna (step 6770). If the data, information, or other code contained within the RFID fob indicates at step 6780 that the fob cannot be copied, RFID key fob reader 4616 may repeat the scan one or more times (step 6784). If the RFID fob duplication process continues to fail via fob reader 4616, then kiosk 4600 may display a prompt to the user via display 4604 or other audio means that the fob cannot be copied and should be removed from fob reader 4616 (step 6786).

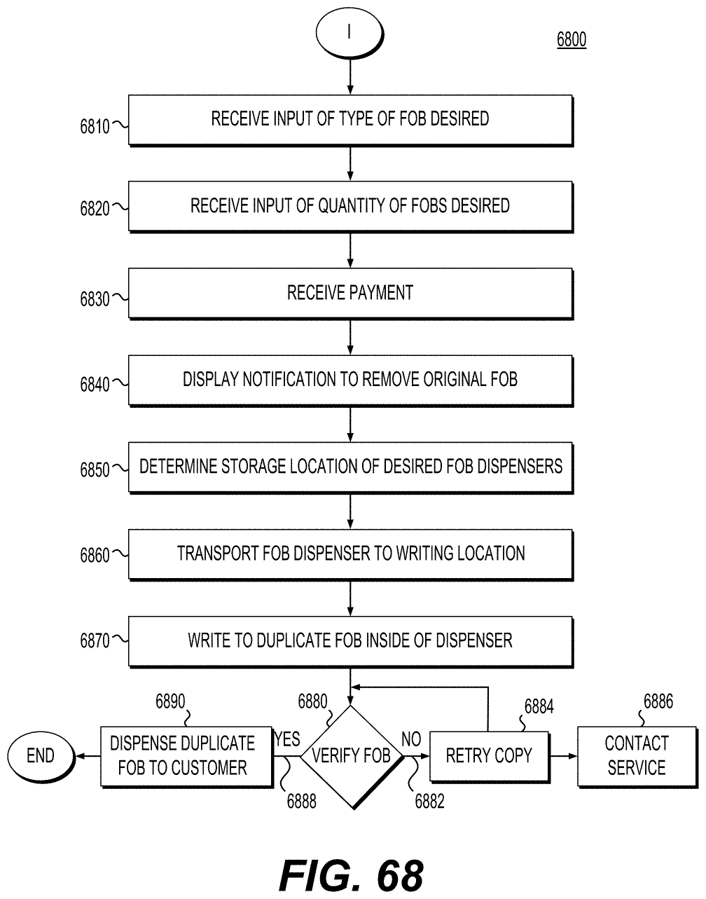

If the user's RFID key fob can be duplicated based on the scanned information (step 6788), then kiosk 4600 may execute subprocess I, which is exemplary process 6800 depicted in association with FIG. 68. Process 6800 will be described in an exemplary fashion as being performed by kiosk 4600, but other equipment may be used in alternative embodiments, such as elements of systems 6900/7000.

At steps 6810 and 6820, if not previously completed or if it is desired to reiterate/revisit, kiosk 4600 may receive input from the user regarding the type and quantity of fobs to be duplicated. As discussed above in association with FIG. 58, RFID fobs may come in a variety of sizes, shapes, and colors. In some alternative embodiments, kiosk 4600 may be equipped to duplicate the user's RFID fob onto a different type or format than the master RFID fob. For example, the user may present an RFID fob in a “tag” form, but may desire to duplicate the fob onto a card or sticker.

At step 6830, kiosk 4600 may display pricing information on display 4604 based on the user's selections at steps 6810 and 6820, and then kiosk 4600 may receive payment for the RFID fob duplication task. In some embodiments, payment may be received at payment receptacle 4608; in other embodiments, payment may be received digitally, such as by or on the user's mobile device, or may be received at the retail location's point of sale. In these embodiments, kiosk 4600 may be configured to present the user with a receipt, barcode, QR code, etc. to take to the point of sale. Kiosk 4800 may display a notification to remove the original RFID fob (step 6840) to ensure that the user does not accidentally leave the fob on fob reader 4616.

At step 6850, kiosk 4600 determines, via controller 4800, the magazine 5706 containing RFID key fob containers 5704 containing the blank RFID fob type desired by the user. Once determined, fob dispenser 4620 and/or associated hardware, such as that described above in association with FIG. 57C, may operate to transport an appropriate RFID key fob container 5704 out of magazine 5706 and within proximity of antenna 5712 (step 6860).

At step 6870, kiosk 4600 and associated RFID key fob duplication hardware as described above may write the blank key fob 5808 with the data/information/code scanned from the master RFID fob. The writing process may take place while fob 5808 remains inside of RFID key fob container 5704.

At step 6880, antenna 5712 may be configured to verify whether the blank RFID fob 5808 was correctly written. If no (step 6882), the system may retry the writing process as discussed above (step 6884). If the verification continues to fail, kiosk 4600 may be configured via controller 4800, display 4604, and antenna 4622, etc., to seek outside assistance, be it a store employee or a remotely located customer service representative (step 6886).

If antenna 5712 verifies that the blank RFID fob 5808 was correctly written with the data/information/code of the master key, then kiosk 4600 may dispense the fob to the user via RFID fob dispenser 4620 (step 6890). In some embodiments, the duplicated fob may remain in the key fob container 5702, which the user may take with them along with the fob and an included key ring 5806.

FIG. 69 illustrates an exemplary key identification and duplication system 6900 consistent with this disclosure. Key identification and duplication system 6900 may include kiosk 4600, network 410, server(s) 420, key technician 6910, and/or key duplicating equipment 6920. Kiosk 4600 may communicate data and/or information with other components of system 6900 via network 410. It is also contemplated that server(s) 420 may communicate data and/or information with key technician 6910 and/or key duplicating equipment 6920 directly or via network 410.

As discussed above, network 410 may include any combination of communications networks. For example, network 410 may include the Internet and/or any type of wide area network, an intranet, a metropolitan area network, a local area network (LAN), a wireless network, a cellular communications network, or Wi-Fi, WiMAX, Bluetooth or other communication protocol, etc.

Server(s) 420 may include one or more servers configured to communicate and interact with kiosk 4600, key technician 6910, and/or key duplicating equipment 6920. Server(s) 420 may be a general purpose computer, a mainframe computer, or any combination of these components. In certain exemplary embodiments, server(s) 420 may be a standalone computing system or apparatus, or it may be part of a subsystem, which may be part of a larger system. For example, server(s) 420 may represent distributed servers that are remotely located and communicate over a communications medium (e.g., network 410) or over a dedicated network, for example, a LAN. Server(s) 420 may be implemented as a server, a server system comprising a plurality of servers, or a server farm comprising a load balancing system and a plurality of servers. Server(s) 420 may be configured to receive one or more images or other data, including geometric data, milling geometry information, or cut geometry information, from kiosk 4600. Server(s) 420 may also be configured to determine a bitting pattern or other geometric information of the key associated with the images received from kiosk 4600.

In some embodiments, server 420 may access one or more databases configured to store instructions and/or data associating vehicle information such as VIN number, make, model, driver's license number, vehicle title information, license plate information, etc., with a bitting pattern for a key associated with the vehicle information. Although server 420 has been illustrated in FIG. 69 as being separate or remote from kiosk 4600, it is contemplated that in some exemplary embodiments, server 420 may be integral with kiosk 4600, or other components.

Server 420 may also be configured in some embodiments to transmit geometric information, key codes, instructions, and/or commands to one or more of key technician 6910 and/or key duplication equipment 6920 to manufacture a duplicate key. In one exemplary embodiment, server 420 may display instructions to allow an operator (in some embodiments, key technician 6910) to select an appropriate key blank and insert the selected key blank into key duplication equipment 6920. Key duplication equipment 6920 may be configured in various embodiments with one or more cutting devices (e.g., edge milling cutters, side milling cutters, drills, saws, laser cutters, etc.). Key duplication equipment 6920 may also be configured to cut notches, for example, 24, 44, or 64 in key shank 12, 32, or 52 based on instructions received from server 420. It is also contemplated that in some embodiments, key duplication equipment 6920 may be configured to retrieve instructions for cutting notches, for example, 24, 44, or 64 in key shank 12, 32, or 52 from a database based on instructions received, for example, from server 420.

FIG. 70 illustrates an exemplary key identification and duplication system 7000 consistent with this disclosure. Key identification and duplication system 7000 may be substantially identical to key identification and duplication system 6900 described in association with FIG. 69, except instead of a single kiosk 4600, a network of kiosks 4600a-4600n may be included.

FIG. 71 illustrates an exemplary hardware configuration of kiosk 4600, consistent with the disclosure. As discussed above, any particular kiosk 4600a-4600n of the network of kiosks may contain different plug and play modules and systems attached via USB hub 4708 and controlled via controller 4800. Optional modules may include, in various embodiments, a home/office key identification module 7110, which may be configured to execute one or more exemplary processes described above such as processes 5900 and 6000. In other embodiments, kiosk 4600 may include a home/office key identification module 7120, which may also be configured to execute all or some of processes such as processes 5900 and 6000.

In other embodiments, kiosk 4600 may include an automobile key identification module 7130, which may also be configured to execute all or some of processes such as processes 6100, 6200, and/or 6300 described above. In still other embodiments, kiosk 4600 may include an automobile key duplication module 7140, which may also be configured to execute all or some of processes such as processes 6100, 6200, 6300, 6400, 6500, and/or 6600 described above.

In other embodiments, kiosk 4600 may include an RFID fob identification module 7150 and/or an RFID fob duplication module 7160, which may each be configured to execute all or some of processes such as processes 6700 and 6800 described above.

In still other embodiments, kiosk 4600 may include a generalized object identification module 7170 and/or a generalized object duplication module 7180 to duplicate any or all of the access devices described above or others that may be contemplated by those skilled in the art, such as rare keys, dimple keys, angled bit keys, etc.

In some embodiments, kiosk 4600 may include an automatic configuration management module 7190, which may interface with and/or include controller 4800 for purposes of controlling and coordinating object identification and duplication.

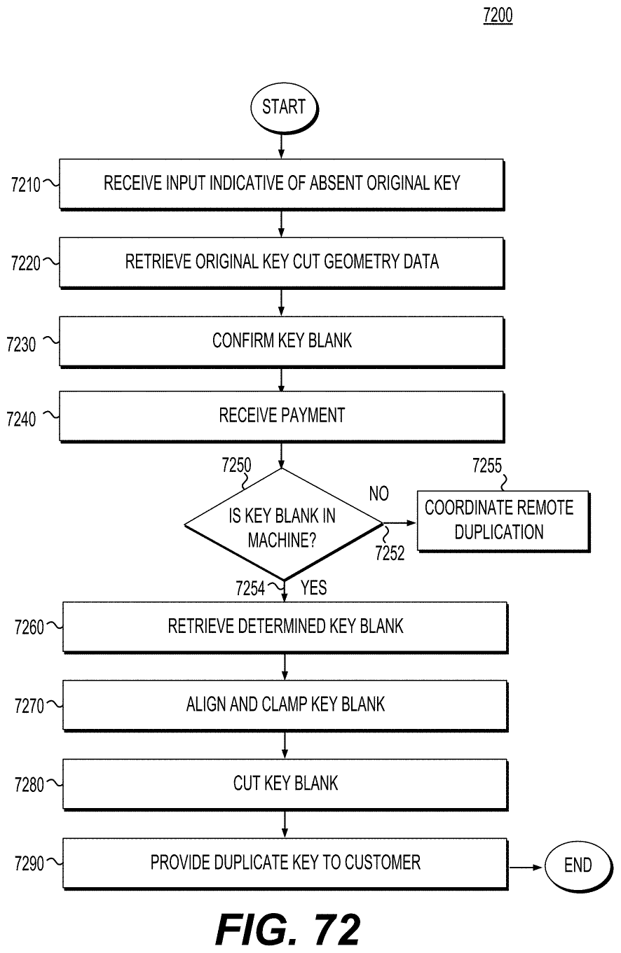

FIG. 72 is a flowchart illustrating exemplary process 7200. Process 7200 will be described in exemplary form as being performed by kiosk 4600, but it may also be executed in full or in part by elements of systems 6900/7000. Process 7200 assists a user of a self-service kiosk 4600 in duplicating an access control device when the original is missing. In some embodiments, the original device may be lost or broken. In other embodiments, the user may have previously stored information relating to the access device such as geometric information, key codes, milling information, transponder codes, etc. to a server such as server(s) 420 for later use and duplication at a kiosk 4600 without the original device present.

At step 7210, kiosk 4600 may receive input from the user, via display 4604 or other means, indicating that the original key or access device is absent. After receiving the input, kiosk 4600 via controller 4800 may retrieve stored information, either from a user entry saved on server(s) 420 or from a database (step 7220). In some embodiments, for example, controller 4800 and associated processors may be configured to determine transponder code information or milling geometry information for a sidewinder automobile key based on a VIN (vehicle identification number) of the vehicle.

At step 7230, controller 4800 and/or server(s) 420 may confirm an appropriate key blank or other blank associated with the absent access device, i.e. a key blank, an unprogrammed remote control device, or a blank RFID fob. Once determined, controller 4800 may determine pricing and shipping information, and may be configured to display that information to the user via display 4604. Kiosk 4600 may then receive payment (step 7240) as discussed above via payment receptable 4608, or other known means.

Controller 4800 may then determine whether the appropriate blank item is stored inside of housing 4602 of kiosk 4600. If no (step 7252), then controller 4800 may display information to that effect to the user via display 4604 and may proceed to coordinate remote duplication of the blank device via other elements of system 6900/7000, such as a different kiosk 4600, a key technician 6910, or key duplication equipment 6920 (step 7255).

If the blank device is located within housing 4602 (step 7254), then controller 4800 and associated robots, motors, and other hardware may retrieve the determined appropriate blank device (step 7260), and clamp and/or align it within the relevant module hardware as appropriate for the device (step 7270).

At step 7280, the duplicate is made, and at step 7290, the duplicate is provided to the user through housing 4602. Although these steps are exemplified with “keys” from homes, offices, or automobiles, in other embodiments other access devices like RFID key fobs or key cards may be duplicated and dispensed to the user if the kiosk is so equipped. Those of skill in the art will be able to contemplate various access devices that can be duplicated without the original device present using kiosk 4600 or other elements of systems 6900/7000.

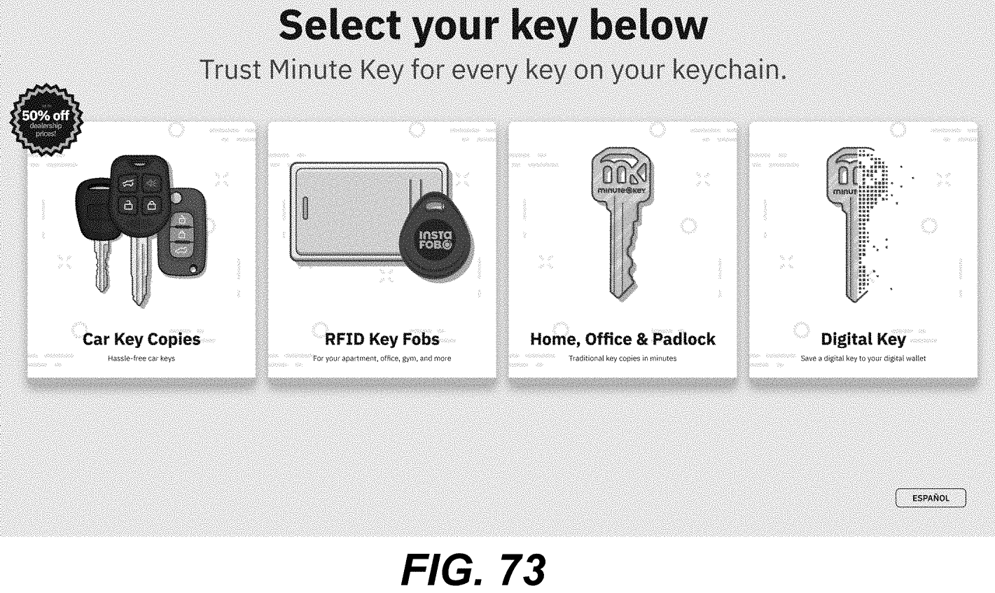

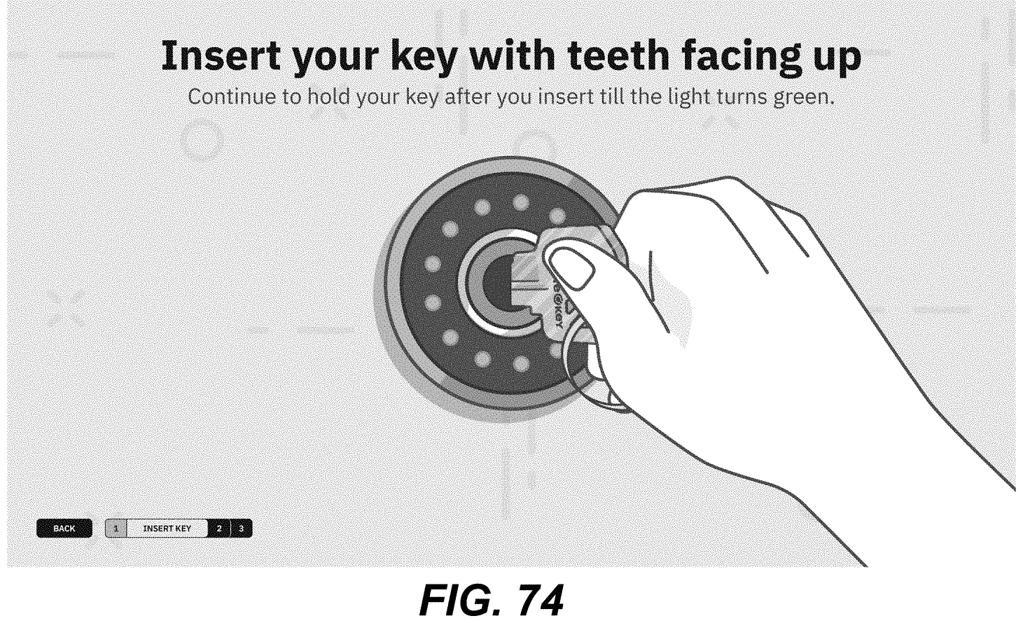

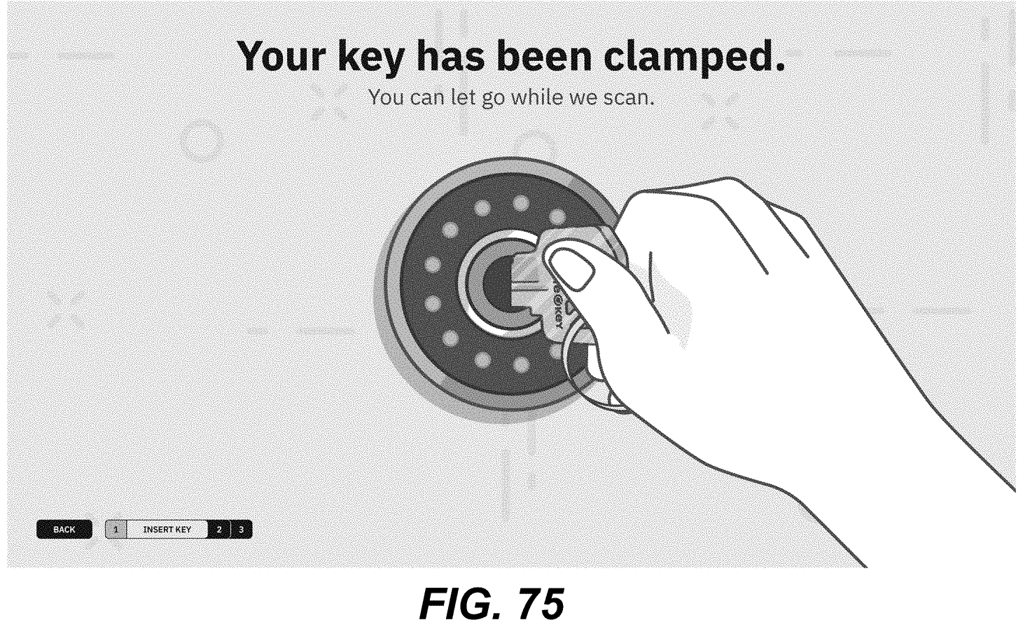

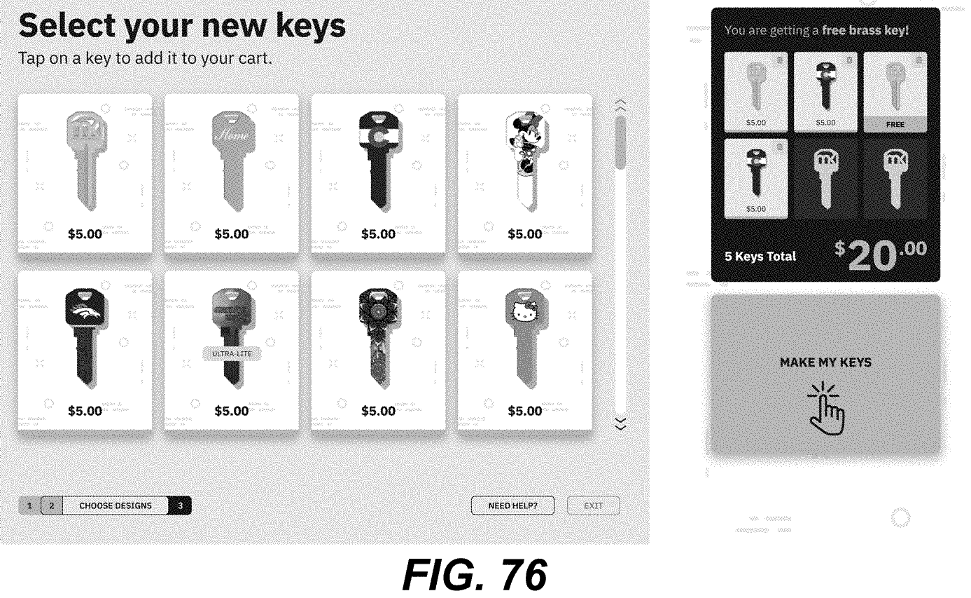

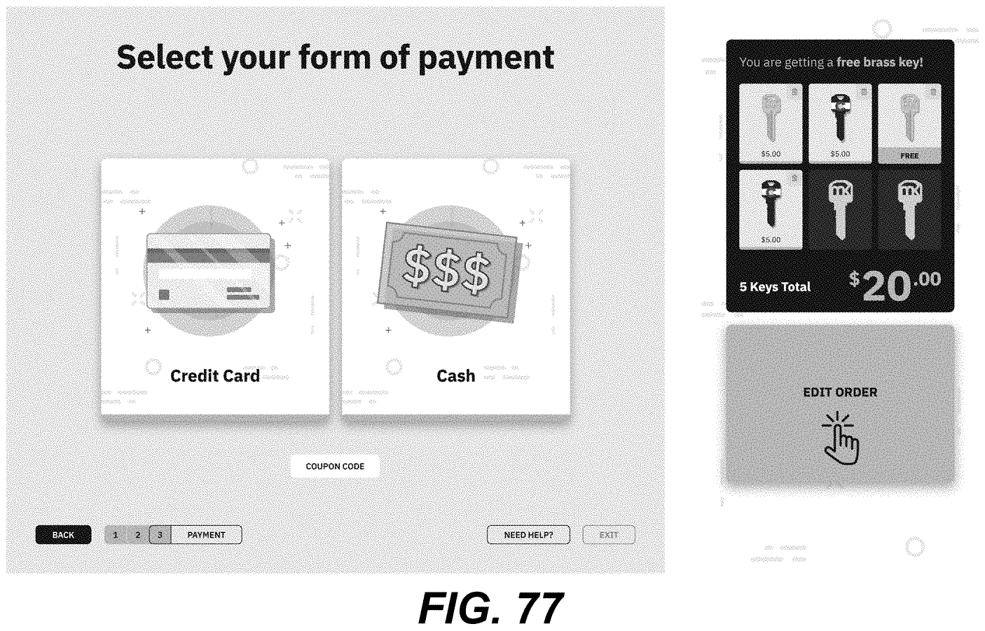

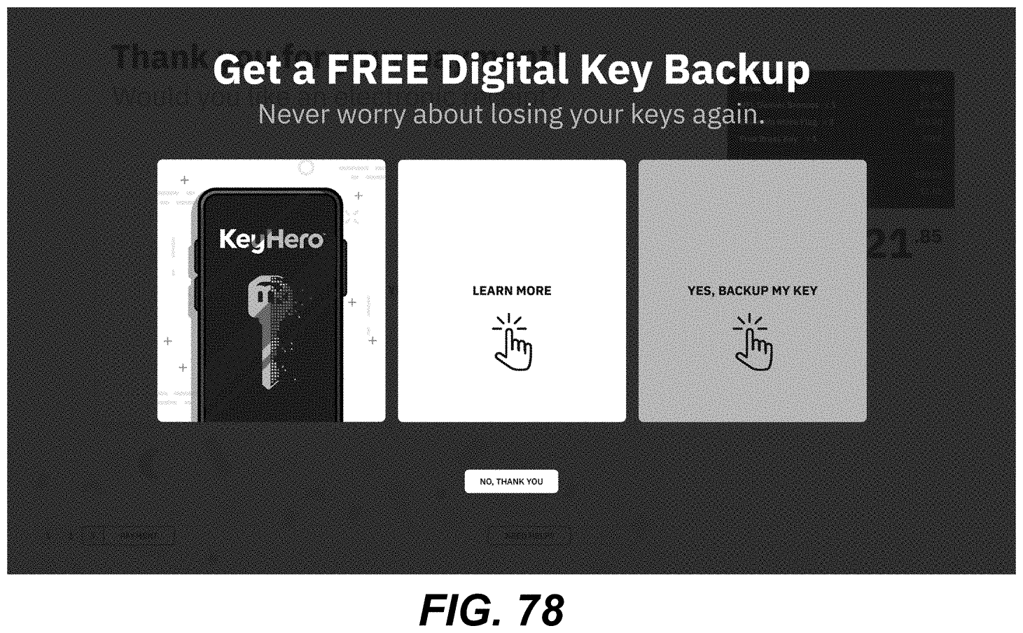

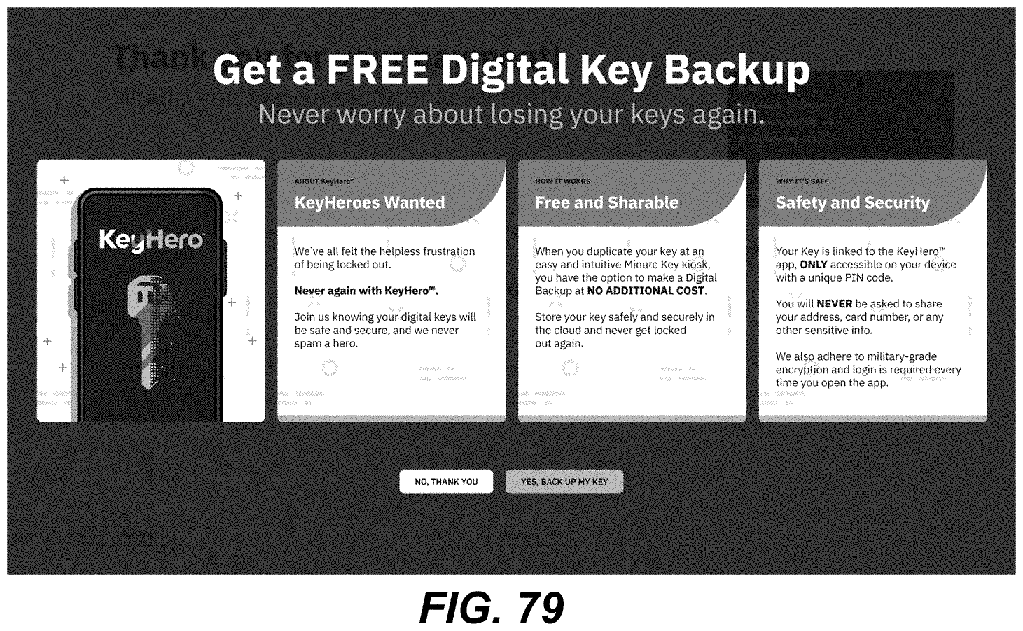

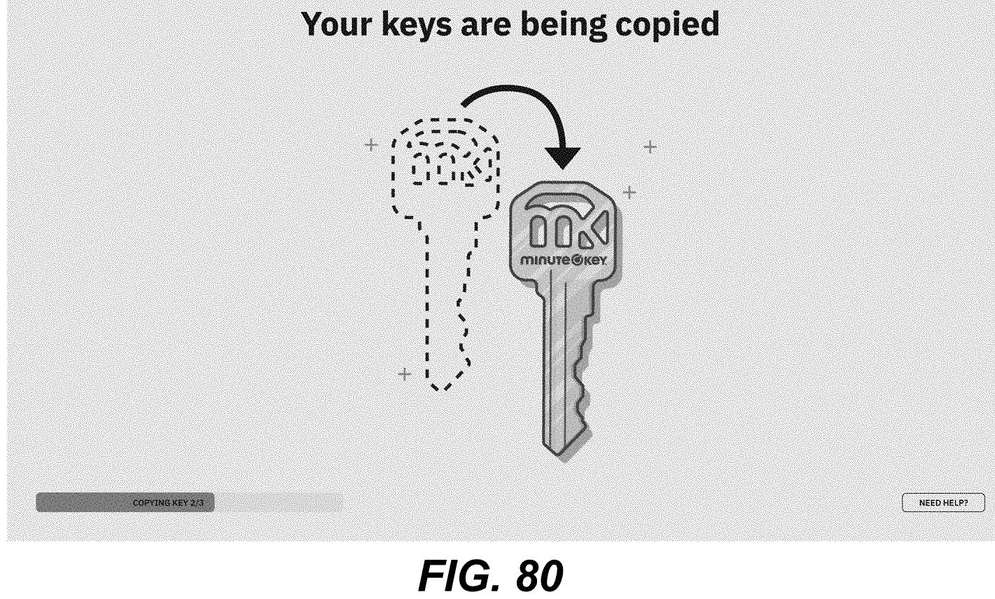

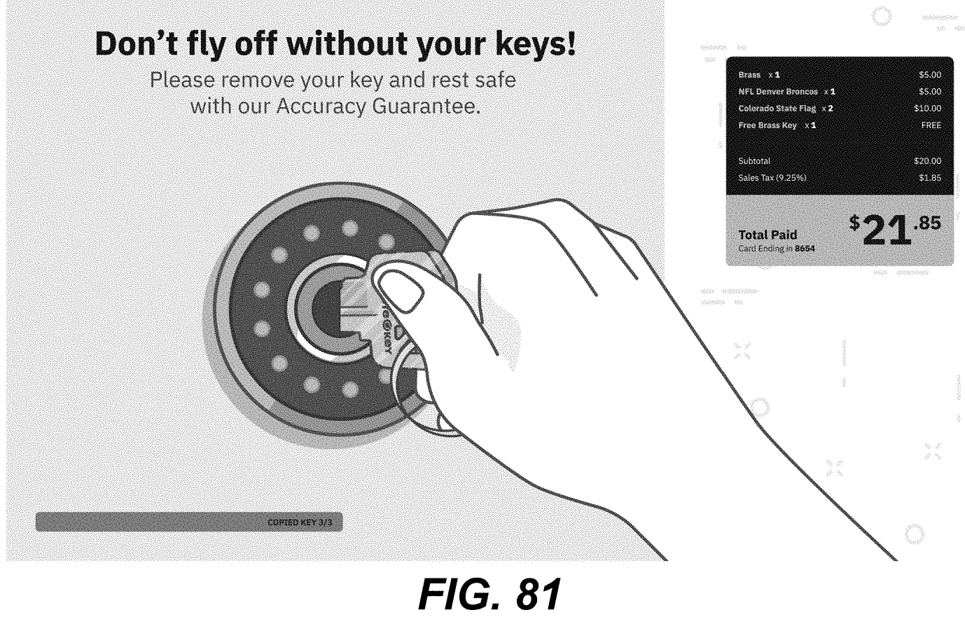

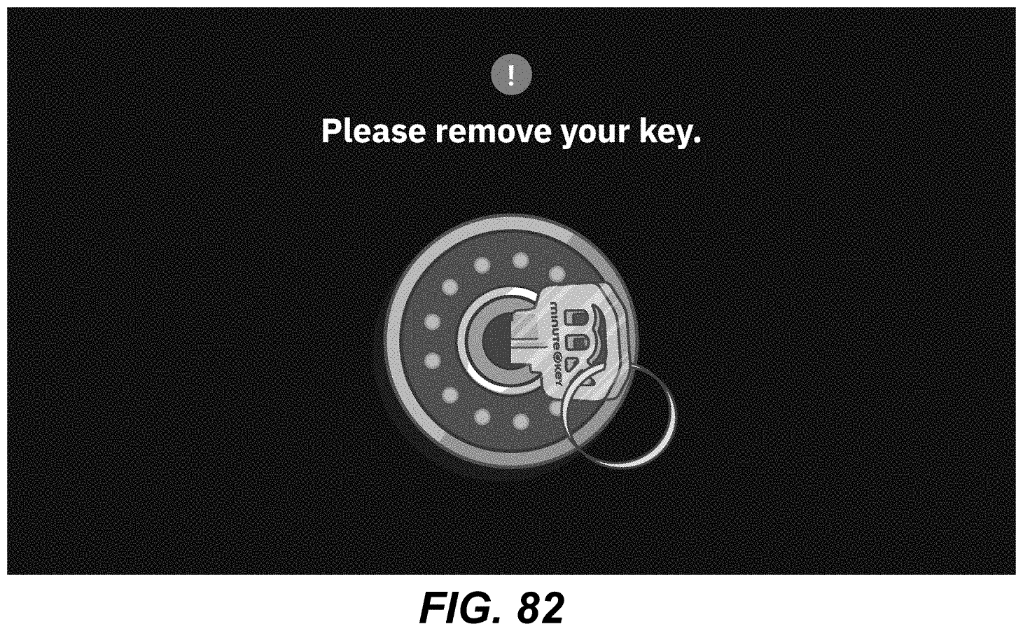

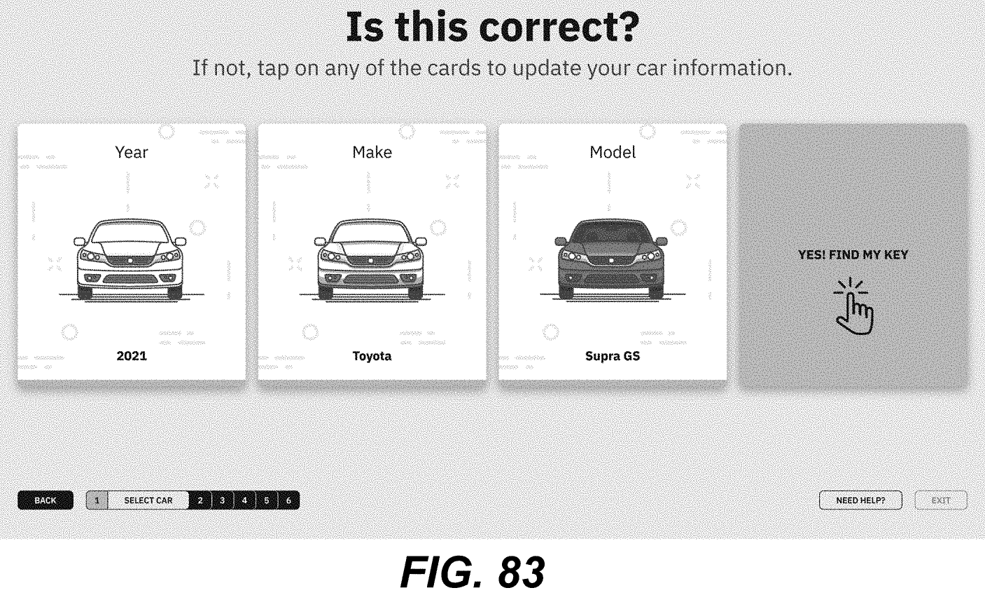

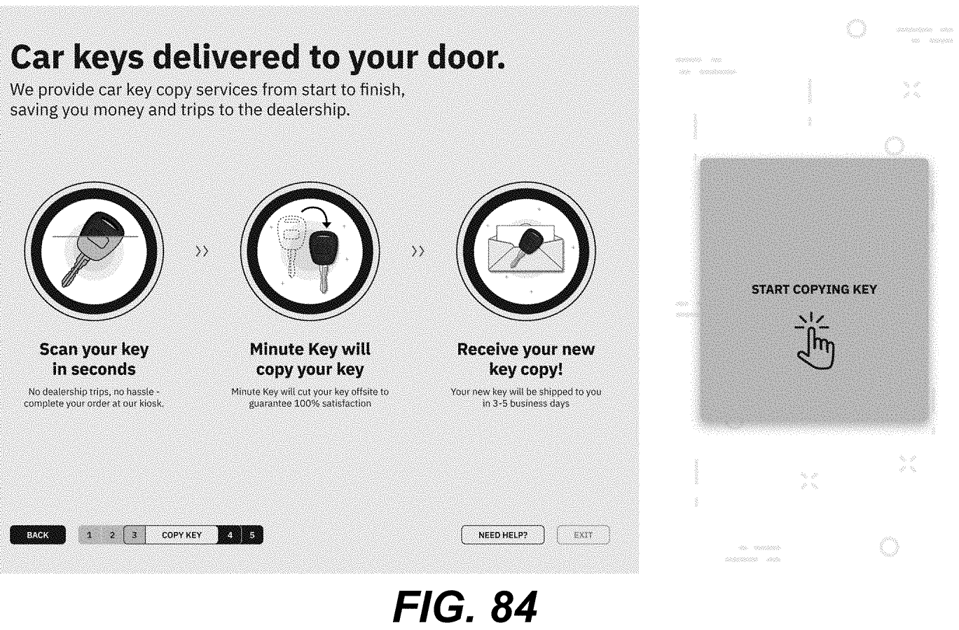

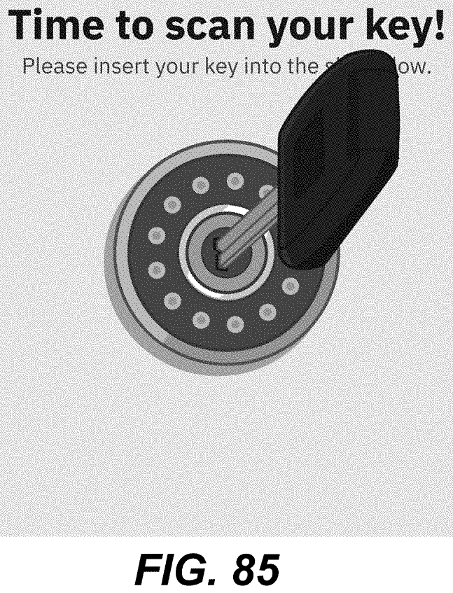

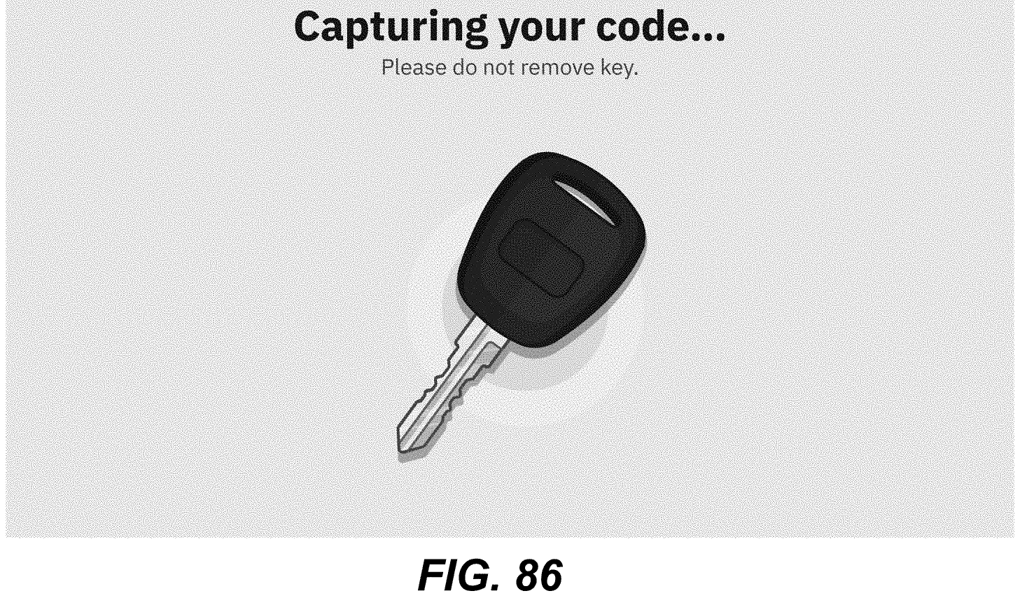

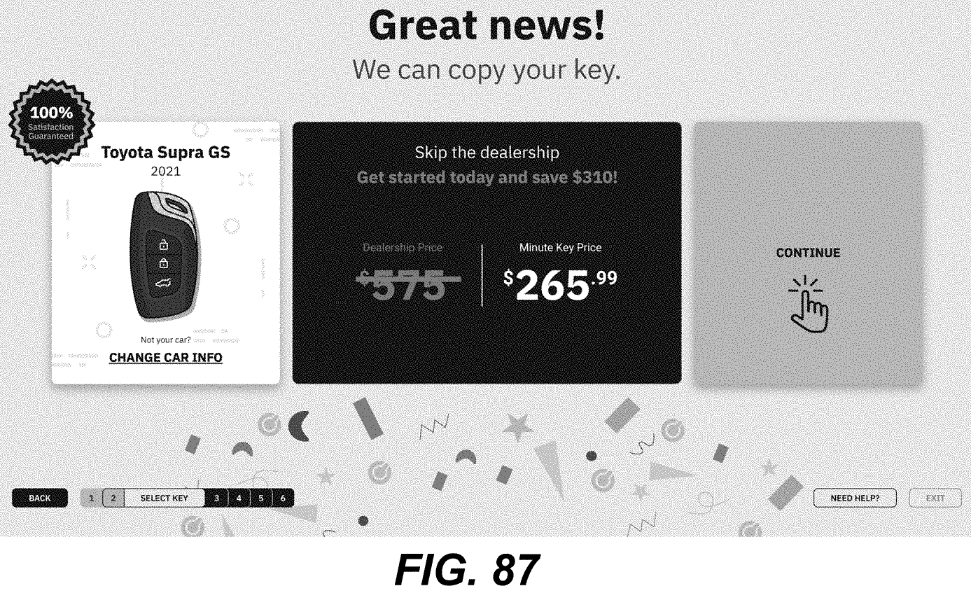

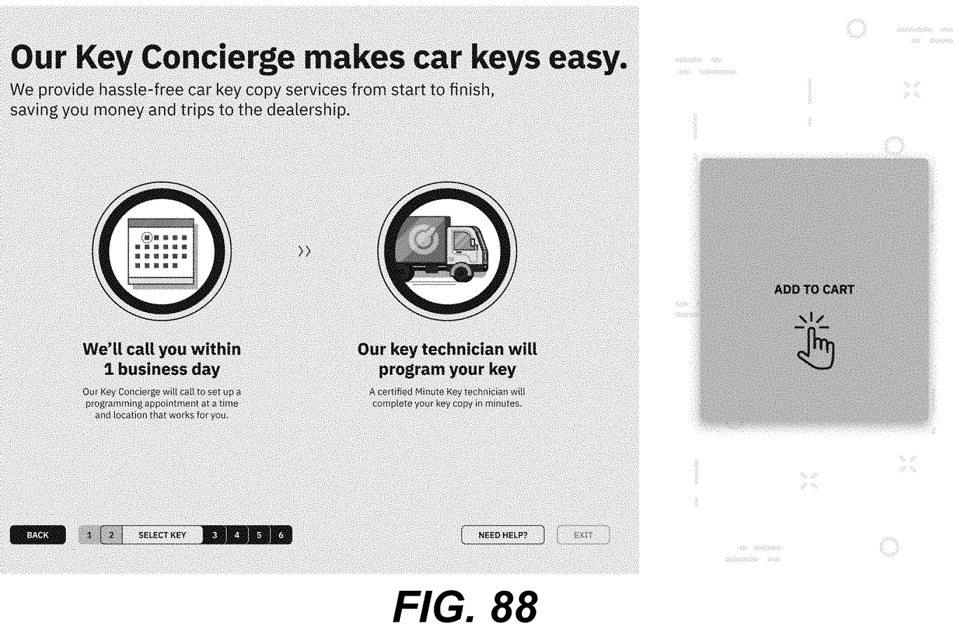

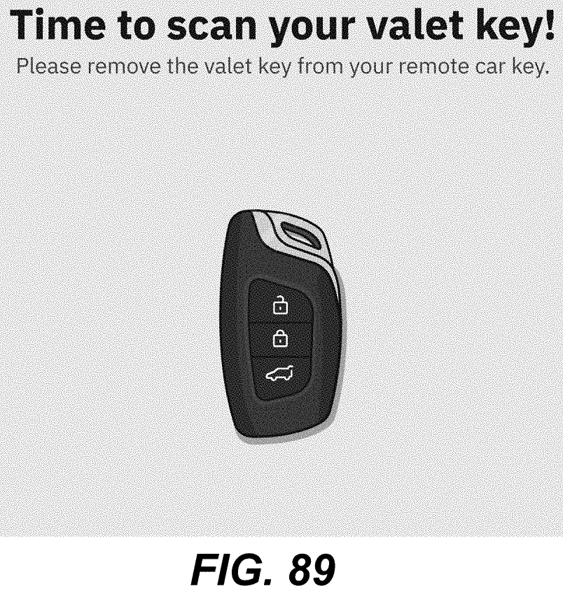

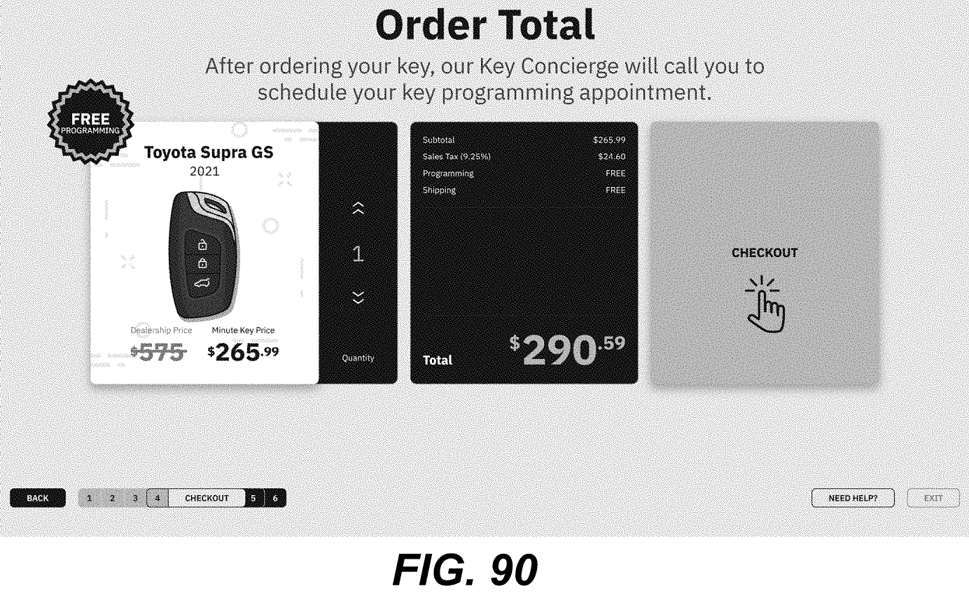

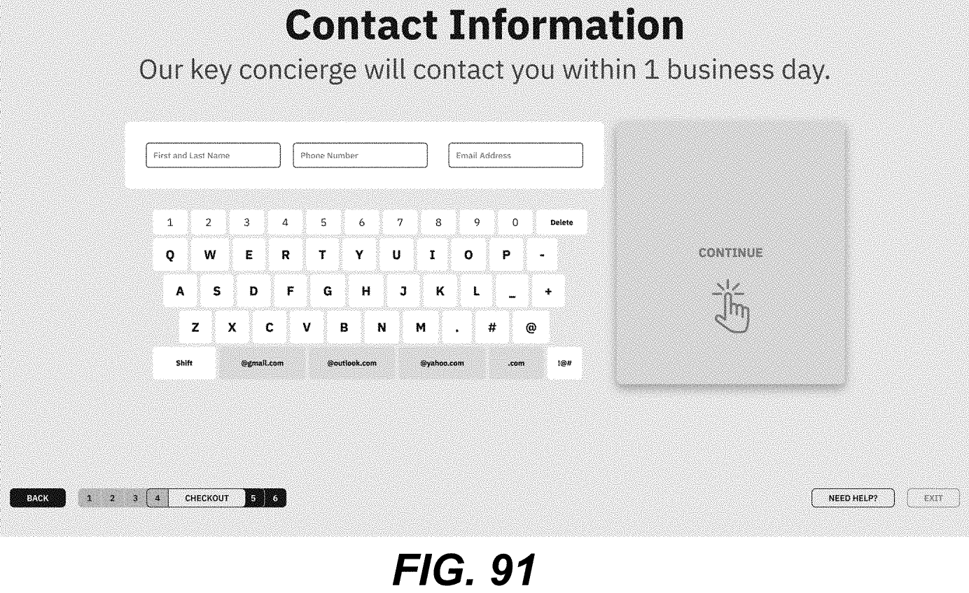

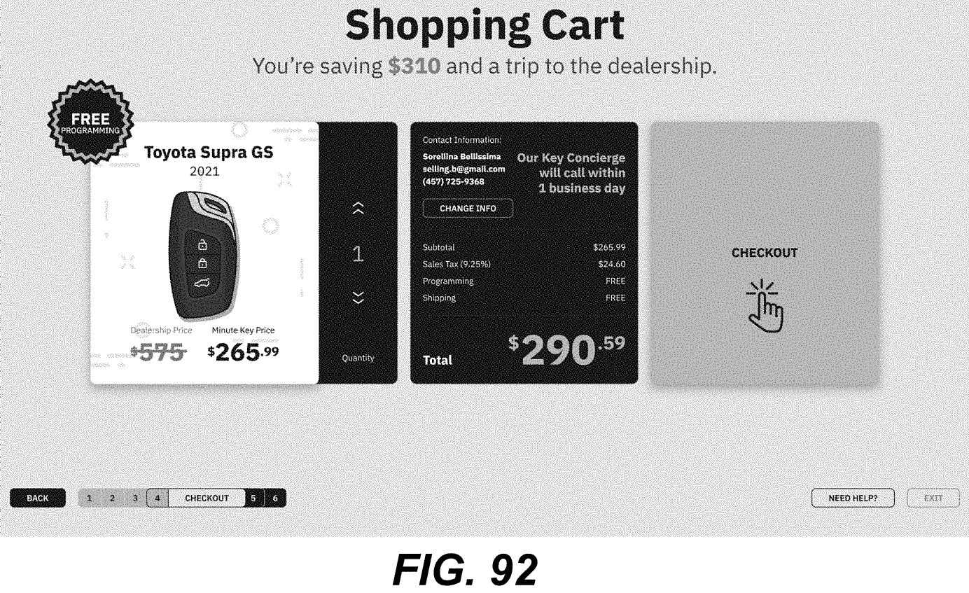

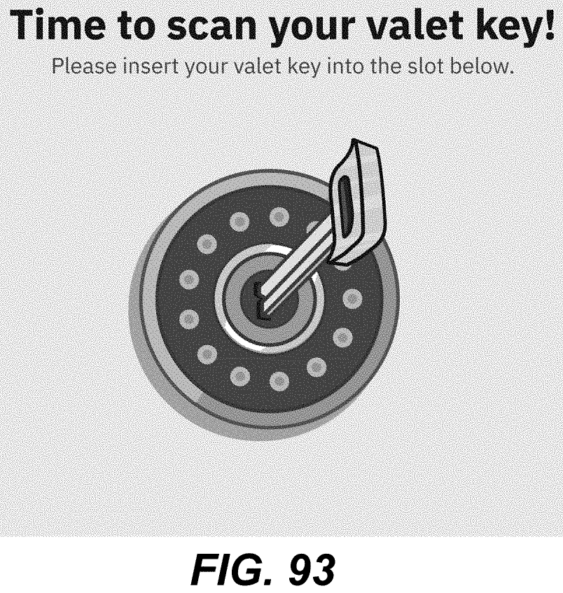

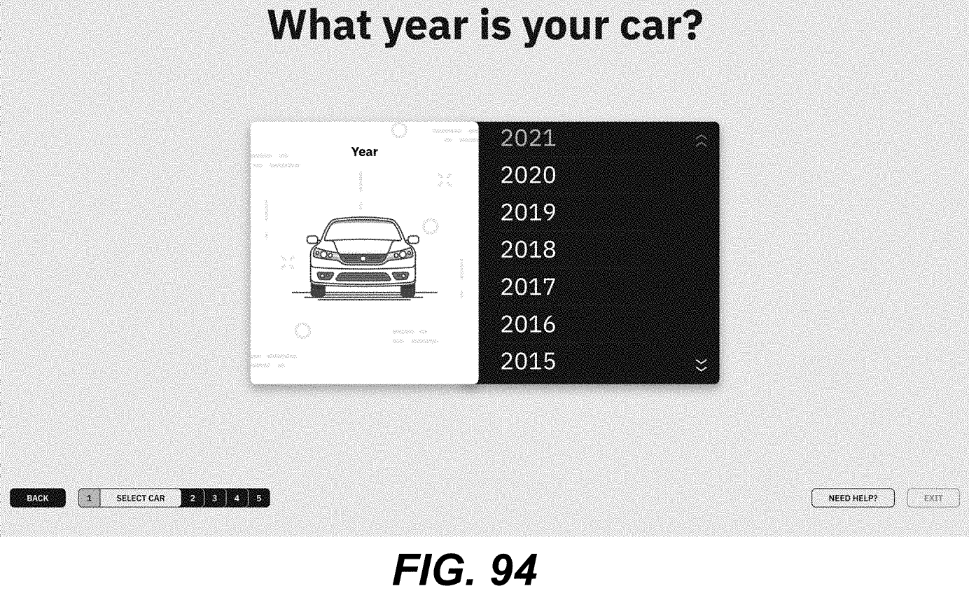

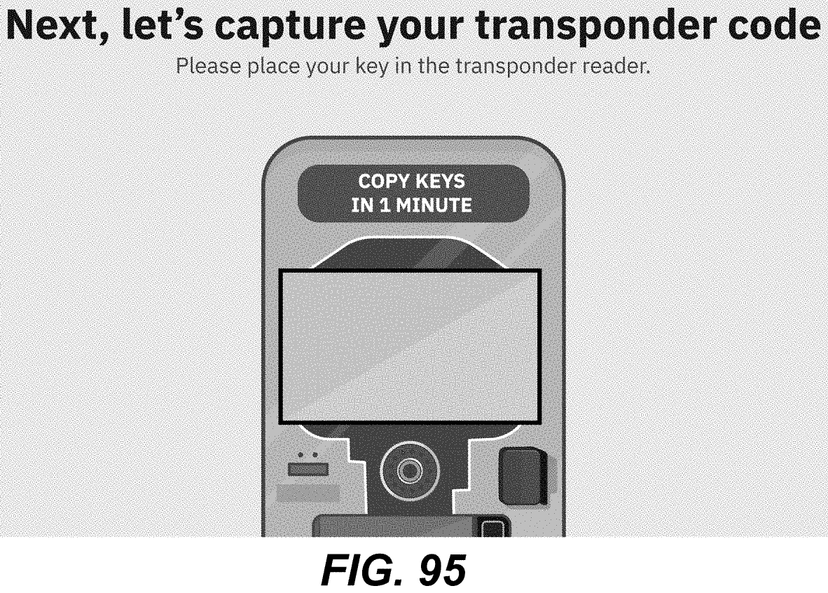

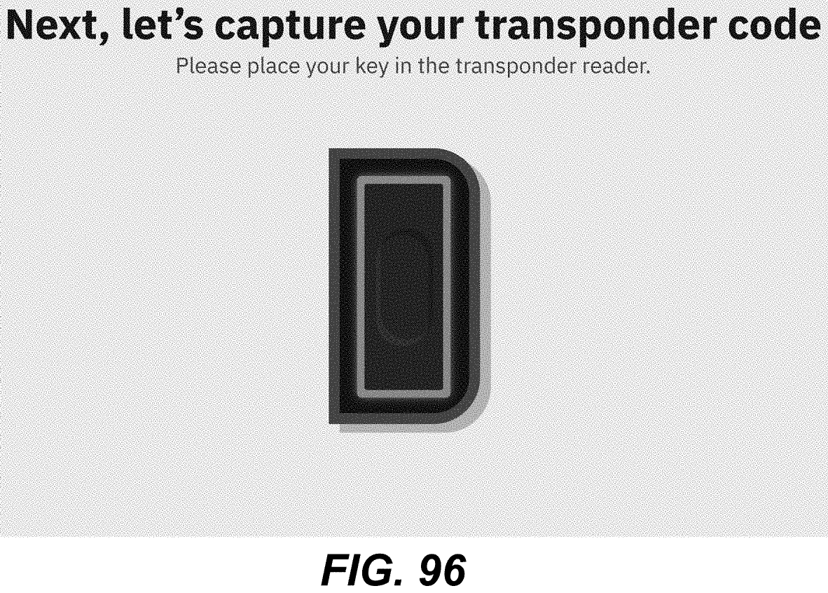

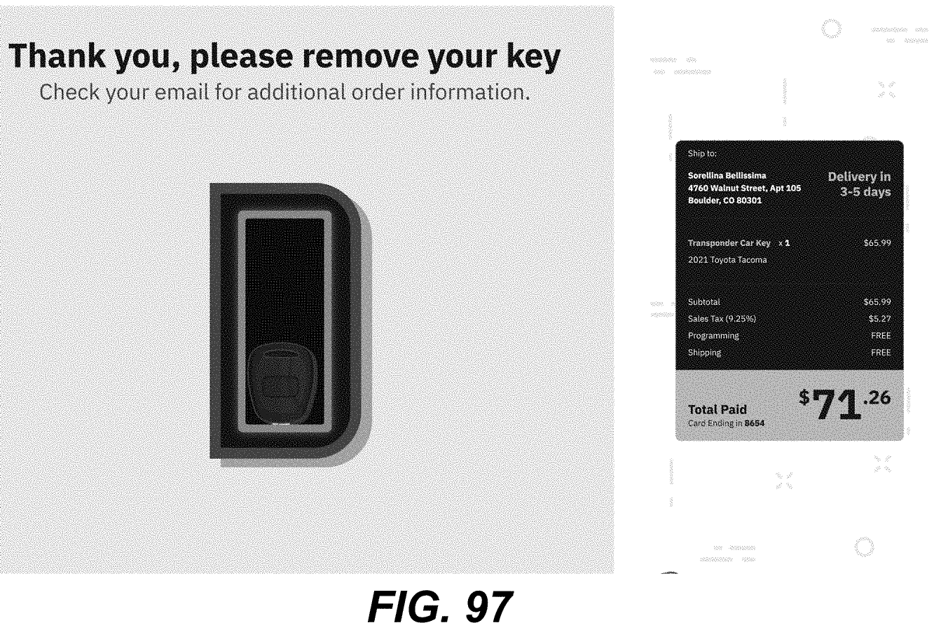

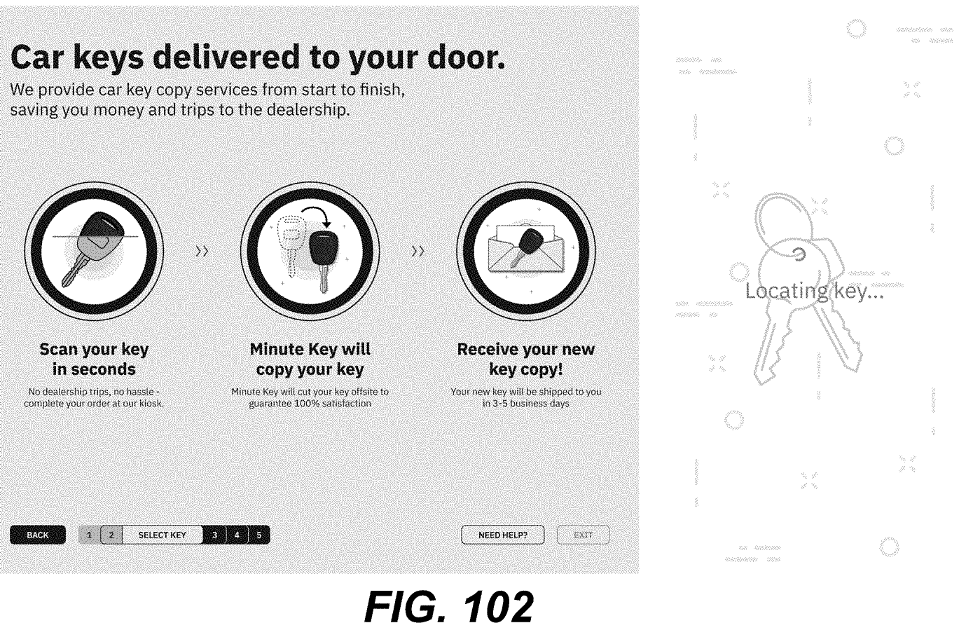

FIGS. 73-102 illustrate exemplary graphical user interface (GUI) displays that may be presented to a user on, for example, display 4604 of kiosk 4600. As illustrated in FIGS. 73-102, these GUI displays may allow a user to select a make, model, and/or year of their vehicle, provide additional information regarding the key the user wishes to duplicate and select an appropriate key that matches the user's key. The GUI displays may also provide instructions to the user to place the key and/or documents on platform 252, and/or insert the user's key into slot 240 to allow the one or more imaging devices associated with kiosk 220 to capture images of the user's key and/or documents. In addition, the GUI displays may allow the user to enter contact information such as email, phone number, address etc. The GUI displays may also display a bar code or QR code as discussed above. Although FIGS. 73-102 illustrate GUI displays for duplicating home/office keys, automobile keys, and RFID key fobs, it is to be understood that these illustrations are exemplary and the disclosed systems may be used for duplication of other types of access devices and objects.

The disclosed object identification and duplication systems and methods provide a simple, one-stop place for a user to duplicate nearly every type of access device by themselves with no training and without having to find and visit a specialized key duplication location such as a vehicle dealership and/or a particular locksmith. Particularly for automotive keys, the clamping of the existing key, the ability to decode the transponder at the kiosk, and the ability to verify the identity and fidelity of a remote control device for newer cars represents clear advantages over the prior art and promotes increased accuracy, fewer miscuts and misduplications, and less waste. Furthermore, the disclosed object identification and duplication systems may allow retail locations to offer lucrative access control device duplication services without having to store a large inventory at the retail location and without having to dedicate additional labor. Thus, the disclosed system may provide advantages such as increased user convenience, better quality duplicates, and reduced storage space requirements and inventory costs for the retail location.

It will be apparent to those skilled in the art that various modifications and variations can be made to the disclosed object identification and duplication systems and methods. Other embodiments will be apparent to those skilled in the art from consideration of the specification and practice of the disclosed systems and methods. It is intended that the specification and examples be considered as exemplary only, with a true scope being indicated by the following claims and their equivalents.

What is claimed is:

1. A system for duplicating access devices, comprising:
a self-service kiosk comprising:
a housing;
a user interface;
a key identification system within the housing configured to:
receive an existing key at a key insertion slot;
clamp the existing key; and
identify geometric features of the existing key;
a key duplication system within the housing configured to:
retrieve a key blank associated with the existing key;
clamp the key blank;
cut the geometric features of the existing key identified by the key identification system into the key blank; and
dispense the cut key blank;
an automobile key identification system within the housing configured to:
receive input via the user interface indicative of the make, model, and year of an automobile associated with an existing automobile key;
determine whether the existing automobile key includes a transponder chip;
determine information associated with the type of transponder chip;
interrogate the transponder chip; and
determine a code associated with the transponder chip; and
a remote server.

2. The system of claim 1, wherein the automobile key identification system is further configured to determine, based on the received input via the user interface indicative of the make, model, and year of an automobile associated with an existing automobile key, that the existing automobile key is a remote control device.

3. The system of claim 2, wherein the automobile key identification system further comprises one or more imaging devices configured to capture at least one image of the remote control device.

4. The system of claim 3, wherein the automobile key identification system is further configured to verify, based on the captured at least one image, that the remote control device matches a remote control device associated with the received input indicative of the make, model, and year of an automobile associated with an existing automobile key.

5. The system of claim 3, wherein the automobile key identification system is further configured to transmit the at least one image of the remote control device to the remote server.

6. The system of claim 1, wherein the existing key is a sidewinder key.

7. The system of claim 6, wherein identifying geometric features of the existing key further comprises at least one of:
capturing at least one sidelight image of the blade of the sidewinder key; and
capturing at least one laser stripe image of the blade of the sidewinder key.

8. The system of claim 7, wherein the key identification system is further configured to transmit one or more of the at least one sidelight image and the at least one laser stripe image to the remote server.

9. The system of claim 8, wherein the remote server is configured to determine milling geometry information for the blade of the existing sidewinder key based on one or more of the at least one sidelight image and the at least one laser stripe image.

10. The system of claim 1, further comprising a milling system.

11. The system of claim 10, wherein the milling system is configured to:
mill a sidewinder key blank with the geometric features of an existing sidewinder key based on milling geometry information for the blade of the existing sidewinder key.

12. The system of claim 11, wherein the remote server is configured to determine the milling geometry information for the blade of the existing sidewinder key based on information received from the key identification system.

13. The system of claim 1, wherein the self-service kiosk further comprises an apparatus configured to receive payment from a user.

14. A method for duplicating an automobile key, the method comprising:
receiving input via a user interface of a self-service kiosk indicative of the make, model, and year of an automobile associated with an existing automobile key;
determining, based on the received input, that the existing automobile key is a remote control device;
capturing at least one image of a remote control device provided by a user of the self-service kiosk;
verifying, based on the captured at least one image, that the remote control device provided by the user matches a remote control device associated with the make, model, and year of an automobile input received by the user interface; and
transmitting the input of a make, model, and year of an automobile received by the user interface and the captured at least one image to a remote server.

15. A method for duplicating a key, the method comprising:
receiving an existing key at a key insertion slot of a housing of a self-service kiosk;
clamping the existing key;
determining that the existing key is a sidewinder key;
capturing at least one sidelight image of the blade of the sidewinder key;
capturing at least one laser stripe image of the blade of the sidewinder key;
transmitting one or more of the at least one sidelight image and the at least one laser stripe image to a remote server;
determining milling geometry information for the blade of the existing sidewinder key based on one or more of the at least one sidelight image and the at least one laser stripe image;
retrieving a sidewinder key blank associated with the existing sidewinder key; and
milling a blade of the sidewinder key blank with geometric features of the existing sidewinder key based on the determined milling geometry information for the blade of the existing sidewinder key.

16. The method of claim 15, further comprising:
receiving input, via the user interface device, of delivery information for the user of the self-service kiosk; and
delivering the milled sidewinder key blank to the user based on the received delivery information.

17. A method for duplicating an RFID key fob, the method comprising:
reading data associated with an existing RFID key fob at a self-service kiosk;
determining whether the existing RFID key fob can be duplicated;
when the data indicates that the existing RFID key fob can be duplicated;
retrieving an RFID key fob container containing an RFID key fob blank;
writing the existing RFID key fob data onto the RFID key fob blank within the RFID key fob container; and
dispensing the RFID key fob container containing the written RFID key fob blank.

18. The system of claim 1, wherein:
the existing key received in the key insertion slot is a double-edged automobile key,
the key identification system is further configured to identify geometric features on both edges of the existing key, and
the key duplication system is configured to cut the determined geometric information from each edge of the existing key into the corresponding edge of the key blank.

19. A system for duplicating access devices, comprising:
a self-service kiosk comprising:
a housing;
a user interface;
a key identification system within the housing configured to:
receive an existing key at a key insertion slot;
clamp the existing key; and
identify geometric features of the existing key;
a key duplication system within the housing configured to:
retrieve a key blank associated with the existing key;
clamp the key blank;
cut the geometric features of the existing key identified by the key identification system into the key blank; and
dispense the cut key blank; and
an RFID key fob duplication system within the housing configured to:
read data associated with an existing RFID key fob;
determine whether the existing RFID key fob can be duplicated;
when the data indicates that the existing RFID key fob can be duplicated;
retrieve an RFID key fob container containing an RFID key fob blank;
write the existing RFID key fob data onto the RFID key fob blank within the RFID key fob container; and
dispense the RFID key fob container containing the written RFID key fob blank.

20. The system of claim 19, wherein the self-service kiosk further comprises an apparatus configured to receive payment from a user.

21. The system of claim 19, wherein:
the key identification system is further configured to receive the existing key at the key insertion slot in either a teeth-up or teeth-down orientation for a single edge cut key, and
the key identification system is further configured to receive the existing key at the key insertion slot with either edge facing up for a double edge cut key or a sidewinder key.

22. The system of claim 1, wherein:
the key identification system is further configured to receive the existing key at the key insertion slot in either a teeth-up or teeth-down orientation for a single edge cut key, and
the key identification system is further configured to receive the existing key at the key insertion slot with either edge facing up for a double edge cut key or a sidewinder key.

23. The system of claim 1, further comprising an RFID key fob duplication system within the housing configured to:
read data associated with an existing RFID key fob;
determine whether the existing RFID key fob can be duplicated;
when the data indicates that the existing RFID key fob can be duplicated, retrieve an RFID key fob container containing an RFID key fob blank;
write the existing RFID key fob data onto the RFID key fob blank within the RFID key fob container; and
dispense the RFID key fob container containing the written RFID key fob blank.
